(19) United States
(12) Patent Application Publication
(10) Pub. No.: US 2003/0088338 A1
(43) Pub. Date: May 8, 2003

(54) Apparatus and method for electronic control of fluid flow and temperature

(75) Inventors: Terry G. Phillips, Meridianville, AL (US); Wade C. Patterson, Huntsville, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Synapse, Inc., Huntsville, AL

(21) Appl. No.: 10/285,377

(22) Filed: Oct. 31, 2002

Related U.S. Application Data
(60) Provisional application No. 60/335,721, filed on Nov. 1, 2001.

(51) Int. Cl. G05D 11/00

(52) U.S. Cl. 700/282; 700/265

(57) ABSTRACT

An electronically controlled fluid dispensing apparatus is disclosed. An electronically controlled fluid dispensing apparatus of the present invention includes a user interface configured to deliver an electronic signal in response to a user selected temperature and flow rate, a controller communicating with the user interface to receive the electronic signal, and a valve assembly including a motor and a valve coupled to the motor. The controller includes logic configured to process the electronic signal to create a control signal indicative of the user selected temperature and flow rate. The motor is configured to drive the valve in response to the control signal to open the valve a sufficient distance to achieve the selected flow rate and temperature. A method of electronically controlling fluid dispensation and an apparatus and method for mixing fluids are also disclosed.

### CROSS REFERENCE TO RELATED APPLICATIONS

This application claims the benefit of U.S. Provisional Patent Application Serial No. 60/335,721, filed Nov. 1, 2001, entitled, “Apparatus and Method for Electronic Control of Fluid Flow and Temperature, the disclosure of which is hereby incorporated herein by reference.

### BACKGROUND OF THE INVENTION

1. Field of the Invention

The present invention relates generally to the field of fluid dispensation, and more particularly, to an apparatus and method for electronically controlling the flow and temperature of fluid dispensed from a fluid dispensing device.

While the present invention is applicable for use with any number of fluid dispensing devices, it is particularly well suited for use with faucets, shower heads, and the like.

2. Technical Background

Various methods have been employed to electronically control fluid flow through a fluid dispensing device such as a faucet, toilet, showerhead, or the like. Among the accepted methods is the use of an optical sensor typically employed in combination with an infrared (“IR”) source or IR emitter, which, together with processing electronics are used to control one or more solenoid valves. Generally speaking, a pulsed IR beam from an IR source is reflected from an object, such as a user's hands, and sensed to determine whether to activate or deactivate the one or more solenoid valves. Pulsed IR sensing remains at the forefront of sensing techniques used with these types of devices, due in part to its reasonable performance and low cost.

Generally speaking, electronically controlled fluid dispensing devices such as faucets, toilets and the like have had limited public acceptance due to, among other things, the relatively high costs associated with purchasing such products and the complexity of the products themselves, which makes installation and maintenance time consuming and expensive tasks. As a result, such electronic fluid dispensing apparatus are generally employed in commercial settings such as, public restrooms, hospitals, and other commercial environments.

A shortcoming associated with the use of commercially available fluid dispensing devices relates to the limited number of aspects of fluid dispensation that are presently capable of being controlled. Generally speaking, commercially available electronically controlled fluid dispensing devices are capable of either turning fluid flow on or off, or controlling the fluid temperature. None of the devices presently available on the market provide for complete electronic control of all aspects of fluid dispensation. Specifically, no one device known in the art is presently capable of turning fluid flow on and off, controlling the fluid flow rate during fluid dispensation, and controlling the temperature of the fluid dispensed from such a device.

What is needed therefore, but presently unavailable in the art, is a fluid dispensing apparatus and method for controlling the activation and inactivation of fluid flow, the flow rate, and the temperature of a fluid dispensed therefrom. Such an apparatus and method should be inexpensive to manufacture, reliable in operation, and should employ as much conventional hardware as possible. It is to the provision of such an apparatus and method that the present invention is primarily directed.

### SUMMARY OF THE INVENTION

One aspect of the present invention relates to an apparatus for mixing fluids. The apparatus includes a housing defining a channel having a first end, a second end remote from the first end, an area of convergence positioned between the first and second ends, and an orifice communicating with the area of convergence. The channel is configured to receive a first fluid between the first end and the area of convergence and a second fluid between the second end and the area of convergence. The channel is constructed and arranged to guide the first fluid and the second fluid toward the area of convergence to cause the fluids to be rotationally mixed as the fluids enter the orifice.

In another aspect, the present invention relates to a method of mixing fluids. The method includes the steps of dispensing a first fluid into a first end of a channel formed in a housing, dispensing a second fluid into a second end of the channel remote from the first end, and guiding the fluids toward one another within the channel to cause the fluids to meet at an area of convergence formed between the ends of the channel. The fluids are rotationally mixed as they exit the channel via an orifice in fluid communication with the area of convergence.

In yet another aspect, the present invention is directed to a method of electronically controlling fluid dispensation. The method includes the steps of receiving an electronic signal including an instruction for controlling the flow rate at which at least one fluid is dispensed from a device, processing the electronic signal to create a control signal indicative of the flow rate, delivering the control signal to a motor coupled to a valve, and moving the valve with the motor in response to the control signal to dispense the at least one fluid from the device at the flow rate included in the instruction.

An additional aspect of the present invention relates to an apparatus for electronically controlling fluid dispensation. The apparatus includes a user interface configured to deliver an electronic signal in response to a user selected temperature and flow rate, a controller communicating with the user interface to receive the electronic signal, and a valve assembly including a motor and a valve coupled to the motor. The controller includes control logic configured to process the electronic signal to create a control signal indicative of the user selected temperature and flow rate. The motor is configured to drive the valve in response to the control signal to open the valve a sufficient distance to achieve the selected flow rate and temperature.

Additional aspects of the present invention will be described in greater detail below with reference to the drawing figures.

The electronically controlled fluid dispensing apparatus and method of the present invention results in a number of advantages over other apparatus and methods commonly known in the art. For example, the electronically controlled fluid dispensing apparatus of the present invention utilizes a significant number of conventional fluid dispensing device components such as, but not limited to, off-the-shelf ceramic valve inserts and conventional DC motors having low power requirements. As a result, control of flow rate and/or temperature of a fluid can be achieved at significant cost savings to the consuming public.

An additional advantage to the present invention is provided by the controller associated with the present invention. In particular, the controller incorporated into the apparatus of the present invention may permit communication between the apparatus of the present invention and a portable communication device as will be described in greater detail below. As a result, data transfers, preferably wireless, may occur between the apparatus and the portable communication device. Information contained in the transferred data may include, for example, apparatus status, maintenance information, software updates, parameter values and other information.

A further advantage to the present invention achieved by the use of conventional ceramic valve inserts in lieu of solenoid valve technology is increased reliability and flexibility. In accordance with the preferred embodiment of the present invention, activation and inactivation of fluid flow and incremental control of flow rate and temperature is achieved through the use of one or more ceramic valve inserts cooperating with a logic controlled electric motor. Such an arrangement in accordance with the preferred embodiment permits the use of a number of traditional plumbing components, which facilitates ease of component replacement due to ordinary wear and tear, as well as replacement due to increased demand for component upgrades.

Additional features and advantages of the invention will be set forth in the detailed description which follows and in part will be readily apparent to those skilled in the art from that description or recognized by practicing the invention as described herein.

It is to be understood that both the foregoing general description and the following detailed description are merely exemplary of the invention, and are intended to provide an overview or framework for understanding the nature and character of the invention as it is claimed. The accompanying drawings are included to provide further understanding of the invention, illustrate various embodiments of the invention, and together with the description serve to explain the principles and operation of the invention.

### BRIEF DESCRIPTION OF THE DRAWING FIGURES

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating a fluid dispensing apparatus in accordance with the present invention.

FIG. 2 is a perspective view of a conventional valve assembly incorporated in fluid dispensing apparatus commonly known in the art.

FIG. 3 is a perspective view of a preferred valve body in accordance with the present invention.

FIG. 4A is a perspective view depicting the cooperation of the various elements of the valve body depicted in FIG. 3.

FIG. 4B is a perspective view of the mixing chamber of the valve body depicted in FIG. 3.

FIG. 5A is a top view of the valve body depicted in FIG. 3 with the addition of ceramic valve inserts.

FIG. 5B is cross-sectional view of the valve body taken along lines 5B-5B in FIG. 5A and depicting preferred fluid flow paths when fitted with ceramic valve inserts as shown.

FIG. 6 is a perspective view of two types of conventional ceramic valve inserts that may be employed in accordance with the present invention.

FIG. 7 is a perspective view of a preferred valve assembly in accordance with the present invention.

FIG. 8 is a perspective view of an exemplary motor mount bracket in accordance with the present invention.

FIG. 9 is a top view of the valve assembly depicted in FIG. 7 depicting the cooperation of the motor and the valve insert.

FIG. 10 is a flow chart illustrating a preferred method of operating the fluid dispensing apparatus depicted in FIG. 1.

FIG. 11 is a block diagram illustrating an instruction execution system implementing the control logic of FIG. 1.

FIG. 12 is a block diagram illustrating a data communication system in accordance with a first preferred embodiment of the present invention.

FIG. 13 is a flowchart illustrating the event loop of the control logic 120 in FIG. 12 of Remote management node of the present invention.

FIG. 14 is a flowchart illustrating the communication function called by the event loop 114 from the communication function call 122 illustrated in FIG. 13.

FIG. 15 is a detailed flowchart of the send status command called by the communication module 132 from the send status 146 in FIG. 14.

FIGS. 16A-16D is a flowchart illustrating the general functionality of the overall firmware structure of the fluid dispensing device that forms a part of the first preferred embodiment of the system and method of the present invention.

FIGS. 17A-17B is a flowchart illustrating the Interrupt Driven IR and Battery Thread of the firmware of the fluid dispensing device that forms a part of the first preferred embodiment of the system and method of the present invention.

FIGS. 18A-18J is a flowchart illustrating the IR and Battery Detection Thread of the firmware of the fluid dispensing device that forms a part of the preferred embodiment of the system and method of the present invention.

FIGS. 19A-19F is a flowchart illustrating the Motion Detection Thread of the firmware of the fluid dispensing device that forms a part of the first preferred embodiment of the system and method of the present invention.

FIGS. 20A-20D is a flowchart illustrating the Motion Detection Thread of the firmware of the fluid dispensing device that forms a part of the first preferred embodiment of the system and method of the present invention.

FIG. 21 is a block diagram illustrating the data unit descriptions of a Broadcast signal.

FIG. 22 is a block diagram illustrating the data unit descriptions of an Attention signal.

FIG. 23 is a block diagram illustrating the data unit descriptions of a Connected Mode request signal.

FIG. 24 is a block diagram illustrating the data unit descriptions of a Status signal.

FIG. 25 is a block diagram illustrating the data unit descriptions of a Set signal.

FIG. 26 is a block diagram illustrating the data unit descriptions of a Program signal.

FIG. 27 is a block diagram illustrating the data unit descriptions of an End signal.

FIG. 28 is a graphical depiction of the graphical user interface of a handheld computer illustrating five (5) exemplary user options, including three options that incorporate an optical link with the fluid dispensing device of the present invention, “Get Faucet Data”, “Adjust Faucet”, and “Scan For Problems”.

FIG. 29 is a graphical depiction of the graphical user interface of a handheld computer illustrating the “Get Faucet Data” option form that allows a user to retrieve current fluid dispensing device parameters.

FIG. 30 is a graphical depiction of the graphical user interface of a handheld computer illustrating the “Adjust Faucet” option form that allows a user to edit current fluid dispensing device parameters.

FIG. 31 is a graphical depiction of the graphical user interface of a handheld computer illustrating the “Scan For Problems” option form that allows a user to retrieve Broadcast signals as diagrammed in FIG. 21 from a set of fluid dispensing devices.

FIGS. 32A-B is a flowchart illustrating the overall software flow of the firmware structure of the fluid dispensing device as shown in FIGS. 16A-16D.

FIG. 33 is a flowchart illustrating the Broadcast functionality of the fluid dispensing device and the data unit that is depicted in FIG. 21.

FIG. 34 is a diagram of a conventional electronically operated dispensing device.

FIG. 35 is a diagram illustrating a second preferred electronically operated dispensing device incorporating a portable communication device in accordance with the present invention.

FIG. 36 is a schematic diagram of an exemplary remotely managed dispensing system incorporating the dispensing apparatus depicted in FIG. 35.

FIGS. 37A-37F depict of exemplary control and information screens displayed by the portable communication device (PCD) depicted in FIG. 36.

FIG. 38 is a block diagram illustrating a the preferred elements of the control module depicted in FIG. 35.

FIG. 39 is a block diagram illustrating the preferred elements of the transmitting portion of the control module depicted in FIG. 38.

FIG. 40 is a diagram of timing relations for pulses transmitted by the dispensing apparatus of FIG. 35.

FIG. 41 is a block diagram illustrating the preferred elements of the receiving portion of the control module depicted in FIG. 38.

FIG. 42 is a diagram illustrating the location of emitter and receiver elements on the sensor module of the dispensing apparatus depicted in FIG. 35.

FIGS. 43A-43C illustrate various views of a front-to-back mounting of photo diodes in accordance with a preferred embodiment of the present invention.

### DETAILED DESCRIPTION OF THE PREFERRED EMBODIMENTS

Reference will now be made in detail to the present preferred embodiments of the invention, examples of which are illustrated in the accompanying drawing figures.

Wherever possible, the same reference numerals will be used throughout the drawing figures to refer to the same or like parts.

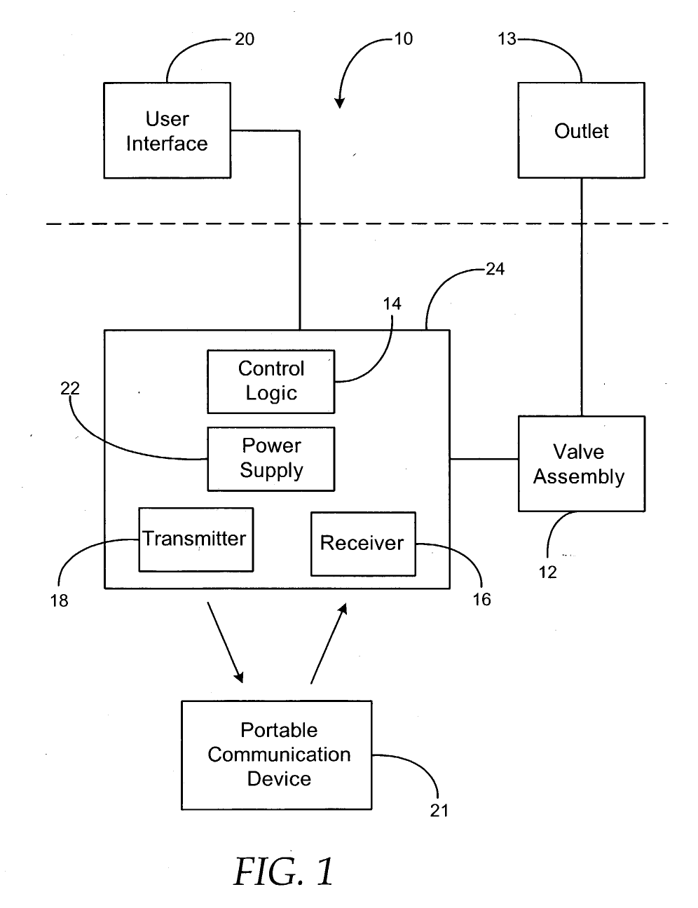

FIG. 1 schematically depicts an exemplary fluid dispensing apparatus 10, which in general, includes a valve assembly 12 communicating with a controller 24. A user preferably provides desired fluid temperatures and flow rates, via user interface 20, to the controller 24. The controller 24, in response to the desires of the user, sends control signal(s) to the valve assembly 12, which utilizes the control signal(s) to position the valve(s). When the fluid dispensing apparatus 10 is utilized to supply water to an outlet 13, such as a faucet, the input fluids to the valve assembly are preferably cold water and hot water. The output of the valve assembly may be a mixture of cold water and hot water, cold water or hot water.

In a preferred embodiment of the present invention, the user interface 20 may be a touch pad type user interface. The touch pad type interface preferably has several keys for user input and a LCD display panel. Preferably, a user may select a desired temperature and/or flow rate and send the information to the controller 24. In addition this information may be stored in memory for later use. Such an arrangement may allow different users to have different stored settings for fluid dispensation at different temperatures and flow rates. For example, a first setting could be used by a mother of a household, a second setting could be used by the father of the household, a third setting could be used by the son of the household, and a fourth could be used by the daughter of the household. A “Turn Off” key on the touch pad may be used to turn the water off or the water may be automatically turned off after a preset time value provided by a user or a technician that installs the fluid dispensing apparatus. Such flow and temperature settings from the touch pad could easily be stored in memory and selected with one or more key strokes.

In another embodiment the user interface 20 may be voice activated utilizing a microphone and speaker arrangement to select a desired water flow and water temperature setting. A variety of commands and the identity of the person speaking could be recognized by a voice recognition system. Outputs from the voice recognition system may then be furnished as input signals to the controller 24. Feedback to the user for such an embodiment is preferably provided by the speaker. In another embodiment, user interface 20 may be a transmitter 18 and receiver 16 in communication with a portable communication device 21. The communication channel for exchanging information may be wireless, such as an infrared system, or may have a wireline channel. As will be described below the transmitter 18, receiver 16, and the portable communication device 21 may also be used to exchange maintenance information and update controller software.

The controller 24 includes control logic 14 and a power supply 22, such as, but not limited to, a battery pack. The control logic 14, receiver 16, transmitter 18 and power supply 22 of controller 24 are preferably housed within a protective box. Among other things, the protective box allows limited access to the electronic components of controller 24 of the fluid dispensing apparatus 10, inhibits vandalism, and also provides a substantially dry environment for the electronic components housed therein.

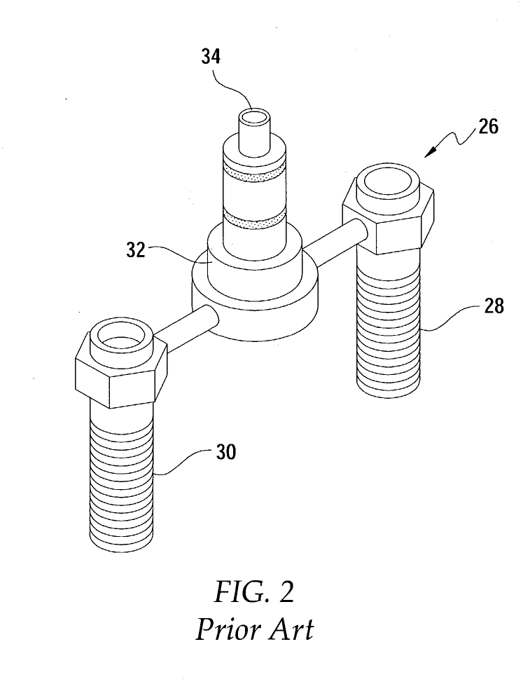

While fluid dispensing apparatus 10 is applicable for use with any number of fluid dispensing devices, it is particularly well suited for, and will be described hereafter with respect to, its use in the field of water dispensing devices such as faucets. Those of skill in the art will recognize that fluid dispensing apparatus 10 may also be applicable for use with showers, toilets, and other fluid dispensing devices. This being said, and with reference to FIG. 2, a conventional valve assembly 26 incorporated in most faucets used today includes a cold water input 28, a hot water input 30, a mixing area housing 32, and a mixed water output 34. Generally speaking, manually operated handles (not shown) control valves seated within valve assembly 26 downstream of the mixing area housing 32. Generally speaking, flow rate and temperature control of water discharged from the mixed water output 34 is controlled by a user manually manipulating the handles (not shown) to increase and/or decrease the amount of hot and/or cold water flow through the valves (not shown), as desired. This process is repeated any time a user wishes to dispense water from the faucet in which valve assembly 26 is housed.

A similar valve assembly is employed in existing electronically controlled faucets. Generally speaking, such similar valve assemblies include solenoid valves which cooperate with the hot and cold water inputs to electronically control the flow of hot and cold water through the valves. In commercial settings such as hotels, such faucets are activated and inactivated utilizing IR sensing techniques. Typically a desired temperature of the mixed water output is selected prior to installation of such electronically controlled faucets so that the solenoid valves automatically open a preset distance to achieve the desired temperature. Changing the desired temperature typically requires a technician or other maintenance personnel to recalibrate such electronically controlled faucet such that the solenoid valves provide either more or less fluid flow.

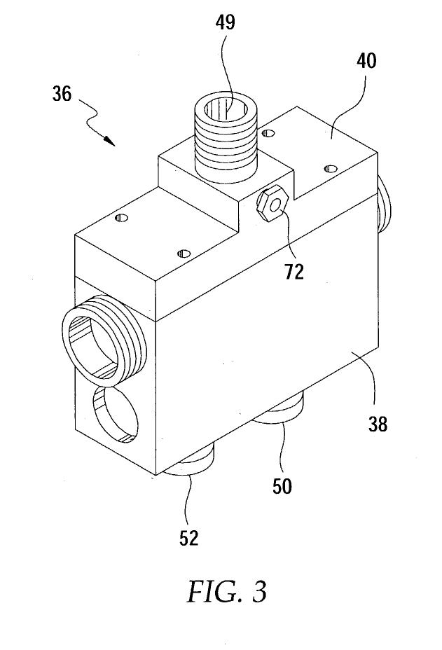

Turning now to the preferred embodiments of fluid dispensing apparatus 10 of the present invention, valve assembly 12 preferably includes electronically controlled valves mounted in a valve body or housing 36 depicted in FIG. 3. Valve body 36 preferably includes a valve frame 38 and a mixing chamber 40. Although shown in the drawing figure as two separate components, valve frame 38 and mixing chamber 40 could be formed as a unitary component. As will be described in greater detail below, while valve body 36 includes a cold water input 50, a hot water input 52, and a mixed water output 49 similar to those embodied in valve assembly 26 described above, valve assembly 12 having valve body 36 differs drastically from valve assembly 26 in both construction and functionality.

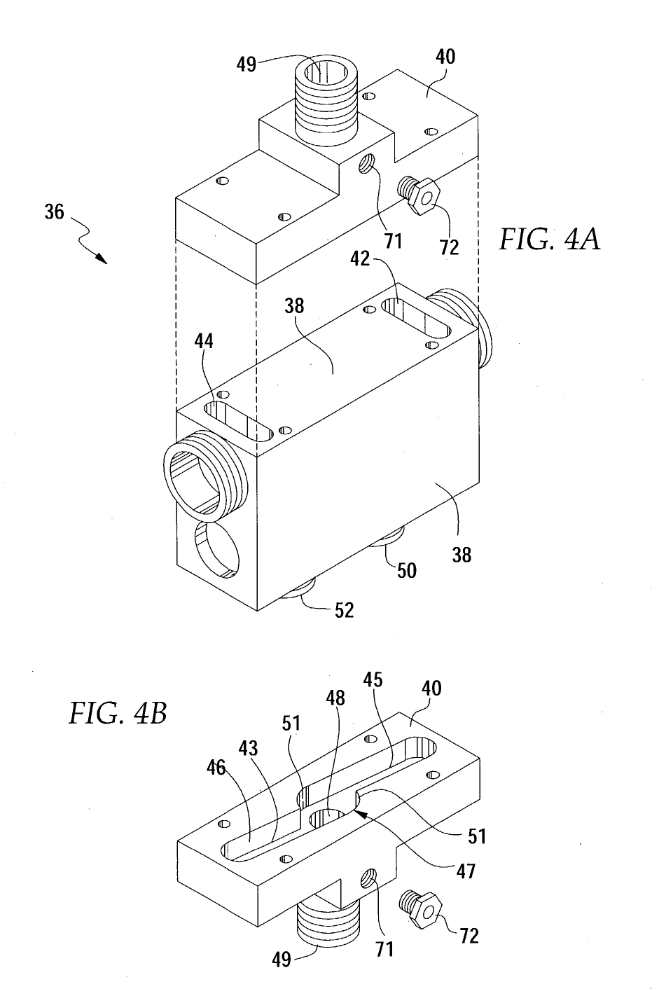

A first point of distinction between valve body 36 and valve assembly 26 is shown clearly in FIGS. 4A and 4B. Valve frame 38 includes a first fluid output 42 and a second fluid output 44 which provide a pathway for the flow of cold and hot water, respectively. Mixing chamber 40 includes a mixing channel 46 and a mixed fluid input passage 48. When mixing chamber 40 is securely affixed to valve frame 38, mixing chamber 40 and valve frame 38 together define an area of convergence 47 adjacent mixed fluid input passage 48. The mixed fluid leaves the valve body 36 via mixed fluid output passage 49. The area of convergence f47 acilitates the mixing of the hot and cold water passed through valve body 36. A sensor aperture 71 preferably provided in the mixing chamber 40 to accept a sensor housing 72. In a preferred embodiment, sensor aperture 71 is preferably in fluid communication with a passageway extending between input passage 48 and output passage 49. A sensor (not shown) such as a pressure sensor, temperature sensor (e.g. a thermistor) or a combined pressure/temperature sensor may preferably be housed within sensor housing 72 to measure temperature and/or pressure, and provide feedback to controller 24 to facilitate closed loop control of fluid dispensing apparatus 10, if desired.

In operation, as cold water exits first fluid output 42 and hot water exits second fluid output 44 of valve frame 38, cold and hot water are forced, typically by pressure, into mixing channel 46 that may preferably lie adjacent first fluid output 42 and second fluid output 44. Both the cold and hot water may then preferably be guided toward the center of mixing channel 46 where the hot and cold water converge at a location adjacent to mixed fluid input passage 48. This area of convergence 47 is preferably defined approximately midway between the ends of channel 46, but could be located closer to one end rather than the other. As shown in FIG. 4B, the shape of mixing channel 46 preferably brings the hot and cold water streams into contact with one another via substantially non-co-linear parallel pathways (i.e., linearly offset from one another) 45 and 43, respectively. As the cold and hot water streams converge, the water streams preferably rotate and a swirling action ensues. This swirling of the hot and cold water streams (rotational mixing of the hot and cold water) continues as the combined water stream is forced into mixed water input passage 48, thereby facilitating rapid mixing of the hot and cold water. As a result, a homogenous mixed water stream having a substantially uniform temperature is discharged from the mixed water output 49 of mixing chamber 40.

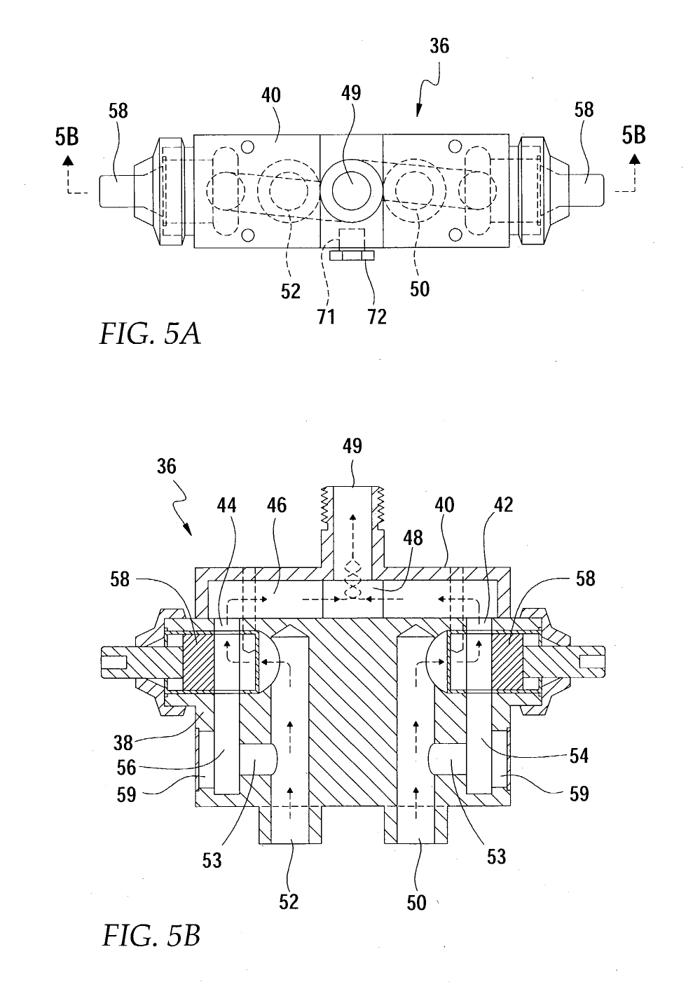

Additional aspects and features of valve assembly 12 of the present invention are depicted more clearly in FIGS. 5A and 5B. Valve frame 38 of valve assembly 12 includes a cold water input cavity 50 and a hot water input cavity 52 for receiving cold and hot water, respectively, from traditional copper, brass, plastic, or other tubing utilized in the plumbing industry. In accordance with a preferred embodiment of the present invention, cold water entering the cold water input cavity 50 traverses the length of the cavity as indicated by directional arrows in FIG. 5B then passes through the bottom and then side of ceramic valve insert 58, when open, to cold water output cavity 54. Hot water entering hot water input cavity 52 traverses the length of the cavity as indicated by directional arrows in FIG. 5B, then passes through the bottom and then side of ceramic valve insert 58, when open, to hot water output cavity 56.

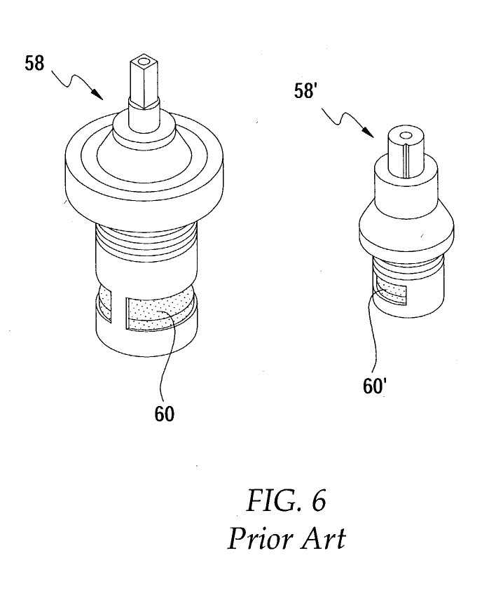

Traditional ceramic valve inserts 58 may preferably be inserted into ceramic valve cavities of valve frame 38 such that the ceramic valve inserts 58 communicate with cold water output cavity 54 and hot water output cavity 56. The exemplary valve body 36 depicted in FIGS. 5A and 5B is shown having two additional ceramic valve cavities 59 for the optional receipt of additional ceramic valve inserts 58′ (FIG. 6). Although not required, the additional ceramic valve cavities 59 provide for a greater flexibility of use. Because there are a number of models of conventional ceramic valve inserts 58, 58′ in use in commerce, exemplary valve body 36, configured as shown in FIGS. 5A and 5B, provides a user with multiple options for types and designs of ceramic valve inserts 58, 58′. Generally speaking, only two ceramic valve inserts 58 or 58′ (one for the hot water and one for the cold water) will be used at any given time in accordance with the operation of the present invention. Accordingly, additional ceramic valve cavities 59 are not necessary for the proper operation of the present invention. However, if valve assembly 36 is configured as shown in FIGS. 5A and 5B, ceramic valve cavities 59 should preferably be plugged or otherwise fitted with a ceramic valve insert 58′ that is positioned in the closed or fluid flow off position. If not so configured, water may otherwise be discharged from ceramic valve cavities 59, thereby preventing proper operation of valve assembly 36.

Two exemplary ceramic valve inserts 58 and 58′ are depicted in FIG. 6. As shown clearly in the drawing figure, ceramic valve insert 58 differs significantly in design from ceramic valve insert 58′. Generally speaking, the functionality provided by ceramic valve insert 58 and 58′ are substantially equivalent, as is the functionality of other ceramic valve inserts commonly known in the art. Each ceramic valve insert 58 and 58′ includes a ceramic valve insert passageway 60 and 60′. As will be described in greater detail below, rotation of ceramic valve inserts 58 and 58′ within either conventional valve assembly 26 or valve body 36 may enable on/off flow of water and control of the flow rate of such water through the valve assembly in which they are installed.

Returning again to FIG. 5B, ceramic valve inserts 58 are preferably positioned with respect to cold water output cavity 54 and hot water output cavity 56 such that the ceramic valve insert passageways 60 (FIG. 6) communicate with the cold water output cavity 54 and hot water output cavity 56. When rotated as described below, the ceramic valve passageways 60 provide a pathway for the flow of water through input cavities 50, 52, and output cavities 54 and 56, such that cold water is discharged through first fluid output 42 and hot water is discharged through second fluid output 44. As the hot and cold water continues to flow, mixing channel 46 defined by mixing chamber 40 and valve body 38 directs both the cold and hot water toward the center of mixing channel 46. The mixing channel 46 includes a cold water pathway 43 and a hot water pathway 45 (FIG. 4B) that are axially offset and come together at an area of convergence 47. Once the hot and cold water reach the area of convergence 47 formed by shoulders 51 located beneath and adjacent mixed fluid input passageway 48, the cold and hot water are rotationally mixed as described above while continued water flow forces the rotationally mixed water into the mixed fluid input passageway 48. When the mixed water is discharged from mixed fluid input passageway 48, mixed water having a substantially uniform temperature is achieved.

Also shown in FIG. 5A is a sensor aperture 71 and a sensor housing 72 which may hold a pressure sensor and/or a temperature sensor (not shown), preferably downstream of mixing chamber 40, and more preferably downstream of mixed fluid input passageway 48. When incorporated, such a temperature sensor can provide real-time temperature output data that may be displayed on the user interface 20 communicated to the remote handheld device 21, or provided as a feedback signal to the controller 24. Similarly, a pressure sensor may be used to provide real-time pressure output data that may be displayed on the input/output device 20, communicated to a remote handheld device 21 (now shown), or provided as a feedback signal to the controller 24. Those of skill in the art will recognize that the temperature and pressure sensors may be co-located in a single housing.

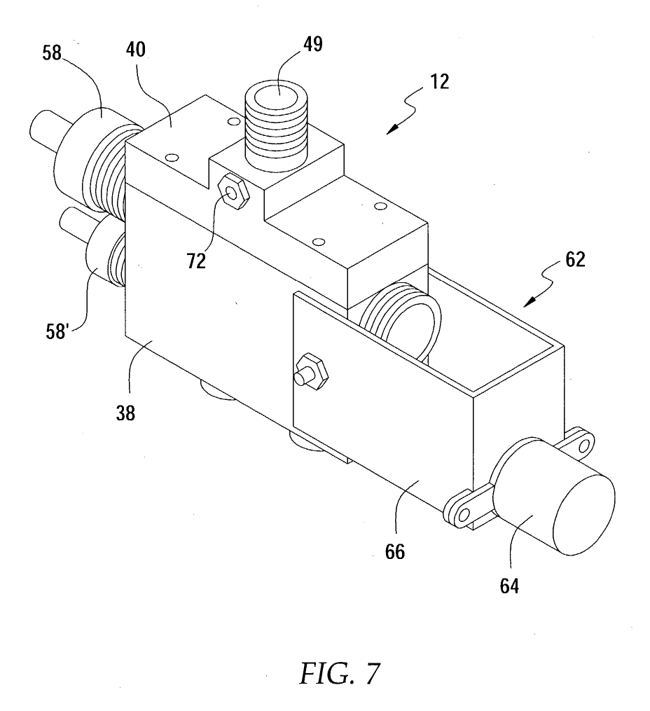

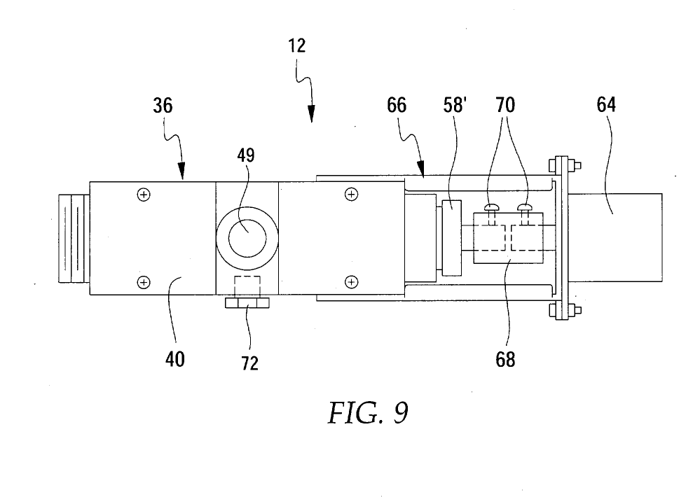

As depicted in FIG. 7 the ceramic valve insert 58′, shown more clearly in FIG. 9, is coupled to a motor assembly 62. Preferably a DC motor 64 attached to motor mount bracket 66 of the motor assembly 62 rotates the ceramic valve insert 58′ in response to a control signal(s) from the controller 24. Although motor 64 is shown coupled to a ceramic valve insert 58′ in FIG. 7, it will be understood by those skilled in the art that the motor 64 may be coupled to a ceramic valve insert 58, depending upon the desires of the user or the availability of a particular ceramic valve insert 58, 58′. In either of the just described arrangements, control signals from the controller preferably cause the valves to move the ceramic valve inserts incrementally to any location between a zero flow rate (off) to a fully on flow rate (the maximum allowed by the valve) in response to the desires of the user. A first control signal from the controller controls the motor that positions the ceramic valve insert 58′ in communication with the cold water output cavity 54 and a second control signal controls the motor that positions the ceramic valve insert 58′ in communication with the hot water output cavity 56. For the preferred embodiment the DC motor 64 is selected to operate from a low voltage provided by power supply 22, preferably a battery pack.

Several control methods may be used to position the valves that are in communication with the DC motors described above. For example, an open loop control system may be implemented by applying a first DC voltage to a first motor driving a first ceramic valve insert associated with cold water, for a first selected period of time corresponding to a desired cold water flow rate. In addition a second DC voltage may be applied to a second motor driving a second ceramic valve insert associated with hot water, for a second selected period of time corresponding to a desired hot water flow rate. For example, if the power supply is nine volts DC then both the first DC voltage and the second DC voltage are preferably nine volts DC. When the first time and the second time are equal, then the temperature of the mixed water is the average value of the temperature of cold water and the hot water. The rate of water flow is dependent on the characteristics of the DC motor, the water pressure, the specifications of the ceramic valve inserts and other factors. Look-up tables preferably provide the correlation between the control signals, the flow rates and the temperature of the cold water and the hot water.

A feedback control system may also be used to generate the control signals for motor position control that provides the desired temperature and flow rates. If the sensor housing 72 includes a sensor that provides both pressure and temperature information to the controller, the controller may provide an actuating signal to minimize error between the measured temperature and the desired temperature and between the desired flow rate and the actual flow rate. Since flow rate is proportion to pressure, the flow rate may be determined if the pressure is known. In other control systems it may be useful to have valve position sensors to provide feedback information. Those skilled in the art will recognize that other control methods, some of which may have other feedback information, may be used to provide a desired flow rate and temperature. Such variations in control methods would fall within the scope of the present invention. It would also be know to those skilled in the art, that while preferred motor 64 is a DC electric motor, other motors such as, but not limited to, hydraulic, or pneumatic motors may be used as well.

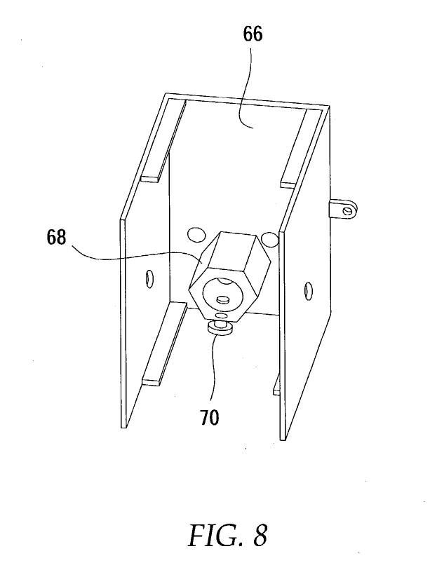

As shown in FIG. 8, motor mount bracket 66 is preferably constructed of aluminum, sheet metal, steel, or some other preferably non-corroding metal material. In a preferred embodiment, motor mount bracket 66 is sized and shaped to be received on an end of valve body 36 and includes a linkage assembly 68 fitted with fasteners 70. As shown in FIG. 9, motor mount bracket 66 is affixed to valve body 36 with screws, bolts, or other fasteners such that ceramic valve insert 58′ is received within linkage assembly 68. Ceramic valve insert 58′ is preferably secured within linkage assembly 68 with screws or other fasteners 70. When instructed by control logic 14 of controller 24 (FIG. 1) motor 64 is engaged to drive linkage assembly 68, which in turn rotates ceramic valve insert 58 to the desired position.

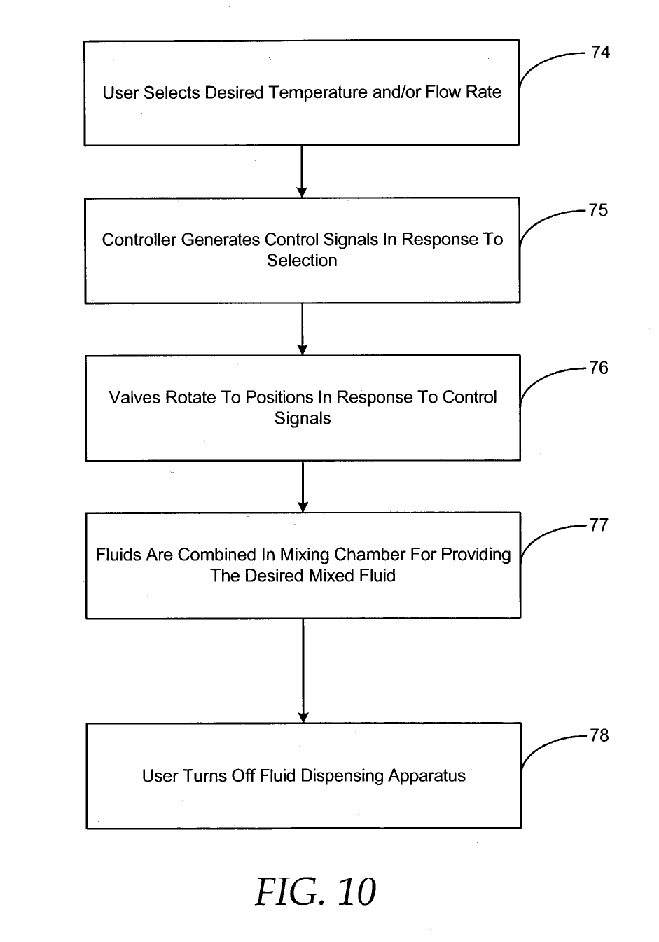

A preferred method of electronically controlling fluid dispensation in accordance with the present invention will now be described with reference to FIG. 10. A user desiring water dispensed at a certain temperature and/or flow rate may select parameters by depressing keys on user interface 20 as indicated at block 74. Upon receiving an electronic signal indicative of the selected parameters, the controller 24 generates control signals in response to the selected parameters, as indicated at block 75. The control; signals are preferably generated by a program contained in memory and processed by control logic 14. The control signals, one for each of the motors driving the ceramic valve inserts, are preferably transmitted to the motors to drive and thus rotate the valves, as indicated at block 76, to provide for a selected flow rate at each valve. The cold water and hot water dispensed from the valves may then be combined in mixing chamber 40, as indicated at block 77, to provide water output having the parameters selected by the user. When the user no longer desires water flow an off key on the user interface may be used to turn off fluid flow, as indicated at block 78.

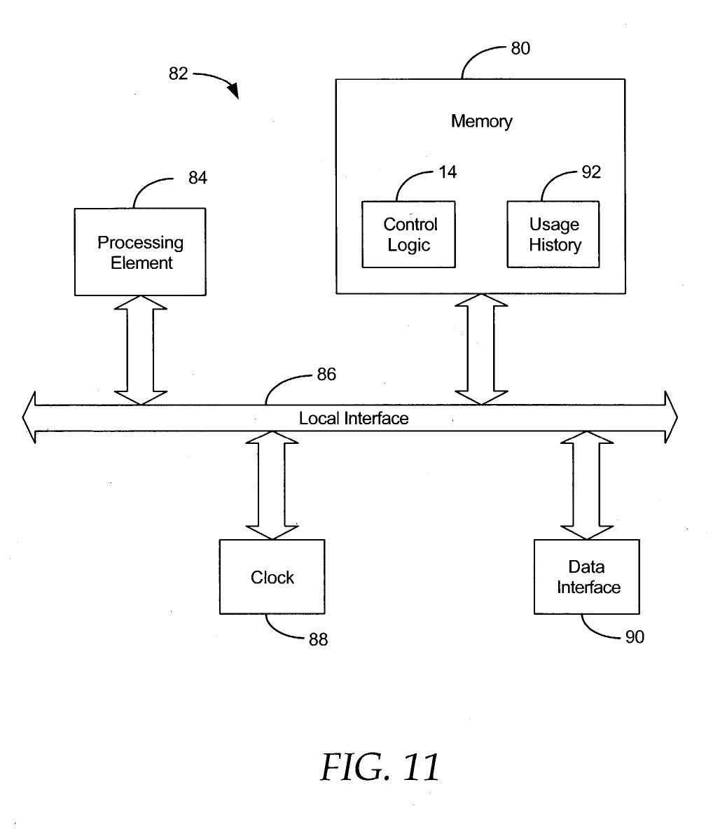

As shown in FIG. 1, the controller 24 includes control logic 14 configured to control the operation and functionality of the controller 24. The control logic 14 can be implemented in software, hardware, or a combination thereof. In the preferred embodiment, as illustrated by way of example in FIG. 11, the control logic 14, along with its associated methodology, is implemented in software and stored in memory 80 of an instruction execution system 82, such as a microprocessor, for example. A portion of memory 80 may also be available for storing usage history 92 that may provide a maintenance technician with information about the fluid dispensing apparatus 10.

Note that the control logic 14, when implemented in software, can be stored and transported on any computer-readable medium. In the context of this disclosure, a “computer-readable medium” can be any means that can contain, store, communicate, propagate, or transport a program. The computer readable-medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. As an example, the control logic 14 may be magnetically stored and transported on a conventional portable computer diskette.

The preferred embodiment of the system 82 of FIG. 11 includes one or more conventional processing elements 84, such as a central processing unit (CPU), that communicate to and drive the other elements within the system 82 via a local interface 86, which can include one or more buses. Furthermore, the system 82 may include a clock 88 that may be utilized to track time and/or control the synchronization of data transfers within the system 82. The system 82 may also include one or more data interfaces 90, such as analog and/or digital ports, for example, for enabling the system 82 to exchange data with the other elements of the controller 24.

The controller 24 includes a user interface 90 that enables a user to provide, to the controller 24, various inputs, such as a desired setting for the temperature and flow rate of water. During normal operation, the control logic 14 is configured to control the operation of the ceramic valve inserts 58, 58′ in an attempt to maintain desired temperature and flow rates of the fluid dispensing device 10.

To achieve the foregoing functionality, the controller 24 may utilize a temperature sensor and/or a pressure sensor contained in sensor housing 72 for sensing the current temperature and pressure in the valve assembly 12. The temperature sensor may transmit a value of the sensed temperature to the control logic 14, which may, in a feedback control method, adjust valves in response to the sensed temperature value. More specifically, the control logic 14 preferably provides to the motor, instructions to open the hot water valve further if the sensed temperature is below the desired temperature and the control logic 14 preferably provides to the motor, instructions to close the valve further to reduce the hot water flow if the sensed temperature exceeds the desired temperature. One of skill in the art will recognize, of course, that either of the hot or cold water flows, or both may be altered to effect the desired temperature and/or flow rate changes in accordance with the present invention.

As briefly described above, the remote communication between a portable, preferably hand-held device, and fluid dispensing apparatus 10 of the present invention may be implemented in any number of ways. By way of example only, communication transmitter(s) and receiver(s) may be housed within the controller 24 as depicted in FIG. 1, housed within an outlet 13, such as a faucet neck, or may be housed in both controller 24 and outlet 13, among other locations. This being said, the remote communication aspects of the present invention will now be described with reference to the communication transmitter(s) and receiver(s) being housed within the neck of a faucet. The description that follows, however, will be equally applicable to other configurations. Moreover, the fluid dispensing device described below will be described as an IR activated fluid dispensing device, preferably a faucet. One of skill in the art will recognize that all or portions of the following description is also applicable for non-IR activated fluid dispensing devices. More specifically, when the faucet or other device does not incorporate IR sensing components, one of skill in the art will recognize that the controller 24 of the present invention may preferably not operate in a detection mode (Broadcast Mode) as described below. Instead, controller 24 and portable communication device 21 of the present invention may preferably exchange data/information in accordance with the communication mode (Connected Mode) of operation described in detail below.

If however, the present invention incorporates active sensing capabilities, such as an IR emitter and detector housed in the neck of the faucet, the solenoid valve described below may be replaced with the valve assembly of the present invention. In such an embodiment, the IR emitter and detector may continue to activate (turn on the water flow) in response to the detection of the presence of hands or other objects, but the valve assembly 12 (rather than the solenoid valve), would dispense water (hot and cold) in accordance with the users desired flow rate and temperature requests as described above.

All of this being said, the communication aspects of the present invention will now be described with reference to an embodiment incorporating IR sensing functionality.

The hardware elements of one such embodiment may include Remote Management Node 100 and Managed Node 102. Remote Management Node 100 includes generally an optical interface port 104, a processing element 110, and a memory element 112. Managed Node 102 includes generally an optical interface port 106, an electronics module 114, and a Mechanical Element 123. The optical interface port 106 of Managed Node 102 includes an emitter 118 and a detector 116. The emitter 118 has a pulse range 119 wherein an object within the arc showing pulse range 119 will reflect a pulse transmitted from emitter 118. Communication between Remote Management Node 100 and Managed Node 102 is accomplished by an optical link 108 in free space between the optical interface port 104 and 106.

The Memory Element 112 of Remote Management Node 100 houses the remote management control logic 120. Processing element 110 manipulates the optical interface port 104.

Managed Node 102 further includes Mechanical Elements 123, known to those skilled in the art, necessary for controlling an electronically operated appliance such as, but not limited to, a fluid-dispensing device 102. The electronics 114 include further a Managed Node Control Logic 122 that controls functionality of the optical port 106 and the manipulation of Mechanical Elements 123.

The emitter 118 of Managed Node 102 periodically emits a pulse, such as every 250 milliseconds, for example. The pulse emission creates an optical signal in free space. In order for the optical interface port 104 of Remote Management Node 100 to establish an optical link with the optical interface port 106 of Managed Node 102 Remote Management Node Control Logic 120 resides in a memory component 112 of Remote Management Node 100. The Remote Management Node Control Logic 120 can be implemented in software, hardware, or a combination thereof.

The Remote Management Node Control Logic 120 causes the emitter 105 to emit an Attention signal from the optical interface port 104. The Remote Management Node Control Logic 120 is managed and manipulated by the microprocessor 110. The attention signal that is emitted from the optical interface port 104 is transmitted regardless of its detection of a “media quiet” environment. In other words, the Attention Signal is emitted despite the 250-millisecond infrared pulse of the emitter 118 of Managed Node 102.

As previously described, the electronics 114 in cooperation with the Managed Node Control Logic 122 cause the periodic emission of an infrared pulse from the emitter 118. In this regard, the emitter 118 causes such an emission every 250 milliseconds. Prior to emission of the infrared pulse, the detector 116 attempts to detect an attention signal that is emitted from the optical interface port 104 of Remote Management Node 100. If an attention signal is not detected, the emitter 118 is allowed to operate normally, emitting an infrared pulse every 250 milliseconds. If, on the other hand, an attention signal is detected, normal operation of the emitter is discontinued and an optical link 108 is established between the optical interface port 104 and the optical interface port 106. If the attention signal is not detected, then normal operation of the emitter 118 continues.

In the first preferred embodiment of the invention Remote Management Node 100 is a handheld or portable device or computer, and Managed Node 102 is an electronically activated fluid dispensing device. During normal operations, the fluid dispensing device emits an infrared pulse from emitter 118 every 250 milliseconds. If an object is within pulse range of the emitted signal, the signal is reflected and the detector 116 detects the reflected signal. If the detector 116 detects the reflected signal, then the electronics 114 will activate a solenoid 101 causing fluid to be dispensed from the faucet assembly.

A handheld computer 100 allows a remote user to interrupt the normal operation of the Managed Node 102. In order for the handheld computer to communicate with the Managed Node 102, an optical link 108 is established between the optical interface port 104 of the handheld computer 100 and the optical interface port 106 of the fluid dispensing device 102. The optical link allows a maintenance user to perform various maintenance function remotely, including retrieving device-specific data stored by the electronics 114 of the fluid dispensing device 102, adjusting electronics parameters, or reprogramming the software that controls the fluid dispensing device.

### Handheld Computer Software

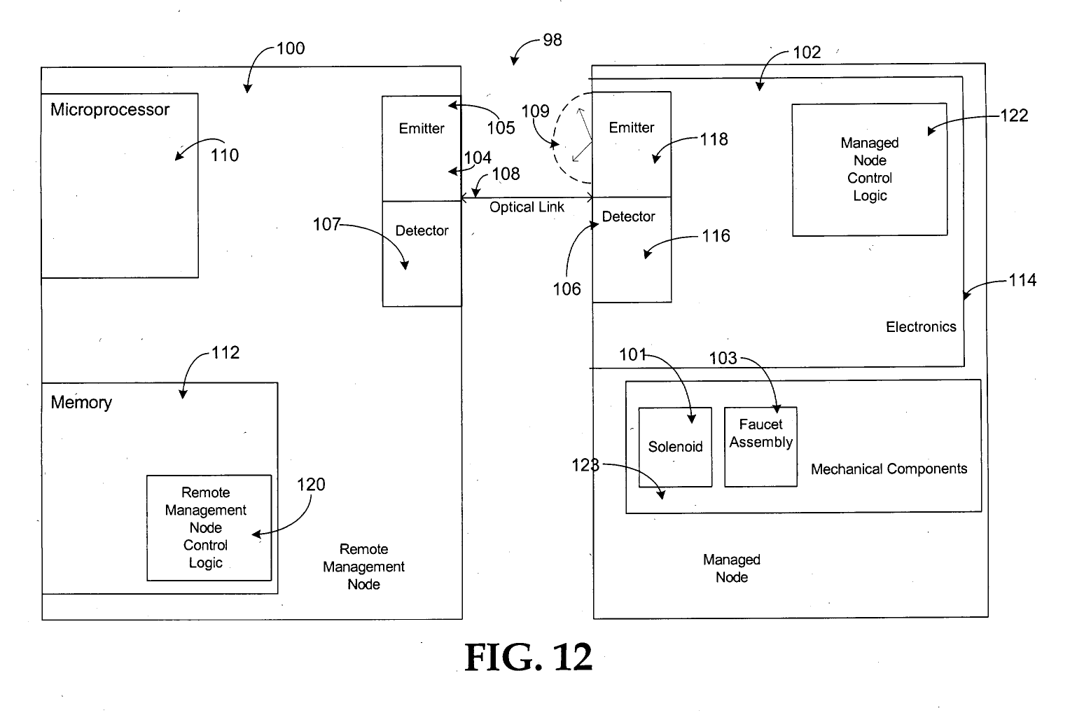

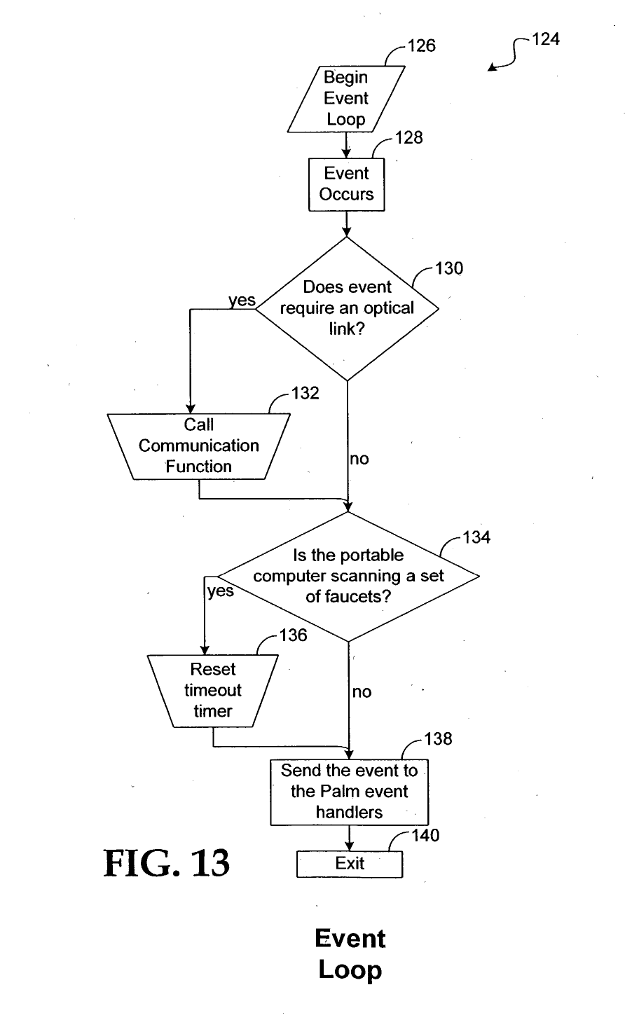

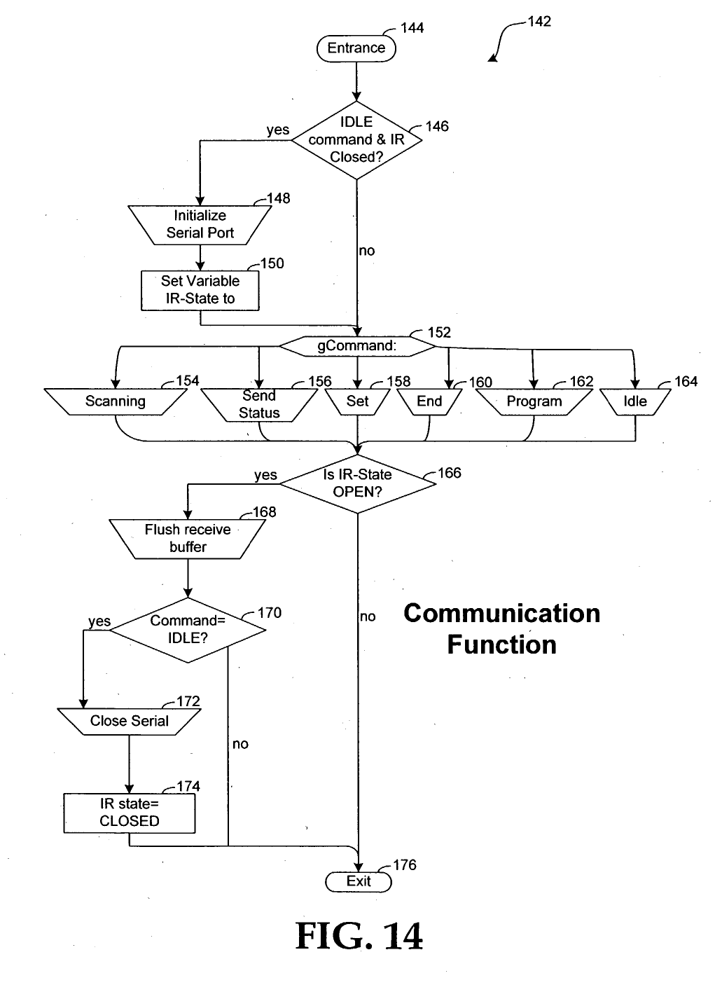

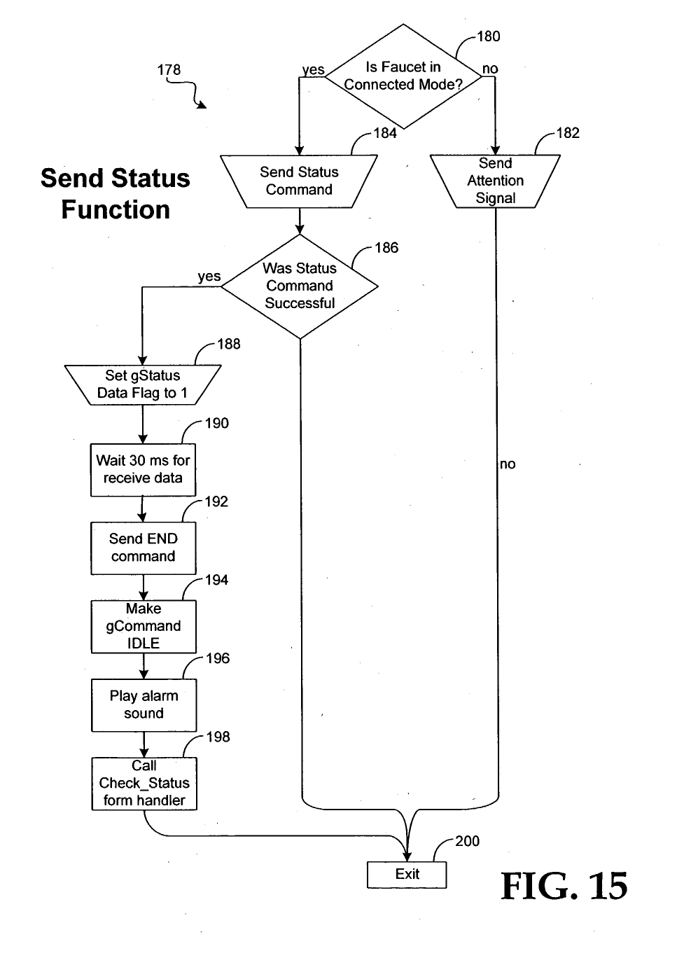

The Remote Management Node Control Logic 120 (FIG. 12) on the handheld computer 100 (FIG. 12) initiates an optical link 108 (FIG. 12) between the optical interface ports 104 and 106 in accordance with a user's instruction. A description of the Remote Management Node Control Logic on the handheld computer 100 is now described in more detail with reference to FIG. 13, FIG. 14, and FIG. 15. The flow charts are merely exemplary and other methodologies may be employed to implement the present invention.

The Remote Management Node Control Logic 120 (FIG. 12) generally controls a user interface, input and output to the user interface, and input and output through optical interface port 104 (communication between optical interface ports). FIG. 13 is a high level illustration of the Remote Management Node Control Logic 120 (FIG. 12). Event loop 124 of the Remote Management Node Control Logic 120 (FIG. 12) executes on the handheld computer 100. In essence, the event loop monitors input and output activity. This monitoring step of the remote management control logic is represented in the event loop 124 by the processing symbol 128. When an event occurs, the event loop 124 then determines whether the event is one that requires the establishment of an optical link between the handheld computer and the fluid dispensing device in decision symbol 130. Events that require an optical link include retrieving data from the fluid dispensing device 102 providing a user data accessibility, reprogramming the Managed Node Control Logic 122 on the fluid dispensing device 102 (FIG. 12), or reconfiguring electronics parameters on the fluid dispensing device 102 (FIG. 12). The decision symbol 130 represents that part in the control logic where the input retrieved from step 128 is analyzed to determine whether the event requires the establishment of an optical link.

If an optical link is not required to perform the function requested in step 128 by the user, then the event loop 124 of the remote management control logic 120 determines whether the user has requested that one or more fluid dispensing devices be scanned as indicated by decision symbol 134. The scanning of various fluid dispensing devices is discussed further herein. If the event does not require the scanning of one or more fluid dispensing devices, then the event requested by the user is processed in step 138 by the palm event handlers that do not require the establishment of an optical link between the handheld computer 100 (FIG. 12) and the fluid dispensing device 102 (FIG. 12).

If at the decision symbol 130 it is determined that the requested event requires an optical link, then the communication function is called in processing symbol 132. The communication function is illustrated in FIG. 14 and is designated generally throughout as reference numeral 142. The communication function is entered from step 132 in FIG. 13 at the input/output symbol 144 in FIG. 14.

The communication function 142 first ascertains the status of the optical interface port 104 (FIG. 12) represented by the decision symbol 146 in the communication function 142. If the port is in a closed state, then the serial port is initialized indicated by the processing step 148. Once the port is initialized, the IR-State variable is set to OPEN in the processing symbol 150. Once the port is initialized and the IR-State is set to OPEN, the handheld computer is now configured for communication with the optical interface port 106 (FIG. 12) of fluid dispensing device 102 (FIG. 12).

The communication function 142 provides six functional capabilities. Each separate function is indicated as a different indicator in the gCommand variable. The next step 152 is represented by a switch symbol serving as a director to the appropriate function as indicated by the gCommand variable. This variable represents the event requested by the user. The six functions available are represented by the processing symbols and include Scanning 154, Send Status 156, Set 158, End 160, Program 162, and Idle 164.

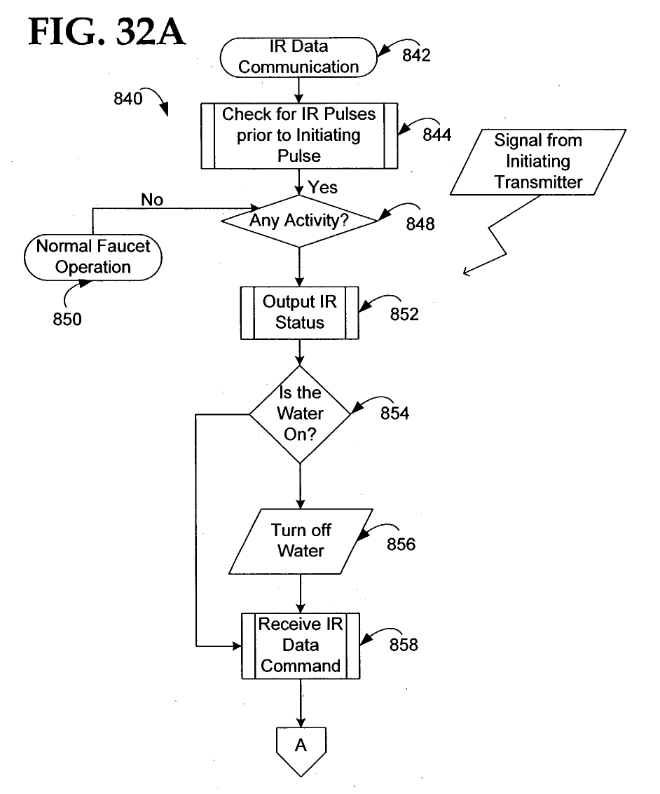

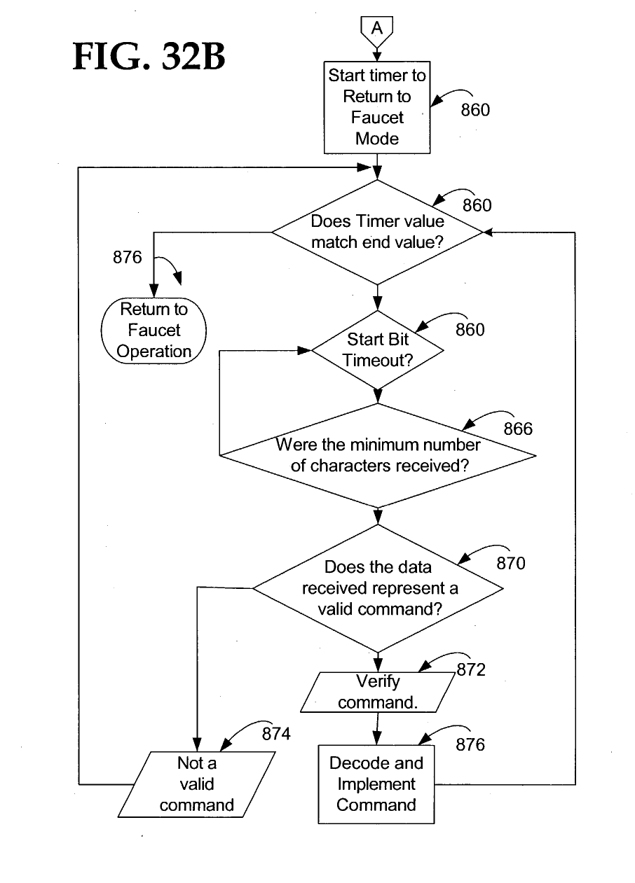

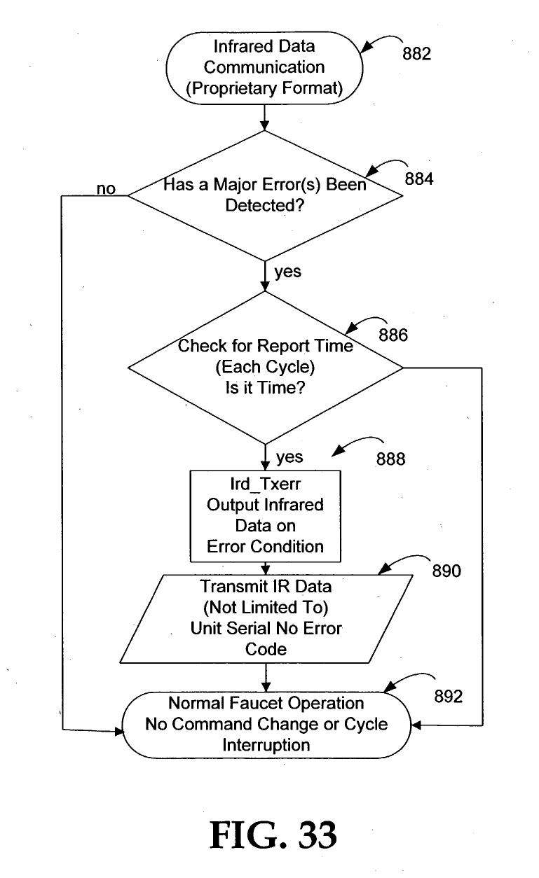

If the user chooses to retrieve from the faucet information about the fluid dispensing device, then at processing symbol 156 the Send Status function 178 in FIG. 15 is called. FIG. 15 illustrates in detail the control logic of the Send Status command function 178. The Send Status function 178 initially determines if the fluid dispensing device is in a connected mode. This step is represented by the decision symbol 180. The connected mode is present when an optical link 108 (FIG. 12) is established. If the connected mode has not been established, then the remote management control logic initiates an optical signal that is emitted from the optical interface port 104 (FIG. 12). This step is represented by the processing symbol 182. The signal is an Attention Signal and is referred to throughout as such. FIG. 32 illustrates the logic flow initiated on the fluid-dispensing device when the handheld device attempts to initiate connected mode. FIG. 32 is described further herein.

If the fluid dispensing device is in connected mode, the Send Status command is sent as represented by the processing symbol 184. The Send Status command requests from the fluid dispensing device a set of data describing various parameters of the device. The set of data includes parameters about the fluid dispensing device including information relating to power, settings, and usage. Power information relating to the fluid dispensing device includes unloaded volts, loaded volts, time in use, and replace battery date. The settings information includes the current operating mode, the range setting, the range offset, delayed settings, and virtual settings. The usage information consists of the number of uses, uses per day, and hours of operation. Other miscellaneous information can include current errors, past errors, software version, PCB number, and engineering change level.

Once the request for the status is sent in processing step 184, the Send Status function 178 determines whether the command was received. This step is indicated in the software function 178 by the decision symbol 186. If the request for status information was successful, a flag is set in the processing step 188 and the data is received by the handheld computer as indicated by the processing symbol 190. The optical link is then terminated when the handheld computer send the End command in step 192. The gCommand variable is set to idle in the processing step 194, an alarm is sounded in processing step 196 to indicate to the user successful receipt, and the Send Status function exits in processing step 200.

If the Status command is not received by the fluid dispensing device, the Send Status function 178 exits in processing symbol 200.

When the Send Status command module 178 exits control is returned to the Communications function 142. In FIG. 14, the Communications function 142 then queries the status of the IR serial port in decision step 166. If the IR-State is OPEN, the receive buffer is flushed in processing step 168, and the gCommand variable is queried. If the command variable is Idle, then the serial port is closed in processing step 172 and the IR-State variable is set CLOSED. The Communications function exits in processing step 176 returning control of the processing to the event loop 124 (FIG. 13).

With reference to FIG. 13, the Event Loop 124 then queries the gCommand variable to determine if scanning is taking place in decision step 134. If scanning is taking place then the “time out” timer is reset in processing step 136. If the handheld computer is not scanning a group of fluid dispensing devices, then the event request is handled by functions that do not require the optical communication link 108 in processing step 138. The event loop then exits in processing step 140.

### Fluid Dispensing Device Firmware

With reference to FIG. 12, the Managed Node Control Logic 122 of the fluid dispensing device 102 is now discussed with reference to FIGS. 32A-B, 16A-16D, 17A-17B, and 18A-18J. FIG. 32 illustrates the basic functional blocks of the fluid-dispensing device showing the fundamental communication components.

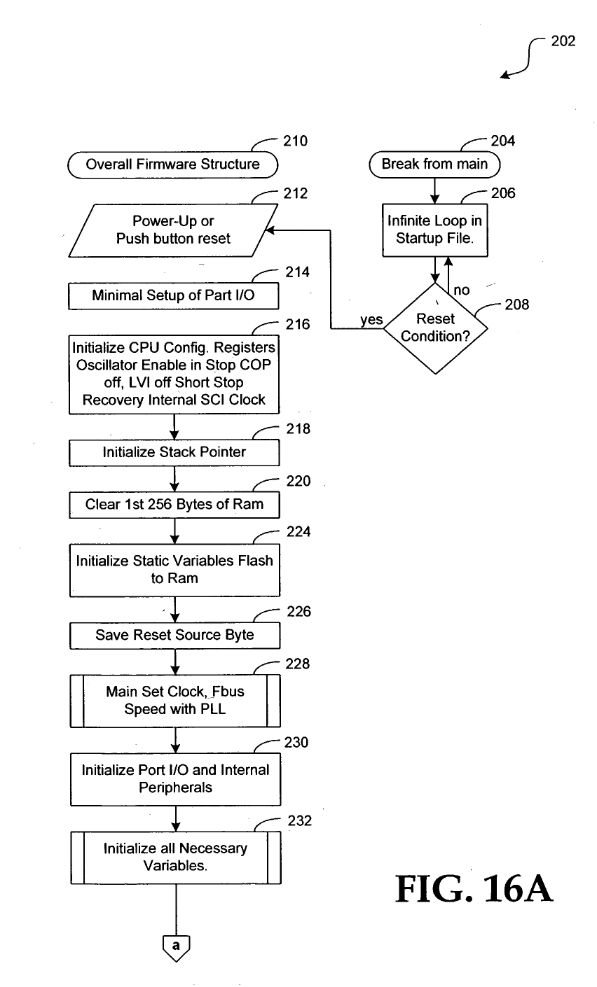

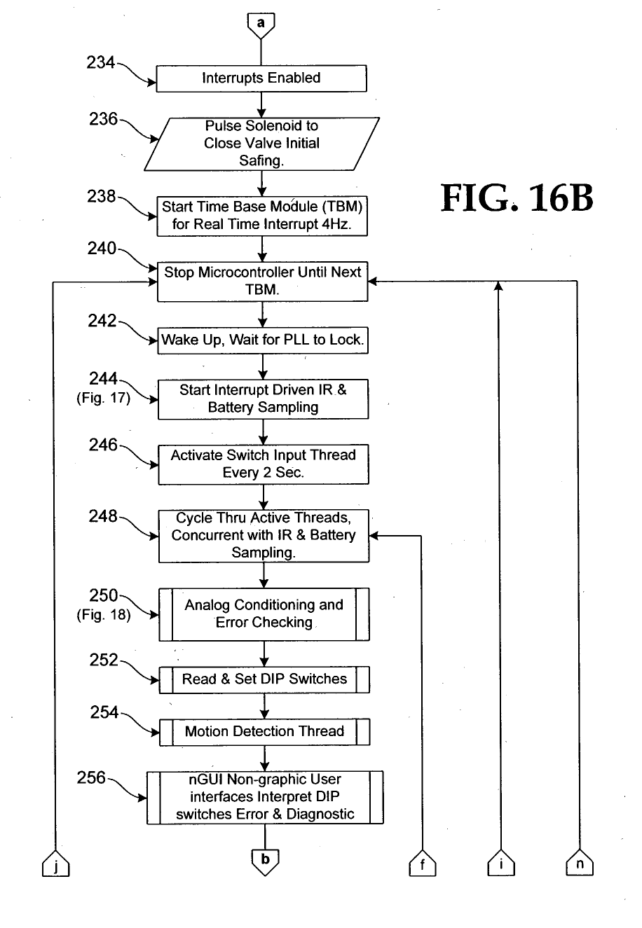

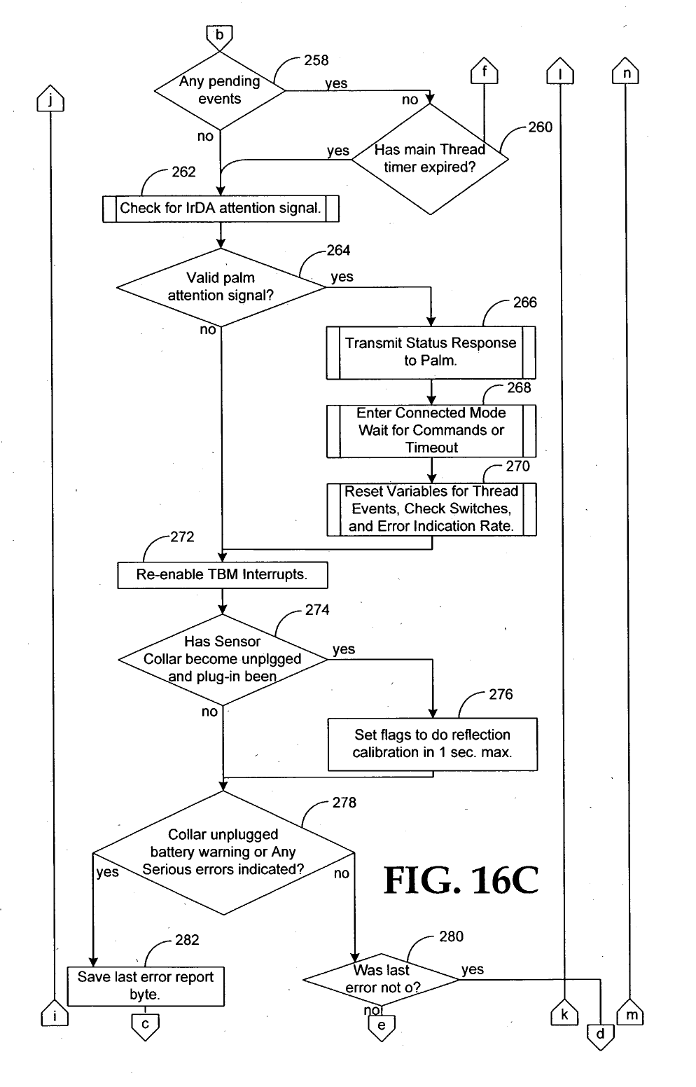

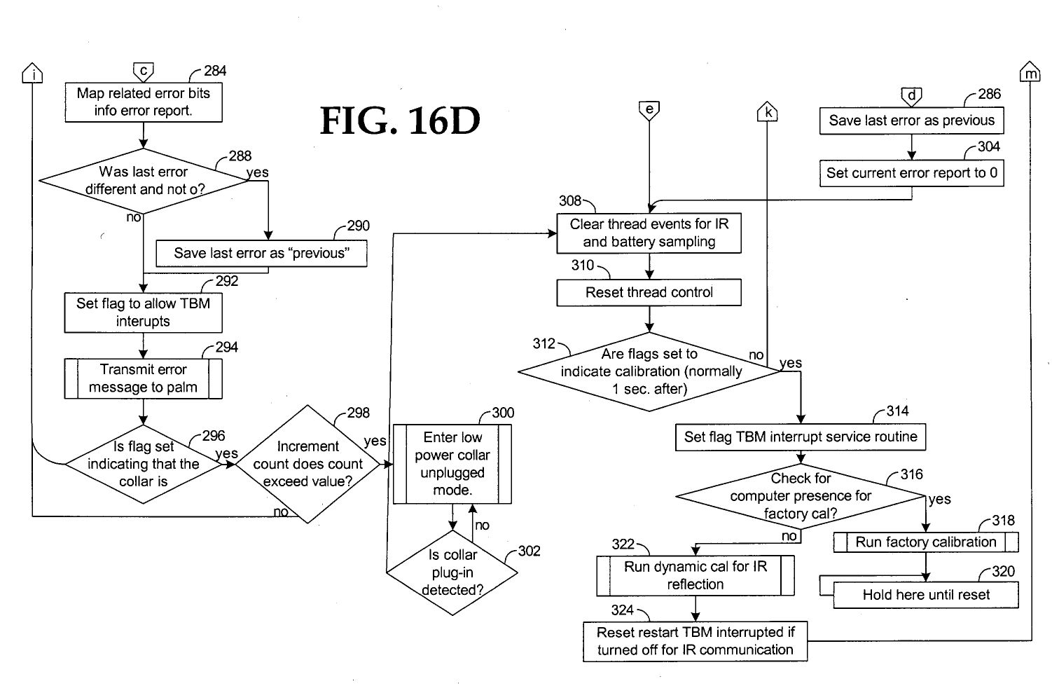

With reference to FIG. 32, the logic flow of the fluid dispensing device response to a request for Connected Mode from a handheld device is shown and is generally referred to throughout as reference numeral 840. The fluid-dispensing device response to a request for connected mode is initiated by an IR signal from the handheld device as shown by the signal transmission block 842. This initiating signal is the Attention Signal as discussed infra. During a pulse cycle, which is discussed further herein and is described in FIG. 16, the detector 116 (FIG. 12) samples its detection range to determine whether an initiating transmission was sent from the emitter 105 (FIG. 12) in a process illustrated by independent process symbol 844. This process samples its detection range for the Attention Signal prior to initiating a detection pulse for object reflection.

The format in which the signal is sent indicates that the signal detected is an Attention Signal, and those skilled in the art will recognize various ways that the Attention Signal can be formatted to accomplish this indication. In a preferred embodiment the Attention signal includes a stream of ‘FF’ characters followed by a linefeed. Also, the duration of the signal is greater than the length of the pulse cycle.

Decision symbol 848 illustrates the query that determines whether the sample received by the detector was an Attention signal (i.e. contained ‘FF’ characters followed by a linefeed. If the signal detected is not the Attention signal, then the fluid-dispensing device continues its normal operation as represented by terminating symbol 850.

If, on the other hand, the Attention Signal is received, the fluid dispensing device responds as indicated in independent process symbol 852. In decision symbol 854 the current state of the water flow is queried. If the water is currently on, the water is turned off as indicated by processing symbol 856, prior to responding to the request for connected mode.

In independent processing symbol 858, the command sent by the handheld computer is received. The various commands that can be sent by the handheld computer are described infra and include Scanning 154, Send Status 156, Set 158, End 160, and Program 152 (FIG. 14).

A timer starts in processing symbol 860 to return to normal operation after a fixed amount of time. Decision symbol 860 determines whether the End command 160 (as shown in FIG. 14 and described supra) has been sent. If the End signal is sent, then the fluid-dispensing device returns to normal operation in terminating symbol 876. If the End command has not been detected, then the process 840 determines in decision symbol 862 whether the entire signal has been sent. If the entire signal has been sent, according to the bit count expected, then the process determines in decision symbol 866 whether the entire signal was sent. If the command is a valid one, as determined by decision symbol 870, then the command is decoded and implemented in processing symbol 876. Connected Mode is then terminated through decision symbol 860 at termination symbol 876.

FIGS. 16A-16D illustrate the control logic 122 that controls the electronics 114 (FIG. 12) of the fluid dispensing device 102, thereby controlling the communication on the fluid dispensing device node side of the optical link 108.

With reference to FIG. 16A, as indicated by the processing symbol 202, the fluid dispensing device is powered on or reset. Numerous setup functions are performed in processing steps 214-234 (FIG. 16A) and 236-238 (FIG. 16B). Specific functions related to data communication operations are indicated by processing symbol 230 including initializing the input/output ports, CPU peripheral initialization, and time base module (TBM) process 236 (FIG. 16B) initialization. The TBM is responsible for the timing of the IR pulse every 250 milliseconds. It performs the real time interrupt that occurs every 250 milliseconds for cycle timing, and it monitors seconds and hours.

With reference to FIG. 16B, a pulse cycle includes generally powering up the microprocessor, attempting the detection of the Attention signal emitted by the handheld computer, emitting a pulse from the fluid dispensing device emitter, and powering down the microprocessor. The processing symbol 240 is the first processing symbol in this process. It indicates that the process element included in the electronics component 114 (FIG. 12) is powered off as a first step in a pulse cycle. The TBM determines that 250 milliseconds have elapsed, and the microprocessor is awakened as indicated by processing symbol 242. In this processing step, the overall firmware process 202 also waits for the phase-locked loop to lock in order to maintain a constant 4.0 MHz for normal operation.

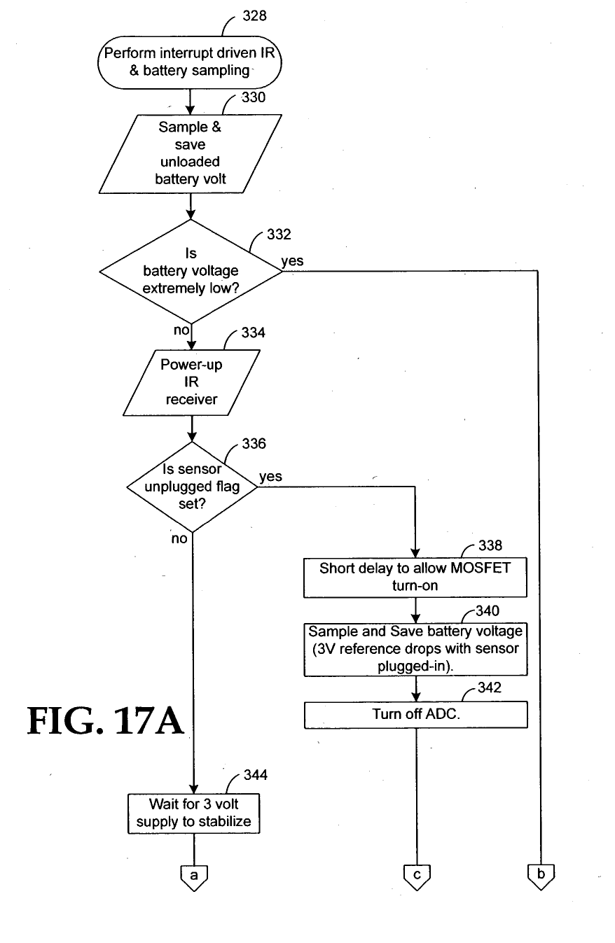

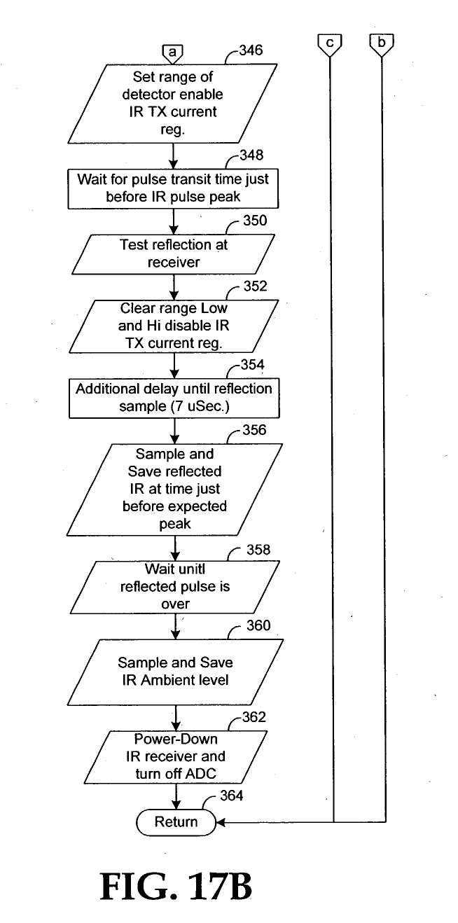

The processing symbol 244 represents the initiation of the interrupt driven IR and Battery Sampling Routine. The interrupt driven IR and Battery Sampling Routine is now discussed with reference to FIGS. 17A and 17B. The Interrupt Driven IR and Battery Sampling Routine begins at input symbol 328 in FIG. 17A and is designated general throughout as reference numeral 326.

The IR and Battery Sampling Routine is interrupt driven and is generally responsible for sampling the battery voltage and obtaining a reflected sample of an IR pulse from the emitter 118 (FIG. 12). The processing step 330 represents the sampling and saving of a battery voltage reading. The decision step in 332 determines whether the battery voltage is extremely low. If the battery voltage is low, then the IR and Battery Sampling Routine 326 returns to the overall firmware program 202 represented by the output symbol 364 in FIG. 17B. If the battery voltage is not low, then the IR receiver is powered on, which is represented by processing symbol 334. In decision symbol 336, the optical sensor flag is examined to determine if the detector 116 (FIG. 12) is connected. If the optical sensor flag indicates that the detector 116 (FIG. 12) is unplugged, only the loaded battery voltage is sampled. In processing step 338 the MOSFET is turned on, the loaded battery voltage is sampled and saved, as represented by processing step 340. The Analog to Digital Converter (ADC) is then turned off, as represented by processing step 342. Routine 326 then exits in terminator symbol detector 364 (FIG. 17B)

If the detector is not unplugged, as indicated in decision step 336, then the Routine 326 waits for the 3 volt power supply to stabilize, as indicated by processing step 344.

In processing symbol 346 the range on the optical sensor is set to low or high, and the IR transmit regulator is enabled to initiate a pulse. With reference to FIG. 17B, once the infrared transmit pulse is enabled, the Routine 326 waits for the pulse time then tests the detector 116 to determine a reflection in processing symbols 348 and 350, respectively. The IR transmit is then disabled in processing step 352. Processing step 354 indicates that an additional delay of approximately 7 microseconds is allowed so that an entire reflection sample can be detected. The reflected IR is sampled and saved just before the pulse peak in processing step 356. Once the reflected pulse is completed, the IR ambient level is sampled and saved in processing step 360. The IR receiver and the ADC are then turned off. The IR and Battery Sampling Routine 326 then returns to the thread handler in FIG. 16.

Processing step 246 represents enabling the switch input thread that is executed every 2 seconds. This thread queries the necessary input mode and makes changes accordingly.

Processing step 248 represents a “kernel” loop that cycles through and calls each of the other active threads. Each thread has separate phases, which are typically run once each thread call, and control movement to the next phase. Thread diagrams show one phase of the same thread run directly after the last. Any other active threads and their current phases would run before the same thread is accessed again.

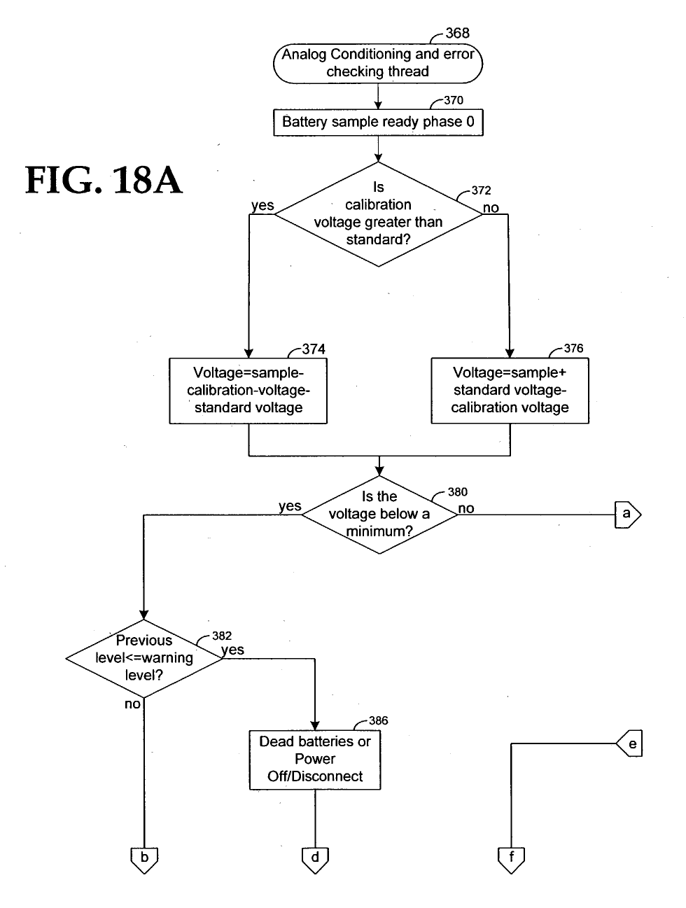

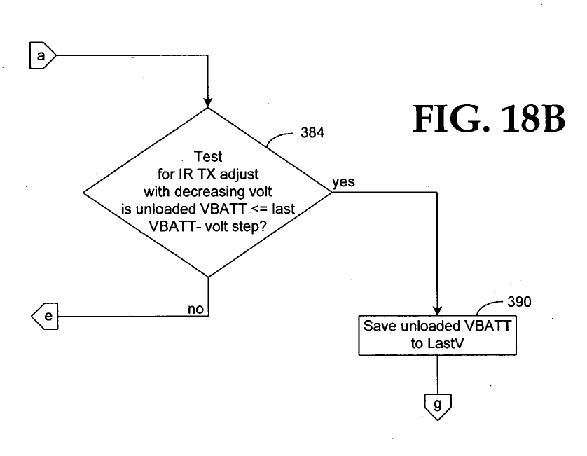

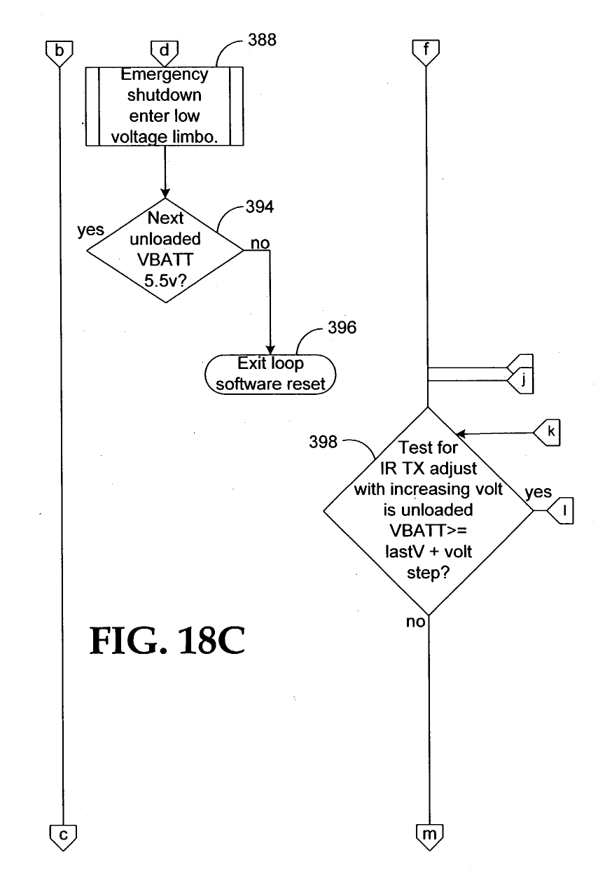

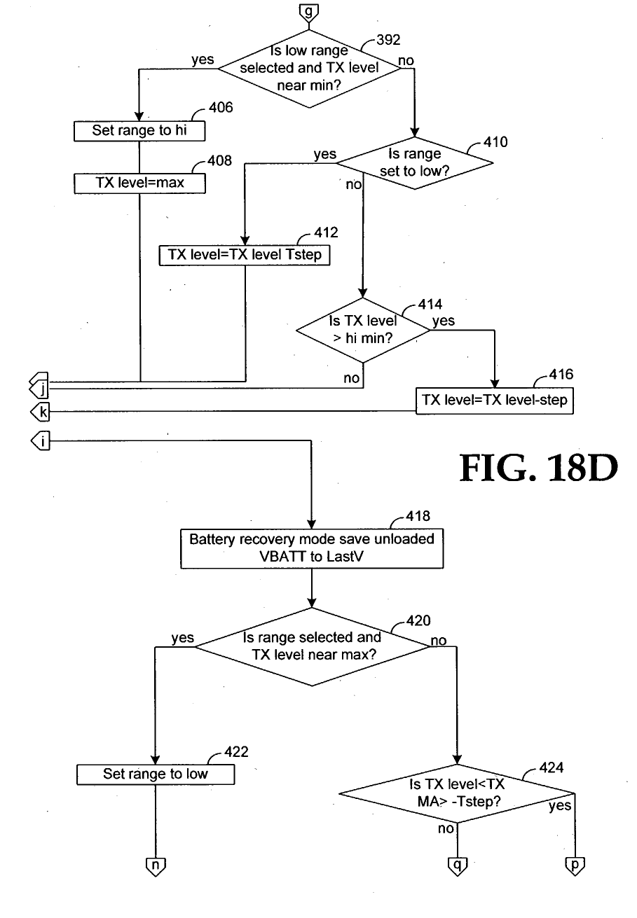

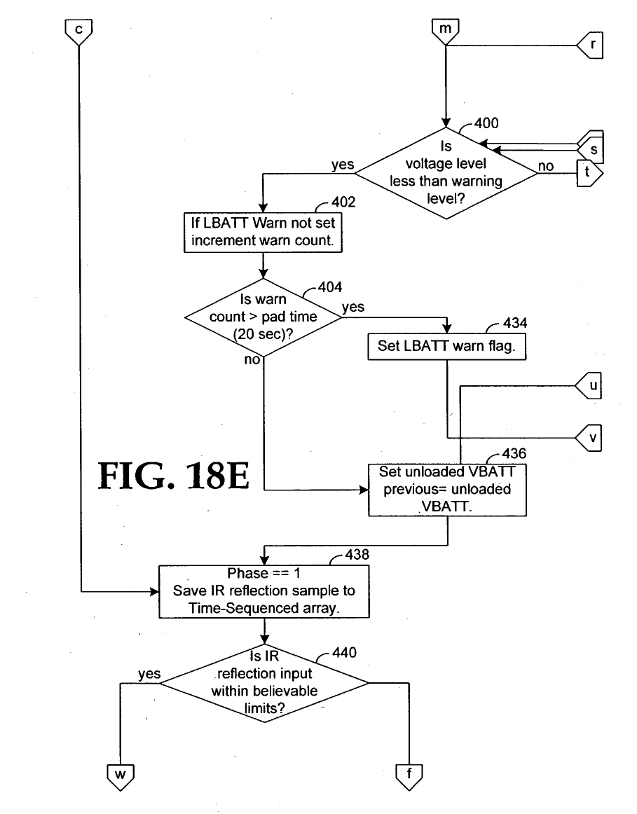

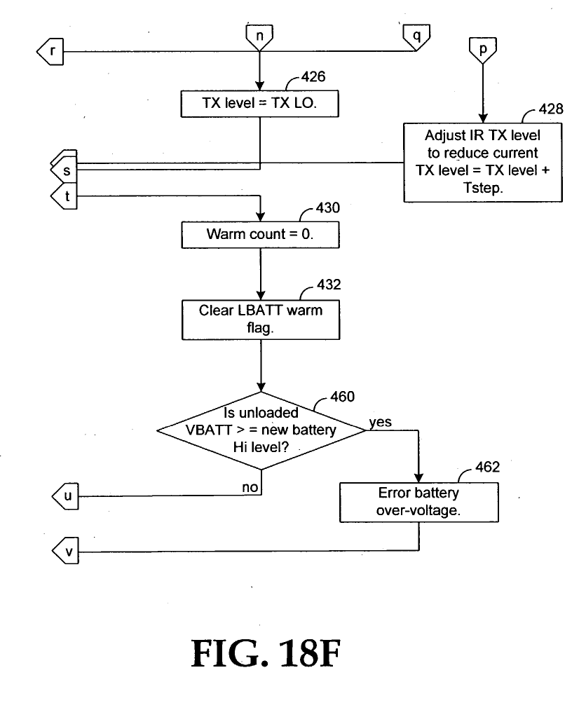

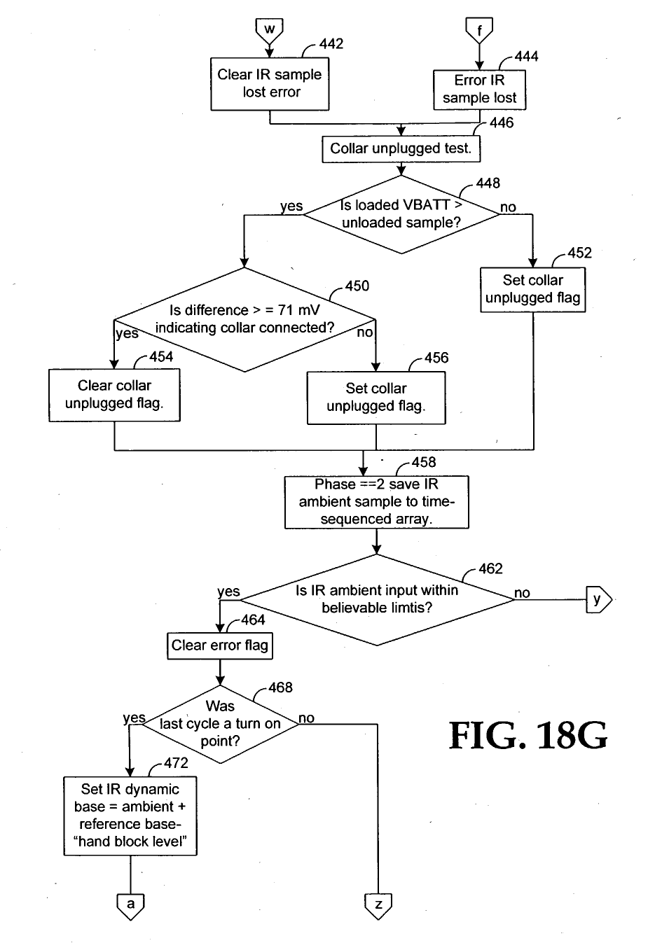

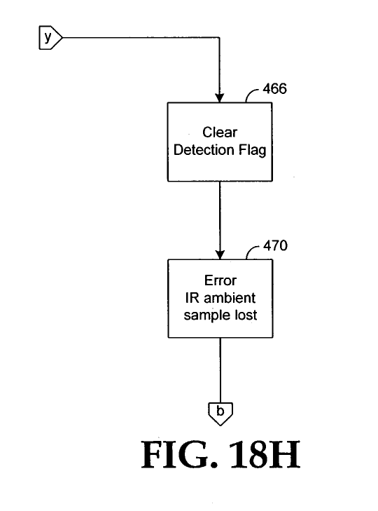

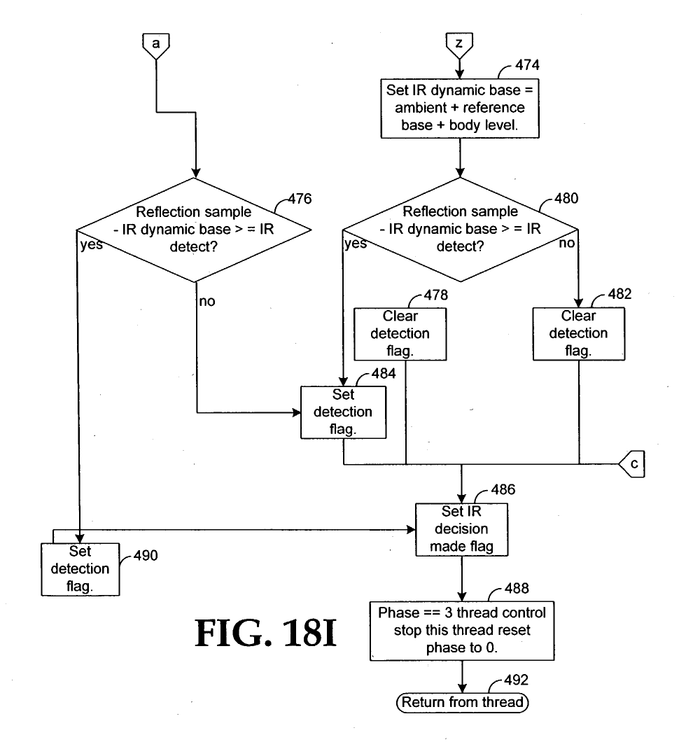

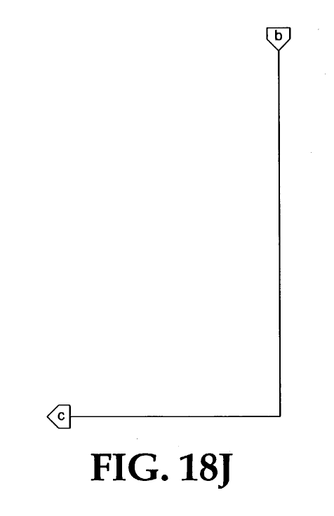

The next processing symbol 250 represents a thread that is responsible for performing analog conditioning and error checking on values obtained from the battery and the infrared receiver. FIG. 18 is a flow chart of the Analog Conditioning and Error Checking Thread represented by the processing step 250. The program starts at input symbol 368 in FIG. 18A.

The thread represented by FIG. 18 has four phases including phase 0, phase 1, phase 2, and phase 3. Phase 0 performs an analysis on the battery voltage level of the system and makes adjustments in the system to compensate for voltage changes. Phase 0 begins in processing step 370 in FIG. 18A with a battery sample from the IR and Battery Sampling Routine 326 illustrated in FIG. 17. The voltage of the battery is initially sampled at calibration time. The calibration voltage is stored and is used in determining the operating voltage of the system. The calibration voltage is compared to a standard value that is a constant value stored in the system. Standard voltage is a constant expected value of the voltage of the system under normal conditions. The calibration voltage and the standard voltage are compared as indicated by the decision symbol 372. The current real-time battery voltage is then calculated. If calibration voltage is greater than the standard voltage, then the battery voltage is determined as represented by processing symbol 374, subtracting from the sample obtained from the IR and Battery Sampling Routine 326 the difference between the calibration voltage and the standard voltage. If the standard voltage is greater than the calibration voltage, then the current real-time battery voltage is determined as represented by processing symbol 376, adding to the sample voltage the difference between the standard voltage and the calibration voltage. Next, the battery voltage is analyzed as indicated by the decision symbol 380 to determine if the voltage is below an operational level. If the voltage is below operational level and the previous voltage level obtained from a prior sample is less than or equal to a warning level, then the system is entered into emergency shut down mode as indicated by the predefined processing symbol 388.

With reference to FIG. 18C, as indicated by the decision symbol 394, the current real-time voltage is compared to 5.5 volts. If it is greater than 5.5 volts, then the thread exits and the software is reset, as indicated in symbol 396. If the previous voltage level is greater than the voltage warning level, then the thread enters Phase 1 in FIG. 18E.

If, however, as indicated in the decision symbol 380, the voltage is not below an operational level, processing symbol 384 (FIG. 18B) and processing symbol 398 (FIG. 18C) indicate that the IR and Battery Detection Thread adjusts the IR emitter power corresponding to changes in the operating voltage of the system. With reference to FIG. 18B, if the voltage has decreased since the last battery voltage sample, then the current real time battery voltage is saved to a variable, LastV, representing the previous sample voltage value, as indicated by processing symbol 390.

With reference to FIG. 18D the emission power level of the IR emitter is then adjusted to compensate for the decrease in the overall system power changes. The decision symbol 392 indicates that the range of the optical emitter is examined. If the range of the optical emitter is selected low and the transmit level is at a minimum, then the range of the emitter is set to high and then transmit level is set to a maximum as indicated by processing symbols 406 and 408, respectively.

When the loaded voltage of the system decreases, more power is provided to the emitter to compensate for the decrease. This allows the emitter to have a more constant range. If the range is not selected as low, as a result of the query indicated by decision symbol 392, then the decision symbol 410 indicates that the range is analyzed to determine if it is low. If the range is low, but the transmit level is not at a minimum, then the transmit level is altered in processing symbol 412 subtracting from the transmit level a variable integer, Tstep.

This allows decreasing adjustment of the transmit level where the range of the device is already toggled low, yet the power of the system has decreased. Decreasing the transmit level decreases the required power of the emitter. If the query in decision step 410 indicates that the range is not set low, then decision symbol 414 determines if the transmit level is at a minimum high. If it is, then the transmit level is altered in processing symbol 416 by subtracting from the transmit level a variable integer, Tstep.

If the overall system voltage has increased since the last battery voltage sample, then decision symbol 398 (FIG. 18C)indicates an adjustment for an increase in overall system operating voltage. With reference to FIG. 18D, processing symbol 418 examines the current real time operating voltage to determine if the voltage is greater than the last voltage reading. If the current voltage is greater than the last voltage reading, then decision symbol 420 queries the range and the transmit level of the IR emitter. If the range is selected as high and the transmit level is at a maximum, then the range is set to low in processing symbol 422 and the transmit level is set to low. If the transmit level is not at a maximum, then the transmit level is examined to see if it is less than the maximum transmit level subtracting an integer variable, TStep. If the transmit level is capable of being adjusted from the query in decision step 424, then the processing step 428 (FIG. 18F) indicates that the IR transmit level is adjusted, providing the sensor more current. This is accomplished by increasing the transmit level by a variable integer, Tstep.

Once the IR emitter transmit level is adjusted for either an increase or a decrease in overall system power, the IR and Battery Detection Thread 366, as indicated in FIG. 18E, examines the overall system voltage reading in decision symbol 400.

If the voltage level is below the warning level, then a flag is set in processing symbol 402 that indicates that the voltage level is below the warning level. With reference to FIG. 18F, if the voltage level is greater than the warning level, then the warning count is set to zero in processing symbol 430, and the voltage low warning flag is cleared in processing symbol 432. The unloaded battery voltage is compared to the battery high level in decision symbol 460. If the voltage is high an error is indicated in processing symbol 462. Then the previous voltage variable is set to the current voltage value in processing symbol 438.

With reference to FIG. 18E, at processing symbol 404, if the warning count indicates a 20-second low voltage, then the low battery warning flag is set. In processing symbol 432, the current real time voltage reading of the overall system is saved to the variable indicating the previous voltage reading to be used by the next iteration of the IR and Battery Detection Thread 366. Phase one begins at processing symbol 438.

The starting point for phase one is indicated by processing symbol 438 in FIG. 18E. Phase one (1) of the Analog Conditioning and Error Checking Thread 366 is responsible for determining if the IR sample received from the IR and Battery Sampling Routine is within believable limits. In addition, phase one examines the IR electronics to determine if the electronics are in working order.

The IR reflection sample received in the IR and Battery Sampling Routine 326 is saved to a time-sequenced array in processing step 438. The decision symbol 440 indicates that the array is examined, comparing it to believable values. With reference to FIG. 18G, if the values are valid, then an error is not indicated and the IR Sample Lost Error flag is reset in processing symbol 442. If the values do not appear to be valid, then the Error flag is set in processing symbol 444.

In processing symbol 446, a test is performed on the overall system voltage to determine if the collar that contains the electronics 114 (FIG. 12) is working properly. The decision step 448 indicates that the voltage is examined comparing the normal operating voltage of the overall system to the voltage value at a time when the IR electronics are operating (this value is indicated as loaded voltage). If the loaded voltage is greater than the normal operating voltage, then the difference between the two voltages is examined as indicated by decision symbol 450. If the difference between the two voltages is greater than or equal to 71 mV, then the comparison indicates that the IR electronics (the collar) are in working order, and the flag indicating an error is cleared in processing symbol 454. If the difference is less than 71 mV, then the flag is set in processing symbol 456 to indicate an error.

If the symbol 448 indicates that the loaded voltage is less than the normal operating voltage, this indicates that the IR electronics are not working properly. Consequently, the error flag is set in processing step 452.

Phase two begins at processing symbol 458. Phase two of the Analog Conditioning and Error Checking Thread 366 examines the IR ambient sample received in the IR and Battery Sampling Routine 326 (FIG. 17) indicated by processing symbol 360 (FIG. 17B). The ambient sample is an IR sample by the detector 116 (FIG. 12) when the emitter 118 (FIG. 12) is not active; therefore, the ambient sample is an IR reading that indicates the normal environmental IR present.

With reference to FIG. 18G, as indicated by decision symbol 462, the ambient sample is saved to a time-sequenced array, and the query determines whether the IR ambient sample is within believable limits.

If the value is not within believable limits, the detection flag is cleared in processing symbol 466 and an error is set that indicates that the IR ambient sample is not valid. The flag indicating that the decision has been made is set in processing symbol 486. If the IR ambient sample is within believable limits, then an error flag is reset to indicate no error in processing symbol 464. Next, the decision symbol 468 indicates a query to determine if the last pulse cycle resulted in activation of the fluid dispensing device. If the last cycle resulted in the activation of the fluid dispensing device, then the IR dynamic base is set to the sum of the ambient value and the reference base decreased by the “hand block level” as indicated in processing symbol 472. The “hand block level” a constant value subtracted in order to account for errors in invalid detection readings.

With reference to FIG. 18I, if the difference between the reflection sample and the IR dynamic base is greater than the detection value, the detection flag is then set in processing symbol 490. Because the IR dynamic base does not include the previously reflected IR from the user's hands, the difference between the IR dynamic base and the reflection sample will indicate detection. If the decision symbol 476 query does not indicate that an object is present, then the detection flag is cleared as indicated by processing symbol 478. Lastly, the IR decision made flag is set in processing symbol 486.

If the last cycle did not result in the activation of the fluid dispensing device in decision symbol 468 (FIG. 18G), then the IR dynamic base is set equal to the sum of the ambient value and the reference base increased by the “Body Level” as indicated in processing symbol 474. The “Body Level” is a constant based on the current range setting of the detector, requiring more energy to turn on the faucet. As indicated by the decision symbol 480, if the difference between the reflected sample obtained in the IR and Battery Sampling Routine 326 and the dynamic base is greater than or equal to a detection value, then the detection flag is set in processing symbol 484. Thereafter, the IR decision mode flag is set in processing symbol 386. If, on the other hand, the difference is not greater than or equal to the detection value, then the detection flag is cleared in processing symbol 482, and the IR decision made flag is set as indicated by processing symbol 486.

Phase three of the Analog Conditioning and Error Checking 366 releases thread control and resets the phase of the thread to zero. This is indicated in processing step 488. The thread then returns as indicated by termination symbol 492.

The overall firmware operation 202 in FIG. 16 continues at processing symbol 252 in FIG. 16B. In processing symbol 252, the DIP switches of the system are read to ensure proper operation modes.

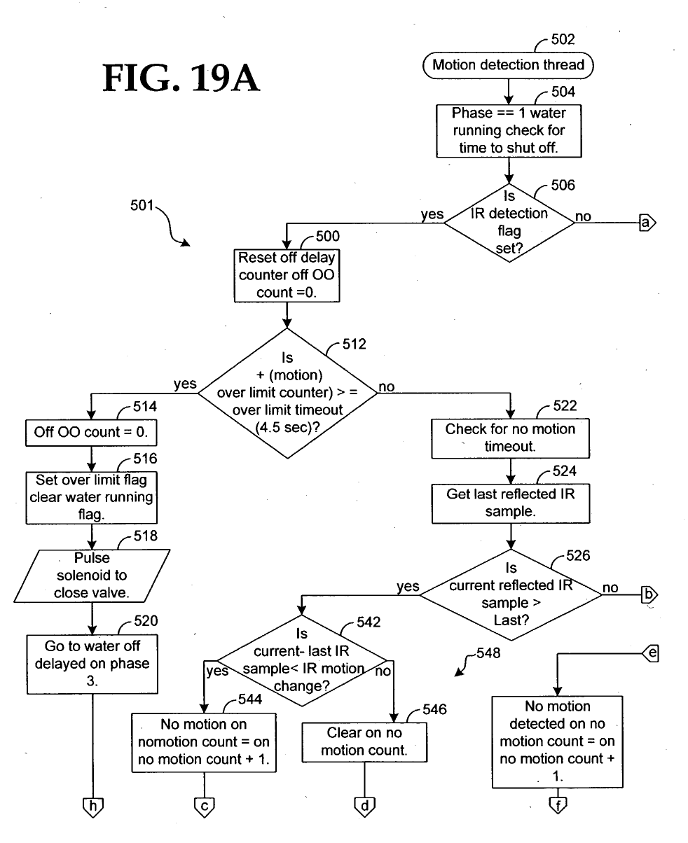

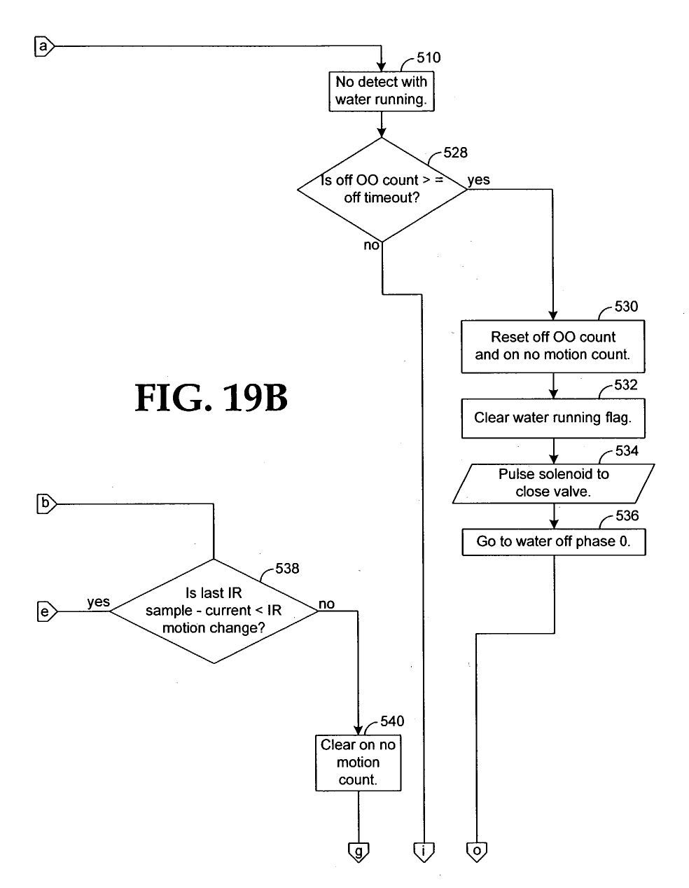

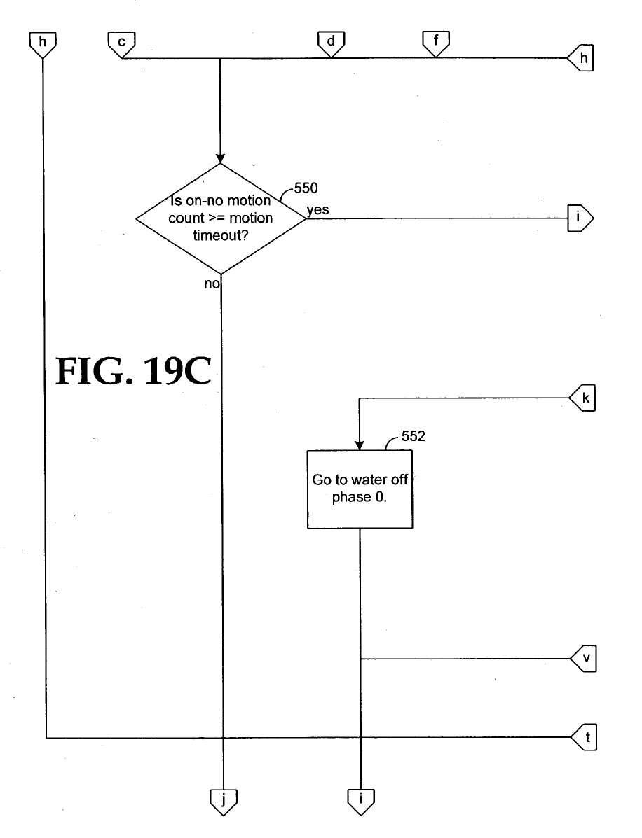

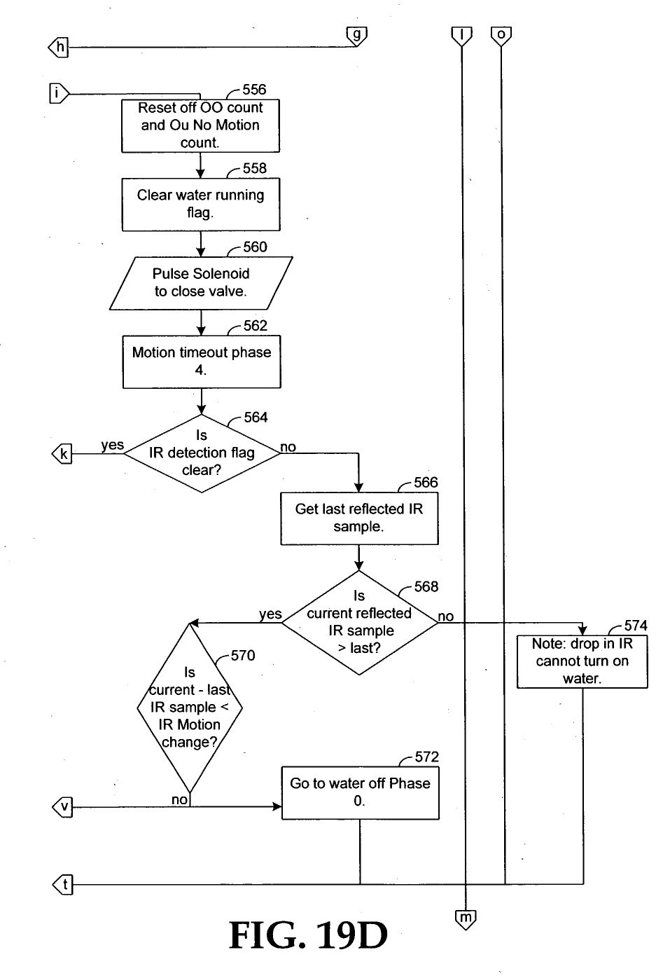

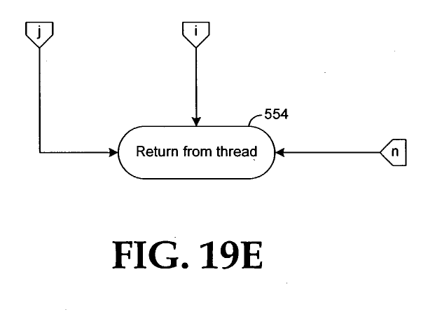

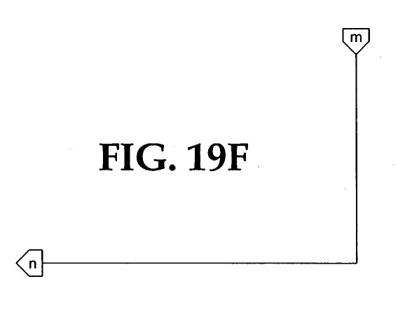

Processing symbol 254 indicates a call to the Motion Detection Thread 501, the flowchart for which is illustrated in FIGS. 19A-19F. The Motion Detection Thread 501 is that functional part of the software that determines if the fluid dispensing device should remain activated in light of motion detected by the emitter/detector pair.

With reference to FIG. 19A, the Motion Detection Thread 501 begins at processing symbol 504 at phase one. As indicated by processing symbol 504, Phase 1 of the Motion Detection Thread 501 is executed when the device is currently dispensing fluid. The decision symbol 506 queries the IR Detection Flag to determine if an object was detected by the IR and Battery Sampling Routine 326. If the Detection Flag is set, the counter for water flow timeout is set to zero (0) as indicated in processing symbol 500.

The decision symbol 512 determines whether the water has been running for more than forty-five (45) seconds, which is a timeout limit. If the water has been running more than 45 seconds, then an over limit flag is set indicating that the water running limit is reached, and the flag indicating that the water is running is reset or cleared as indicated by processing symbol 516. The solenoid is pulsed to close the valve in processing symbol 518.

If the water has not been running for more than forty-five seconds in processing symbol 512, then the 45 second timeout is checked in 522, and the last reflected IR sample is retrieved in 524. The last reflected sample obtained in the IR and Battery Sampling Routine 326 is then compared to the current IR sample in decision symbol 526. If the current sample exceeds the previous sample, then the last IR sample is subtracted from the current IR sample. If the difference is less than a predetermined value that indicates a motion threshold in decision symbol 542, then a flag indicating that no motion was detected is incremented as indicated in processing symbol 544. If the difference is not less that the predetermined value, then a flag indicating that motion was not detected is reset or cleared as indicated in processing symbol 546.

With reference to FIG. 19B, if in decision symbol 526 the query indicates that the current sample does not exceed the previous sample, then the current IR sample is subtracted from the last IR sample as indicated by the decision symbol 538. If the difference is less than a predetermined value that indicates a motion detection threshold, then a flag is incremented as indicated in processing symbol 548 (FIG. 19A) that indicates that no motion was detected. If the difference is not less that the predetermined value, then the flag indicating no motion detected is cleared as indicated in processing symbol 540 (FIG. 19B).

With reference to FIG. 19C, decision symbol 550 indicates that, if the flag indicating that no motion is detected exceed the motion timeout value, then the Motion Detection Thread 500 returns as indicated by the terminating symbol 554 in FIG. 19C. In other words, no motion is detected, and it has exceeded timeout, then the Motion Detection Thread 500 terminates until the water is activated again. With respect to FIG. 19D, if the timeout duration has not been surpassed, then the Motion Detection Thread 500 proceeds by resetting the flag indicating no motion and the counter in processing symbol 556. The Water Running indicator is cleared in processing symbol 558, and a separate process as indicated by the process call 560 is initiated that pulses the solenoid to close the valve.

Phase four begins at processing symbol 562. If the IR Detection Flag is clear (no detection of a user's hands) by the query indicated in decision symbol 564, then the thread returns to the water off phase zero (0) as indicated in processing symbol 552 (FIG. 19C).

With reference to FIG. 19D, if a user's hands were detected in the decision symbol 564, then the previous reflected IR sample is retrieved in processing symbol 566. The current reflected IR sample is compared to the previous reflected IR sample in decision symbol 568. If the current sample is greater than the previous sample in decision symbol 568, then the difference in the current IR sample and the previous IR sample is examined to determine if it exceeds the IR motion change threshold in decision symbol 570. If it does not meet or exceed the threshold, then the thread returns in the terminator symbol 554 (FIG. 19E). In other words, a drop in IR will not turn on the water. If it does indicate a motion change in decision symbol 570, then water off phase zero (0) is initiated in processing symbol 572.

If at the decision symbol 506 in FIG. 19A, it is determined that the IR Detection Flag is not set, then there has been no motion detected and the fluid is currently being dispensed from the device. With respect to FIG. 19B, if the duration of the fluid dispensing has exceeded a timeout threshold from the query in decision symbol 528, then the No Motion Detection flag is incremented in processing symbol 530 and the Water Running flag is cleared in processing step 532. The solenoid is then pulsed to close the valve in the predefined process as indicated in 534, and the Water Off phase is set to zero (0) in process symbol 536.

Thread control is then returned to the overall firmware structure 202 as illustrated in FIG. 16. In FIG. 16C, decision symbol 258 indicates that the firmware determines if there are any pending events. If there are pending events then the main thread timer is queried to determine if a cycle has expired. If the cycle time has expired, the cycle begins again at processing step 240 (FIG. 16B) where the microcontroller is deactivated until the next cycle is initiated on the 250 millisecond interval.

If the cycle time has not expired, then the optical sensor looks for the Attention signal initiated by the handheld computer in processing symbol 262. The Attention signal is emitted by the handheld computer as indicated in the Send Status function 178 in processing step 182 (FIG. 15). If the handheld computer has requested connected mode of the fluid dispensing device and the Attention signal is a valid signal, then the decision symbol 264 indicates that a transmit status response is sent to the handheld computer in the subsequent predefined process step 266. Once the Status Response is transmitted, then the handheld computer and the fluid dispensing device enter connected mode as indicated in predefined processing symbol 268. The firmware remains in connected mode until a command is transmitted or a timeout occurs in processing symbol 268. If an End command is communicated by the handheld computer or a timeout occurs, the variables for the thread events are reset and the DIP switches are queried as indicated in processing symbol 270.

The TBM interrupts are re-enabled in processing symbol 272 allowing the pulse cycle to continue, then the operation of the IR electronics are examined as indicated in the decision symbol 274. If the IR electronics have been unplugged then the system is configured to do reflection calibration in one (1) second in processing step 276. In decision symbol 278, the IR electronics are then tested to determine if the devices are unplugged, if there is a battery warning, or if there exist any other errors. If each of the queries returns a negative response, then this error data is saved in processing symbol 282.

The error indications are saved into a report for user accessibility in processing symbol 284. The decision symbol 288 queries the error bits to determine if the errors changed from the last iteration of the firmware structure 202. If the error has changed, then the previous error is saved in processing symbol 290. With reference to FIG. 16D, the TBM interrupts are re-enabled in processing symbol 292, and error messages are transmitted to the handheld computer in predefined process symbol 294.

The decision symbol 296 indicates a query of the IR electronics. If the electronics are working properly, then the pulse cycle is reinitiated in FIG. 16B at processing symbol 240.

If the electronics are not working properly, then the system is placed into low power IR electronics unplugged Mode in predefined processing symbol 300. The system remains in low power mode as indicated by the decision symbol 302 until the electronics are reactivated. Once the IR electronics begin working properly, processing step 308 indicates that the preparation is taken for the recycling of the IR and Battery Sampling. Thread control is reset in processing symbol 310. If the calibration flag is set, then the TBM Interrupt Service Routine is initiated in processing symbol 314. If Factory calibration is required as determined in decision step 316, then the predefined Factory Calibration Thread is run as indicated by the predefined Factory Calibration symbol 318. The system then holds until reset in process symbol 320 at which time the Firmware structure begins anew at decision symbol 208 in FIG. 16A.

If Factory Calibration is not indicated in the decision symbol 316, then the predefined Dynamic Calibration is run as indicated in the predefined processing symbol 322. To reinitiate the threads, the TBM interrupts are reset in processing symbol 324, and a pulse cycle begins at processing symbol 240 where the microcontroller is deactivated until a cycle is initiated by the TBM.

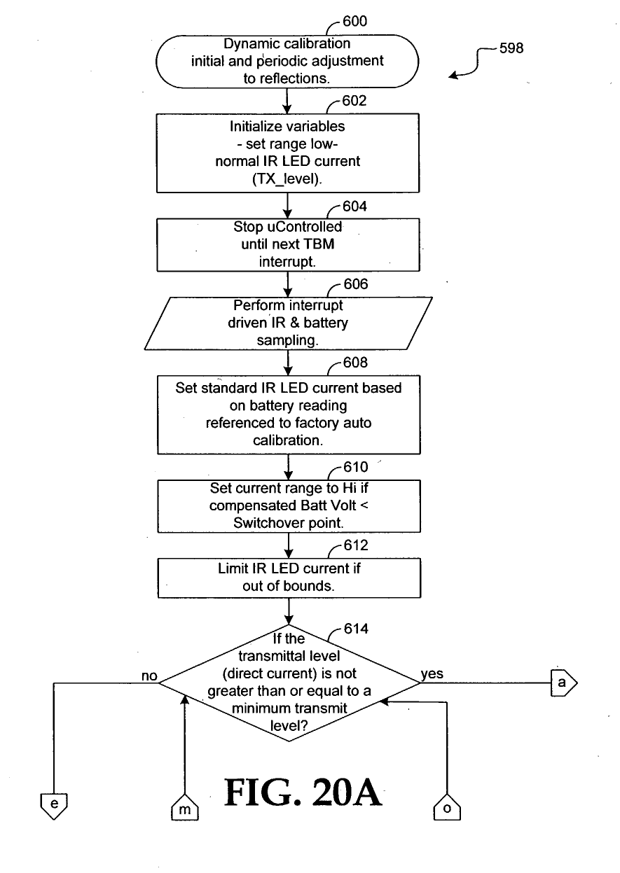

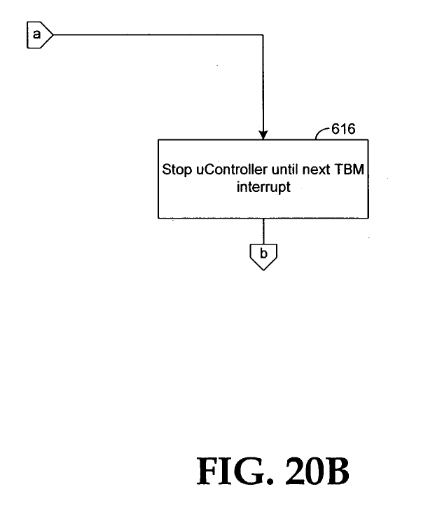

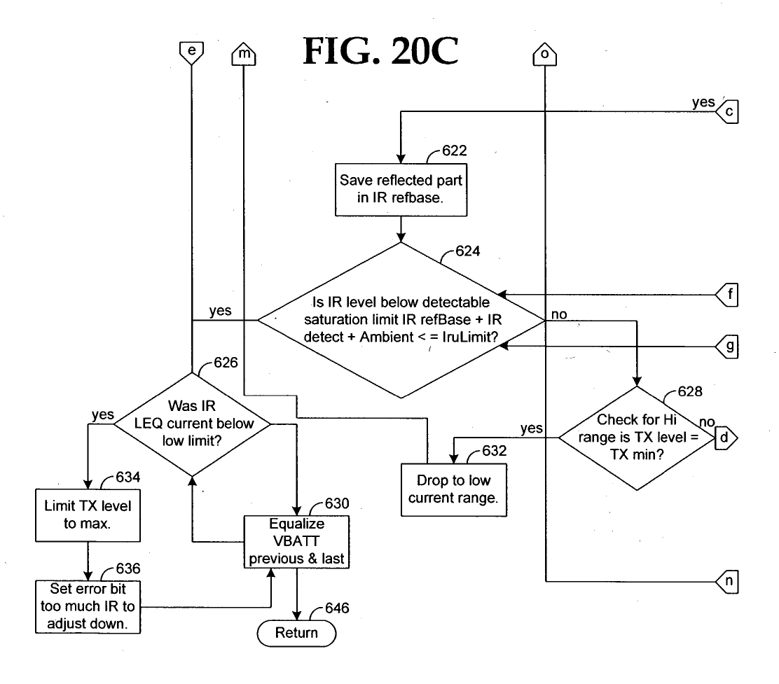

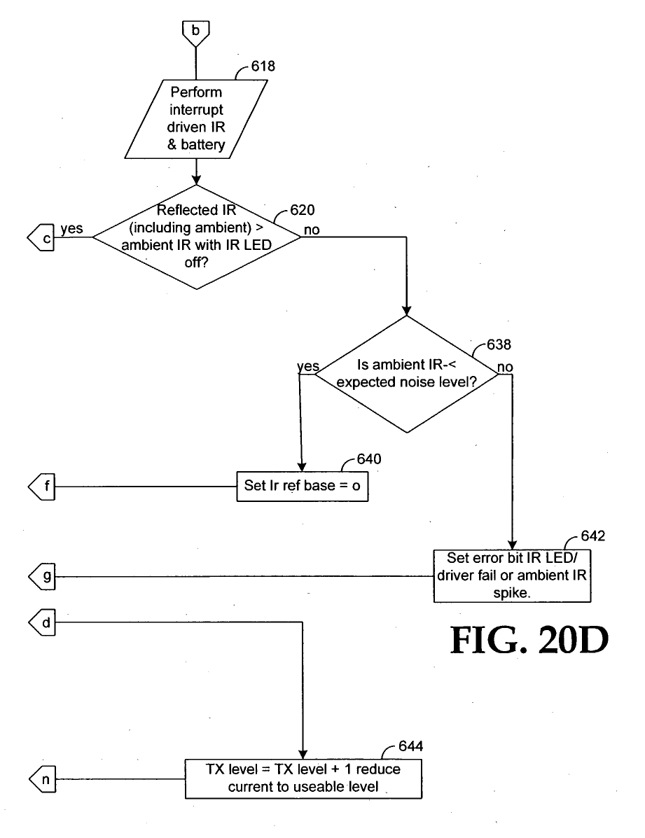

If Factory Calibration is not indicated, then the Dynamic Calibration Thread 598 as illustrated in FIG. 20 is run from the firmware overview structure 202 at processing symbol 322. The Dynamic Calibration Thread 598 is executed both initially when the firmware is first powered up and periodically to adjust the IR hardware components as required by environment and system changes.

The Dynamic Calibration Thread 598 starts at the input symbol 600 in FIG. 20A. The calibration begins by initializing required variables, setting the initial emitter selection to low, and setting the IR LED current to a nominal value ( the transmit level) as indicated in processing symbol 602. The microcontroller is deactivated for the duration of a regular 250 milliseconds TBM cycle in processing step 604. The Interrupt Driven IR and Battery Sampling Routine 326 (FIG. 17) is called in order to obtain initial samples of the battery voltage as indicated in processing step 330 (FIG. 17A), the reflected IR as indicated in processing step 356 (FIG. 17B), and the ambient IR as indicated in processing step 360 (FIG. 17B).

Processing symbol 608 indicates that the Dynamic Calibration Thread 598 sets the current input to the IR LED based on the battery voltage sample obtained from the IR and Battery Sampling Routine 326 (FIG. 17). The current range is set to high if the compensated battery voltage is less than the switchover point in processing symbol 610, and processing symbol 612 adjusts the IR LED current if it exceeds an operational limit that affects performance.

Decision symbol 614 begins the actual calibration of the IR LED and the optical sensor. If the transmit level (or initially the nominal IR LED current) is less than a minimum transmit value in order for the IR emitter to reach an effective range, then the microcontroller is deactivated until the next TBM cycle in processing symbol 616 in FIG. 20B, and the Interrupt Driven IR and Battery Sampling Routine 326 (FIG. 17) is run in processing symbol 618 in FIG. 20D.

With reference to FIG. 20D, in the decision symbol 620, the reflected IR including the ambient sample is compared to the ambient level when the IR LED has not emitted a pulse. This is in contrast to the initial setting that simply used reference values according to the standard LED based on the battery voltage reading.

With reference to FIG. 20C, if the sum of the reflected IR and the ambient level is greater than the ambient level when the IR LED has not emitted a pulse, then the reflected IR is the Reference Base Value as indicated in processing symbol 622. If the IR level, which is defined as the sum of the Reference Base, the Reflected IR, and the Ambient IR, is below a detectable saturation limit in decision symbol 624, then the current input to the IR LED is examined in decision symbol 626.

If the current input to the IR LED is below the low limit, then the transmit level is set to a maximum value in processing step 634, and an error bit is set that indicates that the emitter cannot be adjusted down any farther in processing symbol 636. The battery voltage is then equalized in processing symbol 630 in order to prevent battery error, and the Dynamic Calibration Thread returns as indicated by the terminator symbol 646, with errors. If the current input to the IR LED is not below the low limit, then the battery voltage is then equalized in processing symbol 630 in order to prevent battery error, and the thread returns as indicated by the terminator symbol 646, without errors.

If the sum of the reflected IR and the ambient level is not greater than the ambient level when the IR LED has not emitted a pulse in decision symbol 620 (FIG. 20D), then the difference between the Ambient IR and the Reflected IR (including the Ambient IR) is examined in decision symbol 638 in FIG. 20D. If the difference is less than the expected noise level, then the Reference Base is set to zero (0). If the difference is not less than the expected noise level, then an error bit is set in processing symbol 642, and the IR level is examined in decision symbol 624. If it is below a detectable limit, then the process provides an error before exiting if the IR LED current was below a low limit. If it was not below a low limit, it simply exits.

### Communication Protocol

Data communication between the optical interface ports of the handheld computer 104 (FIG. 12) and the fluid dispensing device 106 (FIG. 12) is now described. Communication between the devices is implemented as Broadcast Mode or Connected Mode.

### Broadcast Mode

The Broadcast mode is employed when the receiving control logic of a preferred embodiment discovers errors including, but not limited to, a malfunctioning solenoid, a low battery, or a reflected signal that is out of range at calibration. When such an error is detected during the normal operations of the firmware of the fluid dispensing device, a signal is emitted from an IR emitter 118 (FIG. 12) of the fluid dispensing device.

The signal emitted has the following format:

ERRSSSSSSSE(CS)(LF).

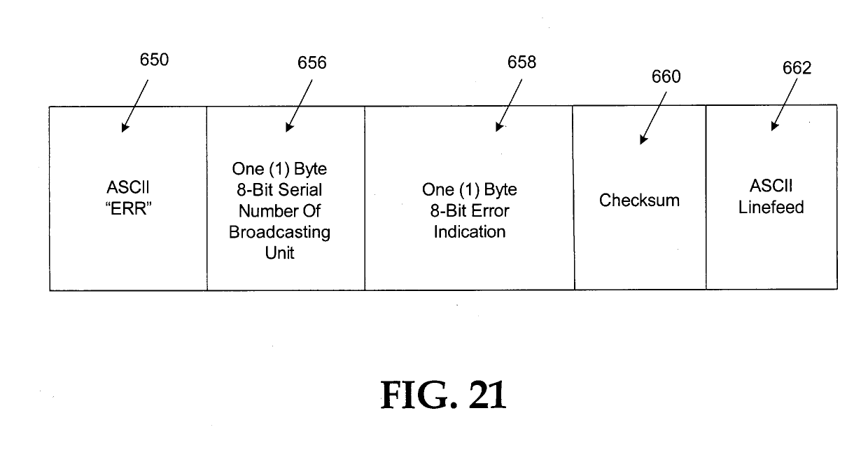

The emission is sent once per second. The specification of the signal is illustrated in FIG. 21. The first three bytes indicate that the signal is a Broadcast signal including an ASCII “ERR” 650. The next byte 656 includes an 8-bit serial number identifying the unit that has detected an error. Byte 658 indicates the type of error that has been detected. The following table describes the types of errors and the corresponding byte indicators:

TABLE 1

| BIT | ERROR TYPE |
|---|---|
| Bit 0 | Solenoid Open |
| | Circuit or Unplugged |
| Bit 2 | Solenoid load too |
| | heavy |
| Bit 3 | Ambient IR level out |
| | of Range |
| Bit 4 | Reflected IR out of |
| | range at Calibration |
| Bit 5 | Low Battery Warning |
| Bit 6 | Collar Unplugged |

The checksum byte 660 is a modulo 256 checksum inverted, and the last byte is an ASCII linefeed 662 to indicate termination of the signal.

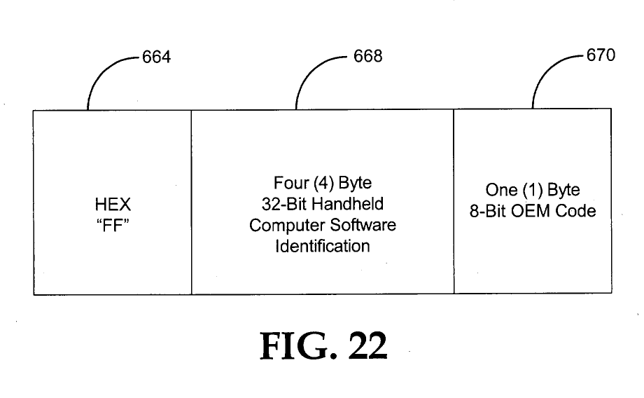

The control logic of the handheld computer processes a discovered error(s) and communicates the error(s) to the handheld computer. The Broadcast Communication Process is shown in FIG. 22 and is designated generally throughout with reference numeral 882.

Decision symbol 884 determines if an error has been detected within the fluid-dispensing device. Within the system, a timer is set, for example to broadcast error messages every five (5) pulse cycles. Therefore, in decision symbol 886 it is determined whether it is time to send out a Broadcast Signal. If it is not, then the fluid dispensing device continues with normal operation in terminating symbol 892.

If it is time to transmit a Broadcast Signal, then the error data is sent in processing symbol 888.

The handheld computer executes a scanning function that can be initiated by a user. FIG. 14 represents the communication function of the handheld computer. The optical interface port is initialized 148, and the IR-State variable is set indicating that the port is open in 150. The gCommand variable of the switch symbol 152 indicates that a user has selected the scan functionality. The scan function searches for a Broadcast signal of the type described.

Once detected, the signal is parsed and the information is stored on the handheld computer. This information is then readily available to the user for maintenance purposes.

### Connected Mode

The Connected Mode is initiated by the handheld computer when a user selects a functionality that requires data to be sent to the fluid dispensing device. As described, infra, an Attention Signal is emitted from the optical interface port of the handheld computer.

The Attention Signal specification is illustrated in FIG. 22. The Attention Signal is defined as a hexadecimal “FF” 664. The “FF” is followed by a four (4) byte computer software identification ASCII code 668. The four-byte code 668 includes 4 ASCII characters identifying the company and product. The last byte 670 indicates an Original Equipment Manufacturing (OEM) code.

The “FF” 664 is sent continuously for 300 milliseconds (approximately 50 milliseconds longer than a normal fluid dispensing device pulse cycle). This allows the fluid dispensing device the opportunity to detect the Attention Signal if the Attention Signal is initially sent during a 250 millisecond cycle.

The fluid dispensing device responds within 39 milliseconds (14 milliseconds if the water is off). If there is no response from the fluid dispensing device, then the Attention Signal is sent repeatedly at a predetermined interval until a response is detected by the handheld device.

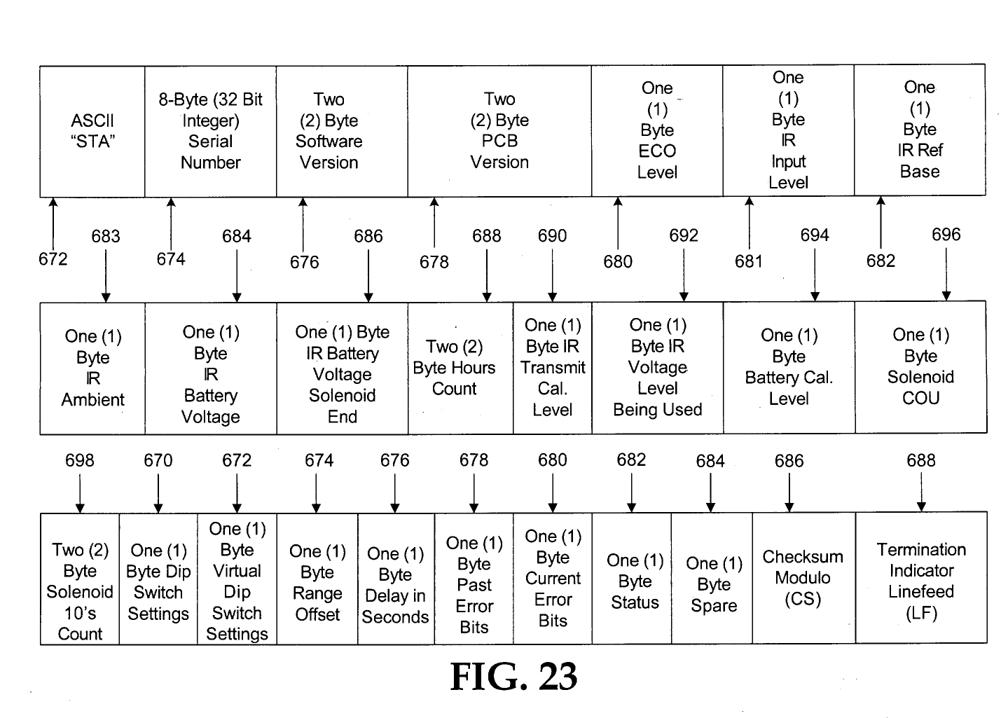

The Attention Signal response sent by the fluid dispensing device includes status information that is described with reference to FIG. 23. The initial ASCII “STA” byte 672 indicates that the fluid dispensing device is responding to the Attention Signal. The 8-byte serial number 674 indicates the serial number of the device responding to the Attention Signal. This 8-byte word is displayed on the handheld computer as a hexadecimal number. The 2-byte software version 676 indicates to the handheld device the version of the firmware used on the fluid dispensing device. The next 2-byte PCB version 678 indicates the board revision number and the part number of the board. The one-byte Engineering Change Order (“ECO”) level indicates previous maintenance order. The one-byte IR input level 681 identifies the IR sensitivity. The one-byte IR reference base reading provides an eight-bit reading. The one-byte IR ambient reading 683 is provided. The one-byte IR battery voltages 684 and 686 provide a normal operating battery voltage and a battery voltage at the end of a solenoid pulse, respectively. The following two bytes provide an hour count 688 for time purposes. The IR transmit calibration level byte 690 provides a voltage output value of the emitter, and the next byte provides a one-byte voltage level 692 of the voltage being used. The next byte is the battery calibration level 694 indicating a voltage reading of the battery at calibration. A one-byte solenoid count 696 and a two-byte solenoid 10's count 698 follow. The dip switch settings are indicated in the next byte 670. The following table describes the bit numbers with corresponding definitions:

TABLE 2

| BIT | DESCRIPTION |
|---|---|
| B7 | DIP Switch 5 (water saver) |
| B6 | DIP Switch 1 (Range 1) |
| B5 | DIP Switch 2 (Range 2) |
| B4 | DIP Switch 3 (Scrub Mode, |
| | 60 second off delay) |
| B3 | DIP Switch 4 (Meter Mode) |
| B2 | Unused extra input jumper |
| B1 | Not used |
| B0 | Not used |

The virtual DIP switch settings are provided in byte 672 and are defined the same as the manual DIP switch settings except B0 is defined as “Use All Virtual Settings.” Range offset 674, delay in seconds 676, past error bits 678, and current error bits 680 provide additional information describing the current fluid dispensing device parameters. Status of the fluid dispensing device is given in the next byte 682 and the bits are defined as follows:

TABLE 3

| | |
|---|---|
| B4 | PROGRAMMING |
| | ERROR, NUMBER OF |
| | BYTES SPECIFIED |
| B2 | PROGRAMMING |
| | ERROR, ADDRESS |
| | SPECIFIED |
| B1 | FLASH PROGRAM |
| | OPERATION NOT |
| | VERIFIED |
| B0 | LAST COMMAND |
| | CHECKSUM FAILED |

A one-byte spare is provided 684, and the transmission is terminated with a checksum 686, and a linefeed 688.

Once connected mode is established, the handheld computer has several functions. The handheld computer can send a status request, send a set command, or send a program command.

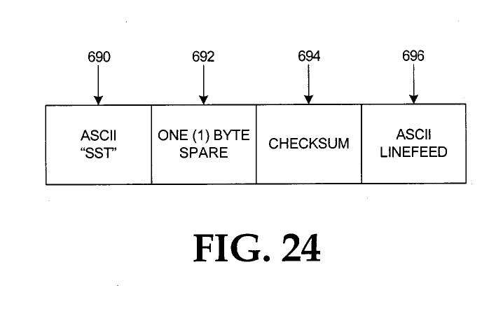

A status request from the handheld computer is responded to by the fluid dispensing device indicating that information that is sent when Connected Mode is accomplished. The status request flowchart in FIG. 4 illustrates the software flow on the handheld computer when a Status command is requested. Processing symbol 184 indicates the transmission of a Status command, and the specification for the Status command is illustrated in FIG. 24. A status command begins with and ASCII “SST” 690. A one-byte spare 692 is followed by a checksum 694 and an ASCII linefeed 696 for termination.

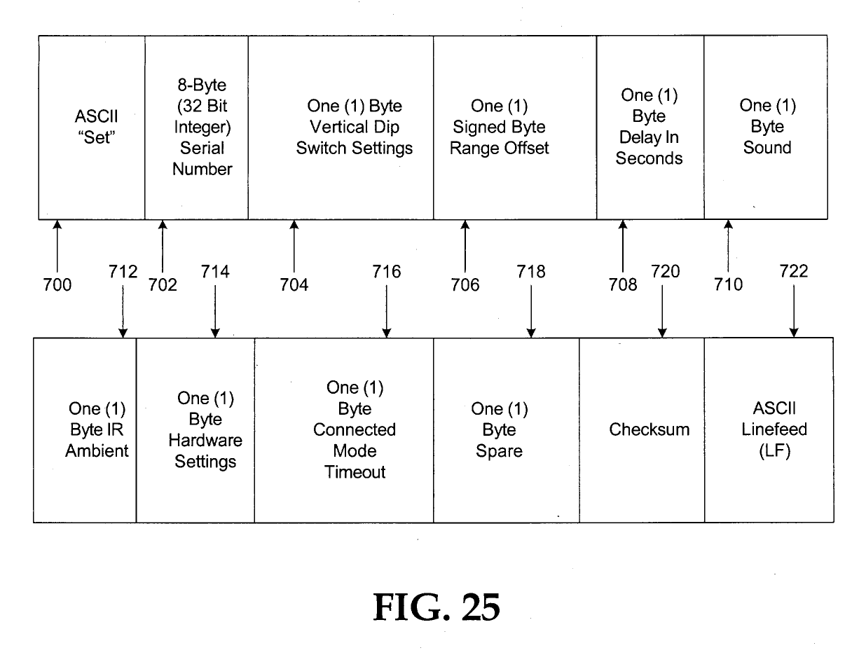

A Set command allows a user of the handheld device to reprogram various electronics of the fluid dispensing device, including but not limited to the DIP switches (i.e. virtual DIP switch settings), range offset, delay in seconds, sound, hardware settings, and connected mode timeout. FIG. 25 illustrates a string transmitted by the handheld computer to accomplish a Set command. The ASCII “SET” string 700 is sent in the least significant byte. Following the “SET” string is an eight-byte serial number 702 indicating the handheld computer that is initiating the “SET” command. The one-byte virtual DIP switch settings 704 are described by the following table:

TABLE 4

| BIT | DESCRIPTION |
|---|---|
| B7 | DIP Switch 5 (water saver) |
| B6 | DIP Switch 1 (Range 1) |
| B5 | DIP Switch 2 (Range 2) |
| B4 | DIP Switch 3 (Scrub Mode, |
| | 60 second off delay) |
| B3 | DIP Switch 4 (Meter Mode) |
| B2 | Unused extra input jumper |
| B1 | Not used |
| B0 | All Virtual Settings |

The emitter range offset is provided in the next byte 704, and a delay is provided in the next byte 708. The sound can be turned on/off with the sound byte 710. B0 indicates sound off. Byte 712 provides the IR ambient level reading. The user can reset hardware settings in the following byte 714 including B0 that resets the main board and B1 that indicates a soft reset. Resetting the main board includes the fluid dispensing device waiting 10 seconds, exiting Connected Mode, then resetting all the variables. A Soft Reset includes waiting 10 seconds, exiting Connected Mode, retaining virtual settings, and re-calibration. The next byte 716 allows the Connected Mode timeout to be changed in the range of 0-255 seconds. Finally, a spare byte 718, a checksum byte 720 and an ASCII linefeed 722 terminates the “SET” command.

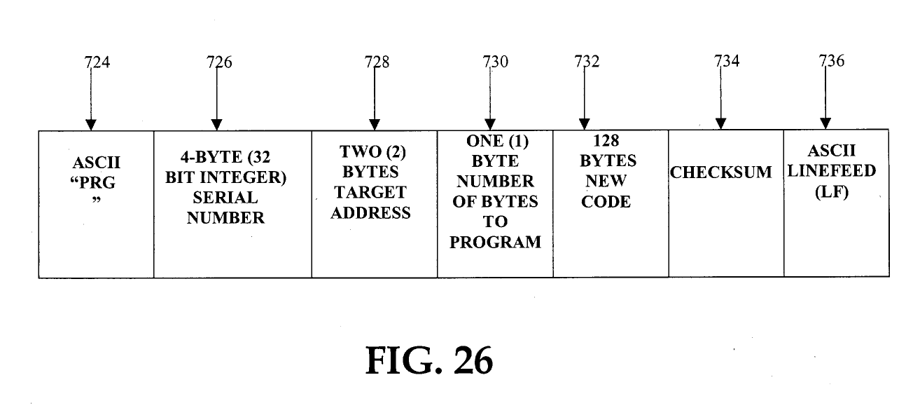

A Program Command allows a handheld computer user to reprogram the fluid dispensing device. The Program Command Specification is illustrated in FIG. 26. ASCII “PRG” 724 initiates a Program Command. A four-byte serial number 726 follows indicating the identification of the handheld computer. The next two bytes 728 provide the target address of the fluid dispensing device. Typically, the target address includes the software type, the PCB code and the address returned from an “STA” Command. The number of bytes making up the new code is transmitted in one byte 730, and the code itself is transmitted in the following 128 bytes 732. If the code exceeds the 128 byte limit, then multiple “PRG” Commands can be sent from the handheld computer in order to transmit the entire piece of code. A checksum 734 and an ASCII linefeed 736 terminate the signal.

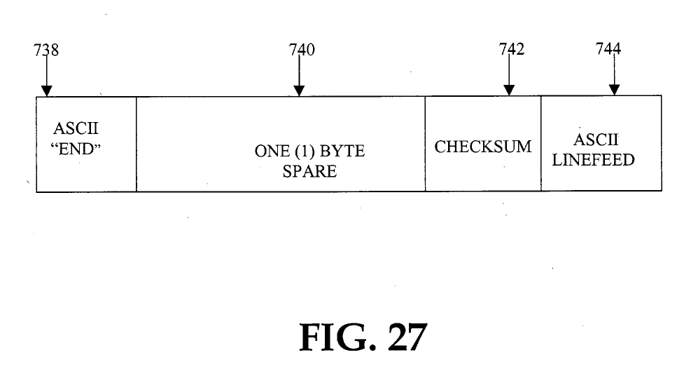

The handheld computer sends an End Command as illustrated in FIG. 27 in order to terminate the Connected Mode between the handheld computer and the fluid dispensing device. An ASCII “END” string 738 initiates the End Command. It is followed by a one-byte spare 740 and a checksum 742. The End Command is terminated by an ASCII linefeed 744.

### Graphical User Interface of Handheld Computer

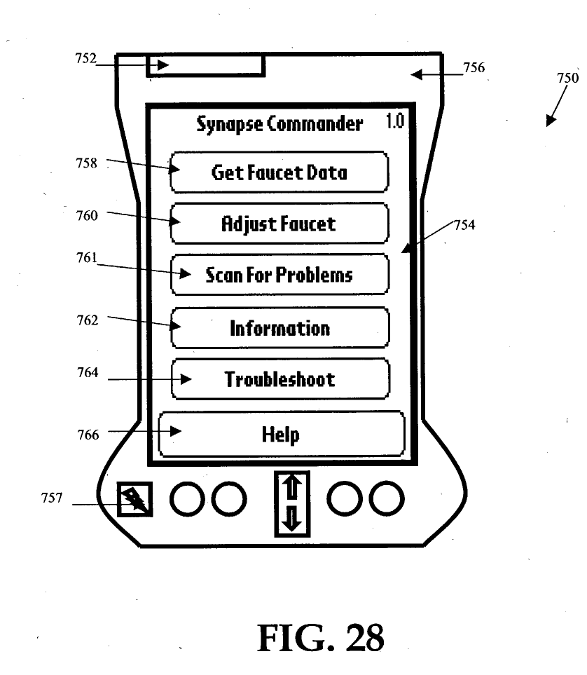

The Graphical User Interface (GUI) of the handheld computer is now described with reference to FIG. 28. The handheld computer 750 generally includes a casing 756 having a monitor 754, an optical interface port 752, and a power button 756. The monitor can be a touch-screen or any other type of monitor known in the art.

The system provides the user with several options including 1) “Get Faucet Data” 758, 2) “Adjust Faucet” 760, 3) “Scan for Problems” 761, 4) “Information” 762, 5) “Troubleshoot” 764, and 6) “Help” 766. Of the six (6) options provided, options 1) through 3) require communication with the fluid dispensing device.

The “Get Faucet Data” option 758 retrieves and stores fluid dispensing device information. Retrieval of the fluid dispensing device data is accomplished by executing the SST command of the handheld computer. As described, the handheld computer emits an Attention Signal. When the fluid dispensing device detects the Attention Signal the handheld computer and the fluid dispensing device enter Connected Mode. The fluid dispensing device then transmits a set of information describing various parameters of the fluid dispensing device.

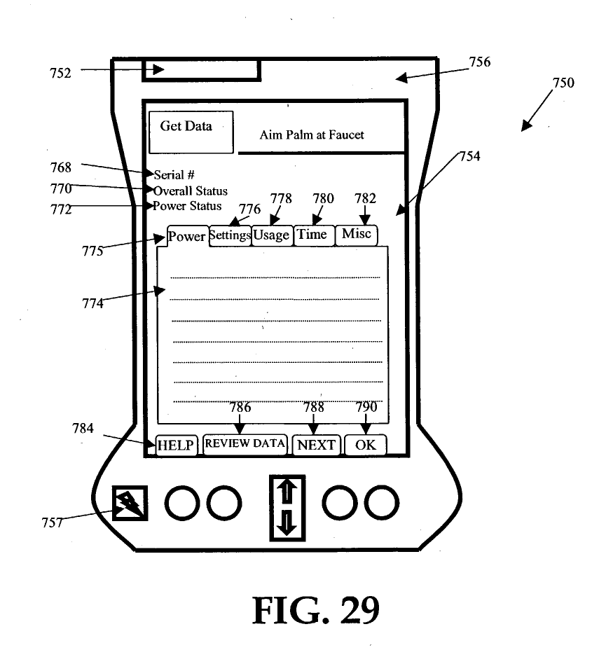

Once the data is retrieved, the data is stored in the handheld computer for user accessibility. FIG. 29 illustrates the GUI interface that is displayed once the data is received from the fluid dispensing device. The fluid dispensing device data can be reviewed by pressing the five tabs on the screen including Power 775, Settings 776, Usage 778, Time 780, and Miscellaneous 782.

The Power tab 775 contains data relating to the power operating parameters of the fluid dispensing device. These parameters include normal operating voltage, loaded voltage, time in use and battery replacement date.

The Settings tab 776 contains data on the various system settings accessible to the user. These settings include, but are not limited to, operating mode, range setting, range offset, delay setting and virtual settings. The factory default operating mode is the normal motion detecting mode where water flows within 250 milliseconds after activating sensor and stays on as long as motion is detected. The maximum on time in this mode is 45 seconds. Additional modes include scrub mode where water continues to flow for sixty (60) seconds after deactivation of the sensor, metered mode having a 10-second flow time from first hand detection, and water saver mode having a 5-second maximum on time starting from first hand detection and fast turnoff when hands are removed.

The Usage tab 778 provides information such as the number of uses, uses per day and uses per month. The Time tab includes the time of the scan, the date of the scan and the total on-time for the faucet. Finally, the Miscellaneous tab 782 includes current errors, past errors, software version, PCB number and engineering change level.

Additional pushbuttons Help 784, Review Data 786, Next 788, and OK 790 provide additional functionality. Review Data 186, when selected, displays data from the fluid dispensing device. Next 780, when selected, performs another “Get Faucet Data” function on a fluid dispensing device.

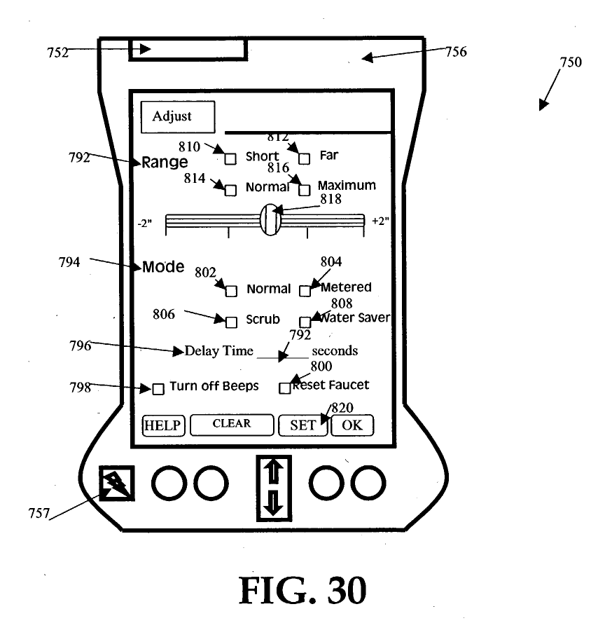

The “Adjust Faucet” option 760 (FIG. 28) allows a user to edit the parameters of the fluid dispensing device and download parameter changes to the device, itself. Selecting the “Adjust Faucet” option 760 from the Commander menu in FIG. 28 displays the GUI illustrated in FIG. 30. This GUI is a form having numerous areas in which the user can enter information about the parameters of the fluid dispensing device. The user can modify the “Range” 792 of the emitter by selecting one of the checkboxes “Short” 810, “Normal” 814, “Far” 812 or “Maximum” 816.

The user can also modify the “Mode” 794 in which the fluid dispensing device is operating. The user can place the device in “Normal” mode 802, “Scrub” mode 806, “Metered” mode 804 or “Water Saver” mode 808 by selecting the corresponding checkbox.

The range slider 818 allows the user to add or subtract 2 inches from the optics range. Initially, the user must calibrate the faucet to determine the current range length. The slider can then be used to adjust the current range ±2 inches.

In addition, the user can change the “Delay Time” 796 of the operating mode selected. The user can enter a delay time ranging from zero to 180 seconds by entering the time in the text field 792. Also, the user can elect to “Turn off Beeps” by selecting the checkbox 798 or “Reset Faucet” by selecting the checkbox 800.

Once edits have been completed, the user selects the “SET” pushbutton 820. As described, infra, with reference to FIG. 25, the Set Command is initiated by transmitting the “SET” signal after obtaining Connected Mode. The “SET” stream is sent to the fluid dispensing device, and the requested changes to the device parameters are updated.

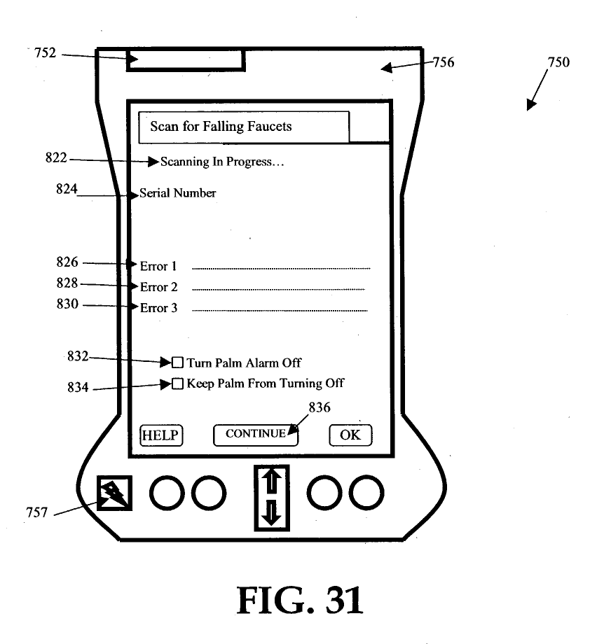

The “Scan For Problems” option 761 (FIG. 28) allows a user to scan a set of fluid dispensing device, searching for a signal from a device that has entered Broadcast Mode. This allows the handheld device to determine from the Broadcast Mode signal devices that are currently in need of service. Selecting the “Scan For Problems” option 761 from the Commander menu in FIG. 28 displays the GUI illustrated in FIG. 31. As indicated, when the GUI illustrated in FIG. 31 is displayed, the “Scanning in Progress” message 822 is displayed.

If a fluid dispensing device is in Broadcast Mode, the “Serial Number” 842 of the malfunctioning device is displayed. In addition, errors associated with the device “Error 1” 826, “Error 2” 828 and “Error 3”830 are displayed. The user can prevent the handheld device from sounding an alarm by selecting the “Turn Palm Alarm Off” checkbox 832. Also, the user can select to keep the handheld computer on for as long as active scanning is in progress by selecting the “Keep Palm From Turning Off” checkbox 834.

The user may continue scanning by selecting the “Continue” pushbutton 836.

### Exemplary System Hardware

While numerous hardware configurations, in addition to those described briefly above, may be employed in accordance with the apparatus and method of the present invention, reference will now be made in detail to an additional hardware configuration and arrangement.

Because the features may be shown with block and other diagrams, conventional electronic elements well known to those skilled in the art, such as transistors, amplifiers, resistors, capacitors, programmable processors, logic arrays, memories and corresponding couplings and connections of such elements are not shown. A person skilled in the art could readily understand the block diagrams illustrating embodiments of the present invention. The block diagrams show specific details that are pertinent to the present invention and do not obscure the disclosure with details that would readily be apparent to those skilled in the art.

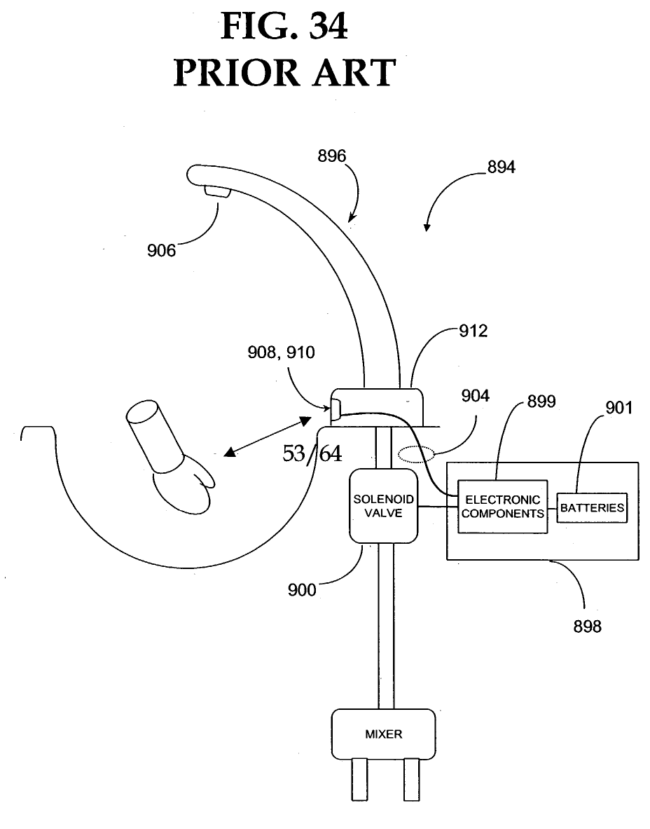

A conventional electronically operated flow control device 94 commonly found in the art is shown in FIG. 34. The prior art embodiment depicted in FIG. 34 generally includes a faucet 896, an electronics box 898 for housing electronic components 899 and batteries 901. The electronic components 899 are coupled to a solenoid valve 900, which may move between an open position and a closed position in response to instructions provided by the electronic box 898. Generally speaking, a wiring harness 904 having cables provides power and a communication link between electronics box 898, faucet 896 and solenoid valve 900.

As further shown in FIG. 34, faucet 896 of conventional electronically operated flow control device 894 typically includes an IR emitter 908and an IR receiver 910 mounted within a collar 912 (or neck) of faucet 896. The IR emitter 908 and the IR receiver 910 cooperate to transmit and receive IR signals, which indicate the presence of a user's hands or other objects in the vicinity of an aerator 906 When a signal emitted from IR emitter 908 is reflected back and received by IR receiver 910, IR receiver 910 generates an electrical signal, referred to as a “reflection signal,” that has a voltage corresponding to the signal strength of the reflected IR signal. The reflection signal is coupled through a wire in the wiring harness 904 to electronics box 898. The electronic components 899 process the reflection signal and send a control signal through wiring harness 904 to the solenoid valve 900. When an external object, such as a user's hands, moves into the detection range of IR emitter 908 and receiver 910, the signal strength of the reflected signal and, therefore, the voltage of the reflection signal should be higher than normal. Thus, the electronic components 899 detect the presence of the external object. When the magnitude of the reflection signal is above a particular threshold value a control signal causes the solenoid valve to open, allowing water to flow in faucet 896. In most conventional flow control devices 894 water flows until a timer expires or until the reflection signal is again below the threshold value indicating that the external object is no longer within the detection range of IR emitter 908 and IR receiver 910.

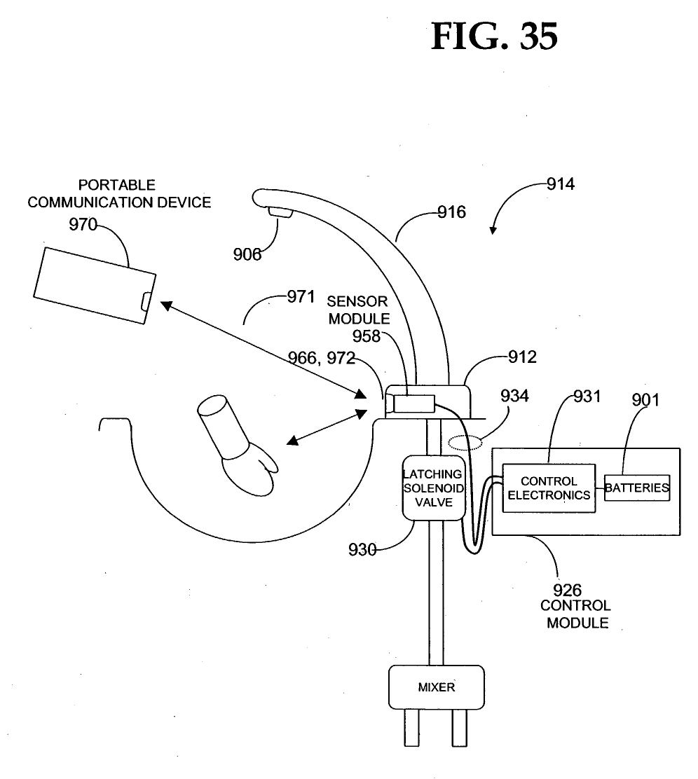

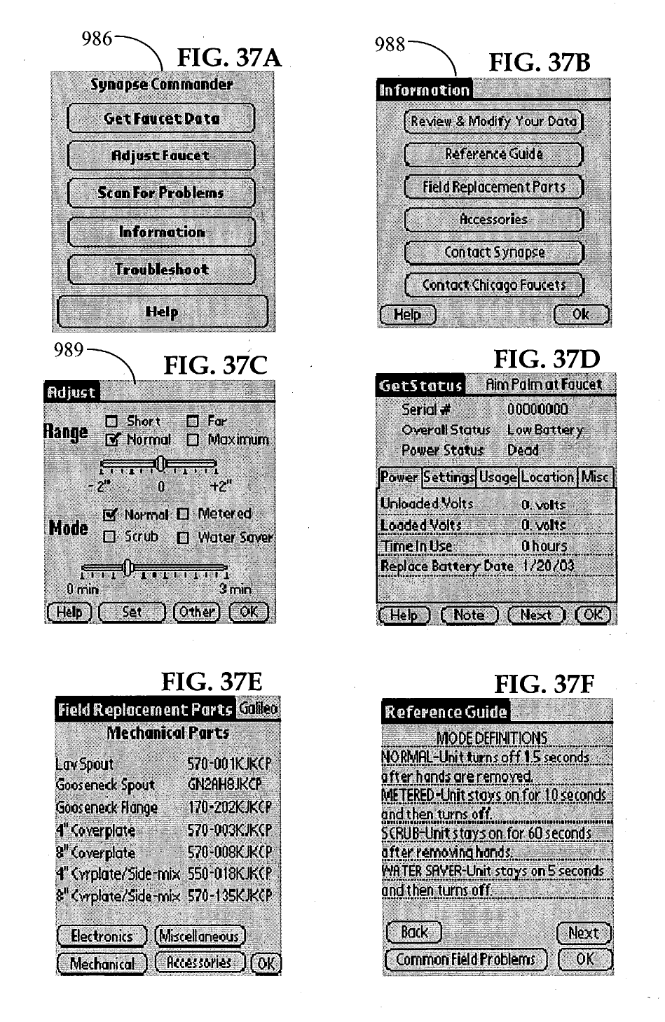

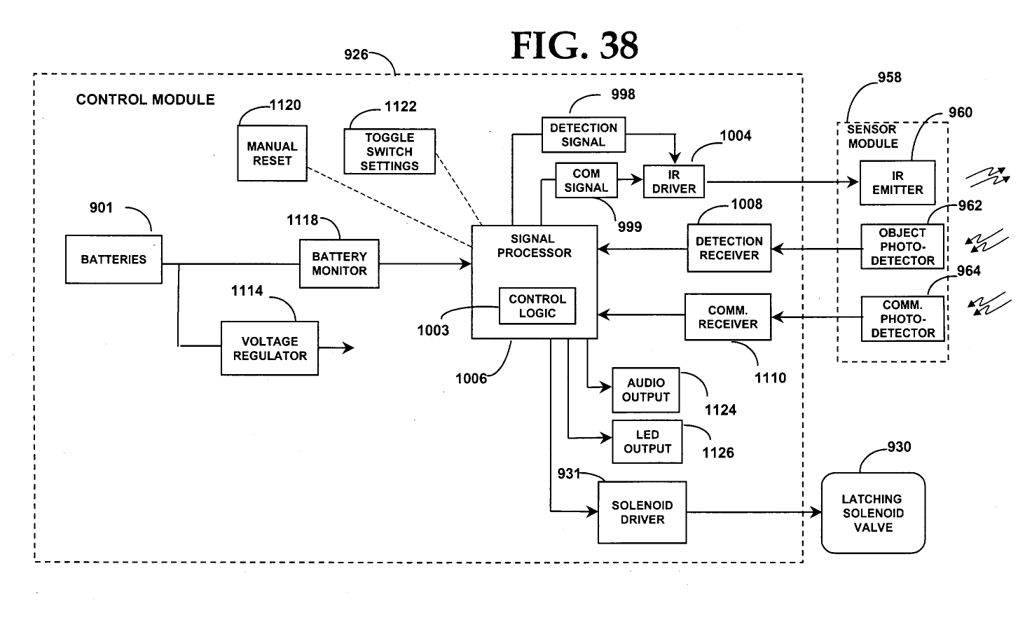

An exemplary embodiment of a remotely managed electronically operated dispensing apparatus of the present invention is shown in FIG. 35, and is designated generally throughout by reference numeral 914. Remotely managed electronically operated dispensing apparatus 914 preferably includes a dispensing unit, such as a faucet 916. Faucet 916 preferably includes a collar 912 having an emitter aperture 972 preferably covered by a signal transmissive lens, and a receiver aperture 966, which permit signals, such as, but not limited to, IR signals to exit and enter collar 912. Remotely managed automatic dispensing apparatus 914 further includes a control module 926, a latching solenoid valve 930 that opens and closes in response to signals provided by control module 926. In the preferred embodiment, control module 926 is contained in an enclosure that incorporates an anti-vandalism bracket (not shown). Remotely managed automatic dispensing apparatus 914 may also include one or more flexible sheaths (not shown) for protecting and positioning the electrical cables 934, which provide a communication link between a sensor module 958 (FIG. 38) positioned within collar 912 of faucet 916 and control module 926, and between control module 926 and latching solenoid valve 930.

The primary purposes of the flexible sheathes are to protect the electrical wiring and to position the electrical wiring with respect to control module 926 and latching solenoid valve 930 such that flexible sheathes form one or more drip loops which are designed to capture any water inadvertently running down the electrical wiring from a leak in faucet 916, the sink, or otherwise. A primary objective of the drip loops is to prevent water from entering the cables and reaching the electronics within the control module 926 and/or the latching solenoid valve 930. Gravitational forces act on any water collected in the drip loops thereby preventing that water from contacting the connectors or other electronic circuitry within or adjacent to control module 926 and latching solenoid valve 930.

Remotely managed automatic dispensing apparatus 914 also preferably includes a sensor board or sensor module 958 (FIG. 38) that is particularly well suited for being retrofit within collar 912. The sensor module 958 may be designed similar to or identical to conventional sensor modules employed within conventional flow control devices 894. More specifically, the sensor module 958 may be constructed and arranged so that it may be installed in a collar having only two apertures, which is typical for conventional flow control devices 894.

As will be described in greater detail below, remotely managed automatic dispensing apparatus 914 of the present invention is preferably designed to communicate with a portable communication device 970. The portable communication device 970, which in the preferred embodiment is a reprogrammed personal digital assistant (PDA), is preferably configured to transmit and receive IR signals for establishing a communication link 97 with managed automatic dispensing apparatus 914.

In addition to an IR emitter 960 and an IR sensor 962, such as a detection or object photo detector, sensor module 958 of the present invention preferably incorporates a data or communication IR sensor 964 such as another photo detector, for receiving communication signals from the portable communication device 970. In one embodiment, IR sensor 962 and the communication IR sensor 964 are mounted back-to-back (not shown) on sensor module 958. Generally speaking, photo detector lens 965 is positioned near the front of sensor board 958 for receiving light through receiver aperture 966, while communication photo detector lens 968 faces the rear of IR sensor 962. Transparent silicone sealant fill 967 may hold the sensors 962 and 964 securely in aligned position. Additional arrangements of IR sensors 962, 964 are possible in other embodiments. In particular it is not necessary communication IR sensor 964 to receive IR signals through the hole 973 of IR sensor 962. For example, a side-by-side configuration for sensors 962 and 964 may be employed if desired. Further, in another embodiment a single sensor, such as IR sensor 962 may serve for detecting reflections and for receiving communication signals.

According to techniques that will be described in more detail below, control module 926, sensor module 958 within collar 912, and latching solenoid valve 930 may be utilized to control operation of faucet 916 and to provide information pertaining to the operational state of faucet 916. Similarly, these components may be implemented within and utilized to control other fluid dispensing devices, such as toilets, for example.

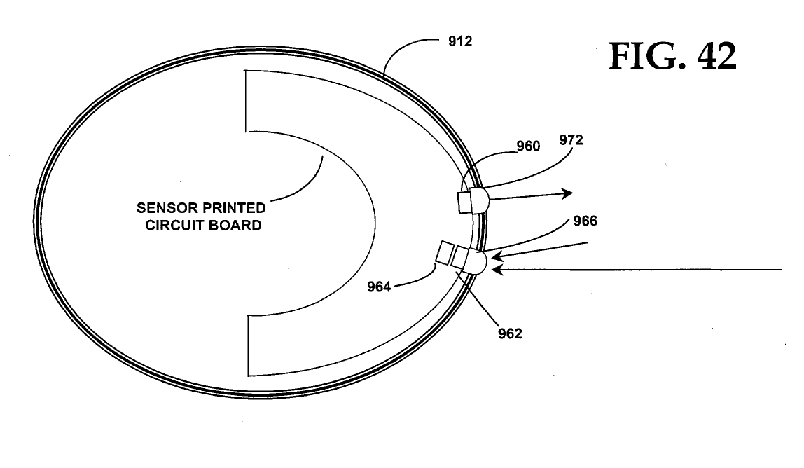

As depicted in FIGS. 35 and 42, sensor module 958 is preferably mounted such that IR emitter 960 is positioned behind and aligned with the transmit aperture 972 of collar 912, while detection photo detector 962 and communication photo detector 964 are positioned behind and aligned with the receive aperture 966 of collar 912. So arranged, the IR signals emitted by IR emitter 960 are transmitted through transmit aperture 972, and both the reflected signal from IR emitter 960 and the communication signal emitted by a portable communication device 970 for controlling and managing the operation of automatic dispensing apparatus 914 are received through receive aperture 966. When desired, automatic dispensing apparatus 914 may send information to portable communication device 970 (upstream information) through transmit aperture 972. Further, automatic dispensing apparatus 914 may receive information from portable communication device 970 (downstream information) through receive aperture 966. Typically, most IR devices, such as the IR emitter 960 and IR detectors 962, 964, have an integrated lens to focus infrared signals and protect the semiconductor material.

As shown in FIG. 35, portable communication device 970, such as a Palm IIIe™ manufactured by 3com®, which preferably utilizes the Palm Computing Platform®, for example, may be configured to communicate with the remotely managed automatic dispensing apparatus 914 of the present invention. Generally speaking, the portable communication device 970 used to communicate with the remotely managed automatic dispensing apparatus 914 of the present invention includes an IR emitter and IR sensor that provide for exchange of data via IR signals passed through apertures 966, 972. It will be understood by those skilled in the art, however, that other devices and particularly portable devices, such as personal digital assistants manufactured by other manufacturers, cellular telephones, pagers, portable computers, and the like may be used to communicate with the remotely managed automatic dispensing apparatus 914 of the present invention. In addition, communication signals other than IR signals may be used to transfer data between any such portable communication device and the remotely managed automatic dispensing apparatus 914 of the present invention. It is not necessary that a device communicating with the remotely managed automatic dispensing apparatus 914 be a portable device configured for IR communication. For example, one or more wires may be coupled to the remotely managed dispensing apparatus 914 to serve as a communication channel for a non-portable communication device. This being said, the preferred embodiments of the present invention will be described hereafter with reference to the portable communication device 970 being the Palm IIIe™, but the preferred embodiments are in no way intended to be limited only to the above mentioned PDA.

Generally speaking, the present invention provides an improved maintenance and monitoring system for use in commercial facilities such as office buildings, manufacturing plants, warehouses, or the like. For example, public restrooms in an office building may benefit from such a system in that such a system may facilitate the efficient operation, management and servicing of multiple conventional automatic flow control devices throughout the building. More specifically, conventional automatic flow control devices are battery powered and therefore require battery replacement. In addition, there are typically a plurality of such devices in any given restroom within the building. As one would expect, the maintenance of such conventional dispensing devices is both time consuming and labor intensive since maintenance personnel have no efficient way of determining whether such devices require battery replacement or are otherwise defective. As a general rule, manual interaction with each device is required to make these determinations. For example, maintenance personnel position their hands beneath the aerator of each conventional automated sink to determine if the faucet is operating correctly. Troubleshooting, however, requires the time consuming steps of removing the cover of electronics box 898, and physically checking and analyzing the circuitry and other components thereof. Accordingly, there is a need for an improved maintenance and monitoring system for commercial facilities having large numbers of automatic flow control devices.

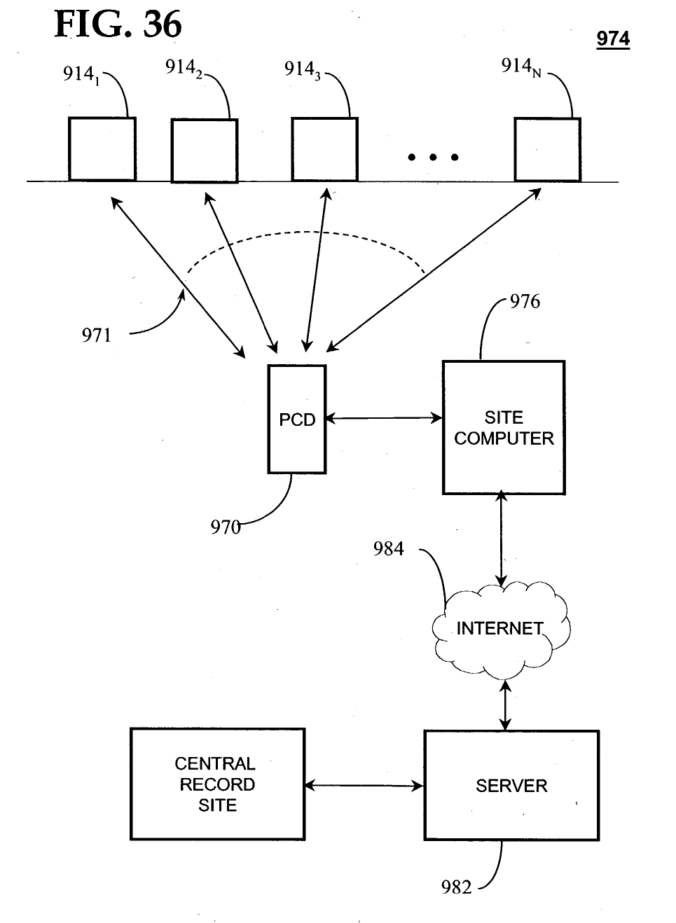

As depicted schematically in FIG. 36, remotely managed automatic dispensing apparatus 914 may be a part of a remotely managed automatic dispensing system 974. System 974 preferably includes a plurality of remotely managed automatic dispensing apparatuses 914₁, 914₂, . . . , 914_{N}, each having an associated dispensing unit, such as a faucet 916 or other dispensing device. The portable communication device 970 may exchange data with each of the automatic dispensing apparatuses via one or more IR communication links 971. A site computer 976 capable of communicating with portable communication device 970 may store information about each of the site's managed automatic dispensing devices. Optionally, one of ordinary skill in the art will recognize that system 974 may be monitored and controlled in a network environment. In a preferred embodiment, a remote server 982 may receive data relating to system 974 from PCD 970 or a site computer 976 over the Internet 984 or other network environment via any standard network connection.

System 974 of the present invention largely obviates the need for manual troubleshooting or servicing of dispensing devices. By implementing the system 974 of FIG. 36, maintenance personnel may enter an area, for example a restroom, containing numerous remotely managed automatic dispensing apparatuses 914 of the present invention, communicate with one or more of the apparatuses 914, and determine which, if any, of the apparatuses are defective or otherwise require servicing based on data communicated from the one or more apparatuses 914. In accordance with the preferred system 974 of the present invention, a failing or malfunctioning apparatus 914 may automatically discover an operational problem and broadcast an IR data signal indicating the nature of the problem. This IR data signal may indicate, for example, the serial number, location, and problem, among other things for the defective apparatus 914 in the room. Depending upon the nature of the problem associated with one or more of the apparatuses 914, portable communication device 970 may preferably provide the maintenance person with troubleshooting information indicative of the problem. Moreover, PCD 970 may also be used to repair defective apparatuses 914. For example, when the problem associated with a defective apparatus 914 is software related, PCD 970 may be used to transmit a software update or otherwise reprogram defective apparatus 914 by transmitting software updates via IR.

In addition, portable communication device 970 preferably includes memory for storing information such as the maintenance history and/or software update history of each device, or an installation and user's guide that may be used by maintenance personnel to install and operate new apparatuses 914. The memory may also be used to maintain records of data gathered or entered for each apparatus 914, by serial number. More preferably, portable communication device 970 may be used to transmit, to one or more apparatuses 914, commands for adjusting apparatus parameters such as IR range, and/or update the software of a given apparatus 914, thus largely eliminating the need for maintenance personnel to open the electronics box 926 and physically access one or more of the apparatus boards. Such commands may be received by IR sensor 964 and processed by signal processor 1006 (FIG. 38).

Information collected by portable communication device 970 may also be transferred to a site computer 976 for updating device records in stored memory of the site computer. In addition, any information transmitted by any apparatus 914 to portable communication device 970 may be sent to a web server 982 via the Internet 984 where the information may be logged and stored in a relational database, such as Microsoft Access, for device fault analysis or other research. Additionally, web server 982 may generate and deliver responses to trouble reports received from portable communication device 970 and system updates to site computer 976 via the Internet 984.

FIGS. 37A-37F depict various display screens, as viewed on portable communication device 970, that may be used in connection with system 974 of the present invention. For example, a control panel screen 986 displays, on portable communication device 970, a menu of selectable items for the managed automatic dispensing apparatus 914. By way of example, but not limitation, a user may select “Information” from screen 986 and obtain information about a faucet as viewed on Information screen 988. Adjust screen 989 provides inputs for adjusting faucet parameters, such as detection distance, flow mode, and time on. Additional example screens are shown in FIGS. 37D-37F and provide maintenance personnel with information that will reduce troubleshooting time and time to repair. The depicted screens represent preferred examples of the types and arrangements of information that may be available to maintenance personnel on display screens provided by PCD 970.

The block diagram of FIG. 38 illustrates a more detailed view of control module 926 and sensor module 958. The control module includes control logic 1003 for controlling the operation of remotely managed dispensing apparatus 914. The control logic may be implemented in hardware, software or a combination thereof. In the preferred embodiment, the control logic 1003 is implemented in software and stored within a signal processor, such as, for example, a Motorola microprocessor (MC88HC908GP32CF8) having flash memory, analog-to-digital (A/D) converters and a variety of input and outputs as are described in the vendor's data sheets. When the remotely managed dispensing apparatus 914 is implemented as a faucet that dispenses fluid into a sink, the electronics of the remotely managed dispensing apparatus 914 may preferably be located in sensor module 958 contained in the collar 912 of the faucet and in control module 926, which is typically mounted under the sink. The two modules 926, 958 may be electrically connected via cables 934 (FIG. 35). In addition, a cable extends from the control module 926 to a latching solenoid valve 930 that directly controls fluid flow. The control module 926 is preferably positioned in a secure enclosure while the sensing electronics or sensor module 958 is preferably positioned on a sensor board potted in collar 912 of the faucet. The potted arrangement reduces the likelihood that water will come into contact with the sensing electronics, and thus minimizes the risk of corrosion and other damage to these parts.

The signal processor 1006 provides a detection signal 998 and a communication signal 999 for transmission from an IR emitter 960 in the sensor module 958. The detection signal 998, preferably generated by the control logic 1003, is a sequence of one or more narrow pulses. In the preferred embodiment, the pulses occur several times per second although other time intervals may be utilized in other embodiments. The detection signal is preferably sent to IR driver circuit 1004 and coupled via a cable to the IR emitter that wirelessly transmits the narrow IR pulses. In the preferred embodiment, one pulse is transmitted every 250 milliseconds. The detection signal is transmitted when the automatic dispensing apparatus is in a detection mode and the communication signal is transmitted when the automatic dispensing apparatus is in a communication mode. The managed automatic dispensing apparatus in the preferred embodiment transfers from the communication mode back to the detection mode when control logic 1003 determines that all information has been exchanged.

Reflected detection signals are detected by an object photo detector 962 and are thereafter coupled to the signal processor 1006 via a detection receiver 1008. Other receiver elements such as a filter or amplifier, or both may be utilized to process the reflected signals detected by the object photo detector 962. In the detection mode, the managed automatic dispensing apparatus transmits a detection signal, receives reflected detection signals, and remains in the detection mode until there is a request to transfer to a communication mode. The communication mode request may be initiated by the portable communication device 970 as disclosed above or may be initiated by the control logic 1003. A request by the PCD 970 for switching to the communication mode preferably is initiated by a transmission of a known digital sequence from the PCD 970. Once the known sequence is detected by the communication photo detector 964, communicated to control logic 1003 via communication receiver 1110 and verified by control logic 1003, the automatic dispensing apparatus 914 transitions to the communication mode. When the managed automatic dispensing apparatus 914 is in the communication mode, the control logic 1003 transmits a communication signal to the IR emitter 960. The communication signal may require a boost from the IR driver circuit 1110 before being transmitted to the IR emitter 960. The non limiting communication signal of the present invention may be based on the specifications described in an IR Data Association Specification and may be limited to half duplex transmission at or less than 9600 bps. Those skilled in the art could use a variety of modulation technologies to provide for information or data exchange.

When the object photo detector 962 generates a signal in response to reflected signals from an object, such as a person's hand, the signal is communicated to signal processor 1006. If the signal is greater than a threshold value, receive logic in the signal processor provides an open valve signal to a solenoid driver 931. Solenoid driver 931 and any associated electrical components can be similar or identical to an H-bridge circuit described in U.S. Pat. No. 5,819,336. The solenoid driver 931 is adapted to drive a latching solenoid valve 930 that opens in response to the open valve signal or closes in response to a close valve signal from the signal processor 1006.

The control module 926 may be powered by one or more batteries 901 or by some other suitable power source. One embodiment of the present invention incorporates four (4) AA batteries in series (around 6 volts) coupled to a voltage regulator 1114 for providing a regulated voltage of three (3) volts for most of the electronics and uses six (6) volts to power the latching solenoid valve 930 and the IR emitter 960. An audio output 1124 and LED output 1126 serve as troubleshooting indicators. For example, if the battery voltage is low, the LED preferably exhibits a defined on/off pattern. A battery monitor 1118 serves several functions. Under no-load conditions, the battery monitor 1118 determines, comparing the battery voltage with a known voltage, if the battery should be replaced. In addition, the battery monitor 1118 may determine if the windings in the latching solenoid valve 930 are in an open circuit condition or in a short circuit condition by observing the battery loading characteristics. Information from the battery monitor 1118 may be sent to the portable communication device 970 when the remotely managed dispensing apparatus 914 is in the communication mode. In addition, an audio signal from the audio output device 1124 or a visual output from the LED output 1126 may be used to notify maintenance technicians of a variety of identified problems.

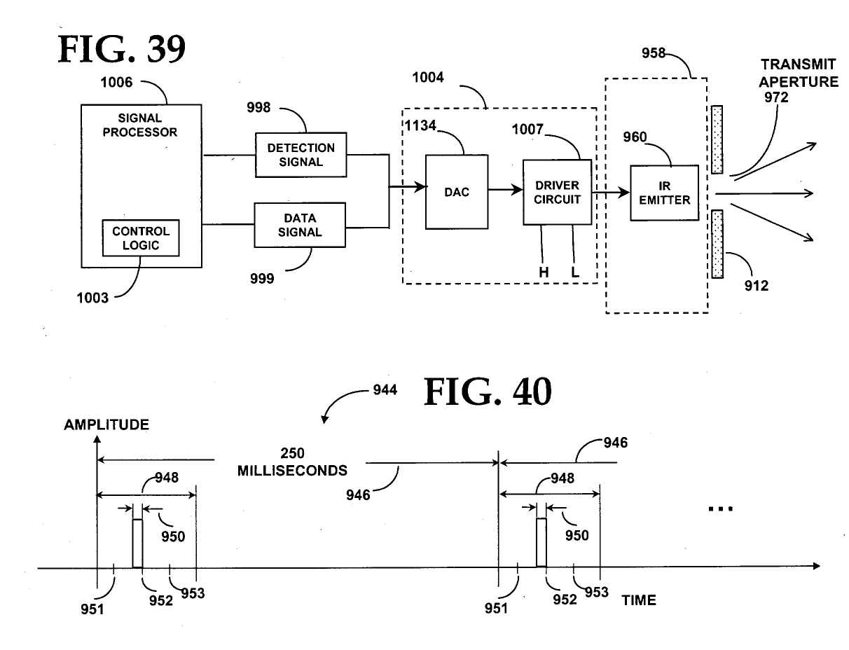

FIG. 39 is a block diagram illustration of timing aspects of the automatic dispensing apparatus 914 of the present invention. The control logic 1003 preferably generates a detection signal 998 when the managed automatic dispensing apparatus 914 is in the detection mode and preferably generates a data communication signal 999, for the upstream direction, when the managed automatic dispensing apparatus 914 is in the communication mode. The control logic 1003 processor is configured to generate either the detection signal 998 or the communication signal 999, but the control logic 1003 preferably does not generate the signals simultaneously. The signal generated by the control logic 1003 is sent to a digital-to-analog converter (DAC) 1134 and is preferably conditioned by driver circuit 1007. An output from the driver circuit 1006 is coupled over a communication link such as a wire to the IR emitter 960 in sensor module 958. Preferably, a transmit aperture 972 in collar 912 of the dispensing device allows the infrared signal to exit from an emitter lens integrated in IR emitter 960. Other arrangements of emitters, lenses, and apertures may provide other embodiments for transmission of infrared signals. The method of generation of the above-mentioned transmit signals is not a limitation of the present invention. In the preferred embodiment, both the pulse width and the pulse height of the detection signal and communication signal may be controlled. For example, the width of the signal preferably is controlled utilizing transistors, and the height of the signal is preferably controlled by a digital value sent to a DAC. The arrangement of the transistors and the DAC could be implemented by those skilled in the art.

FIG. 40 is a timing diagram 944 showing an event repeat time 946, which is preferably approximately 250 milliseconds in the preferred embodiment. Within the repeat time, there is an activity time 948 of around 200 microseconds. During the activity time three samples are taken and stored within memory of the signal processor 1006. In addition the control logic 1003 generates a detection signal 998, positioned in time as shown in FIG. 40. Control logic 1003 samples the battery condition 951, then samples a reflection signal 952, and finally samples the ambient condition 953 (such as room lighting). The reflection sample 952 and ambient sample are taken from object photo detector 962. The reflection sampling occurs immediately after or as the detection signal, represented by pulse width 950 (approximately 60 microseconds), is transmitted. The ambient sampling is used to determine the light levels when no reflections occur. Those skilled in the art would appreciate that variations of the sampling times is not a limitation on the present invention. In general, narrow pulses pull less energy from the battery providing for energy savings, but narrow pulses contain higher frequencies than wide pulses. Components that process the higher frequencies associated with the narrow pulses typically cost more and a cost/efficiency factor is a design consideration. When the repeat time is 250 milliseconds as shown in FIG. 40, the activity time occurs approximately four (4) times per second. Experience has shown that this frequency of activity satisfies the needs of a person using the automatic dispensing unit of the present invention.

In addition to the three samples described above, other samples may be taken to determine the condition of elements within the automatic dispensing apparatus 914 of the present invention. For example, samples taken when the latching solenoid valve 930 is activated may be used to determine changes in the required activation power. Changes in the activation power may give an indication of the solenoid's condition or could indicate above normal pressure in the water supply line. Neither the number of samples, type of samples, or order of samples is considered a limitation on the present invention.

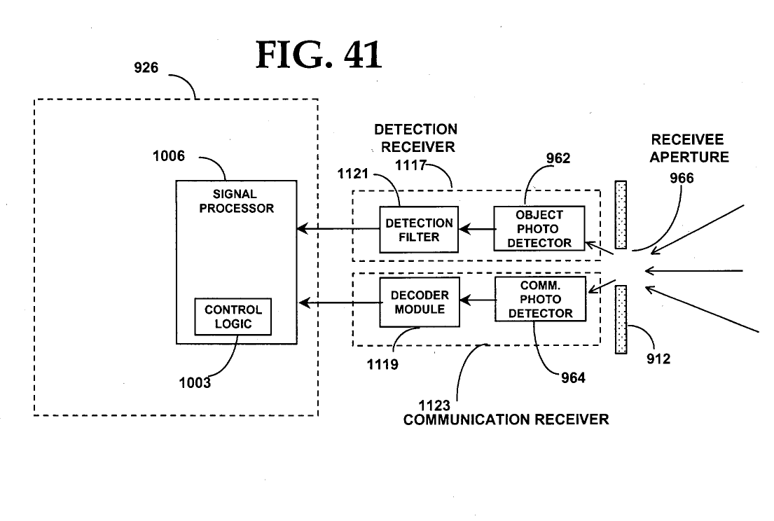

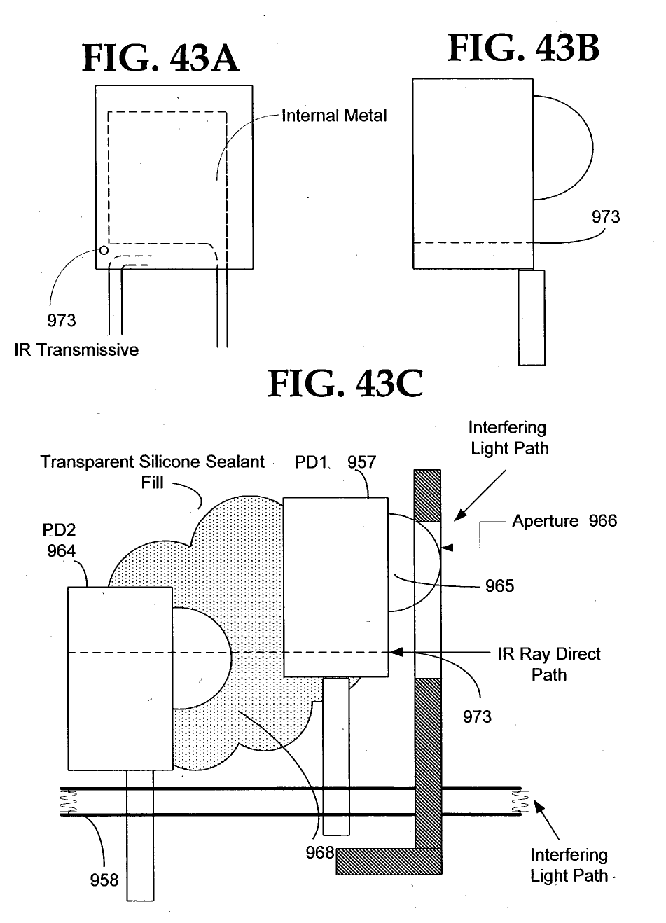

FIG. 41 is a block diagram showing a preferred receiver arrangement in accordance with the preferred electronically operated dispensing apparatus of the present invention. As shown in the diagrammatic illustration a detection receiver 1117 and a communication receiver 1118 are shown side-by-side. The detection receiver 1117 includes object photo detector 962 coupled to a detection filter 1121. The output of detection filter 1121 preferably is coupled to and processed by the control logic 1003. The communication receiver 1123 includes the communication photo detector 964 coupled to a decoder module 1119, the output of which is processed by the control logic 1003. In one embodiment, the object photo detector 962 and the communication photo detector 964 may be arranged back-to-back (not shown). Various other embodiments, however, are also possible. For example, in another embodiment a single photo detector could provide signals to the detection filter and a decoder module. An arrangement of filters could also be used to separate the lower frequencies of the reflection signals from the higher frequencies of the communication signals. A more preferred embodiment will be described below with reference to FIGS. 43A-43C. While only a single aperture is shown in FIG. 41, a communication lens and detection lens may be incorporated with photo detectors 962 and 964. The arrangement and location of the aperture and lenses are not intended to limit the scope of the present invention.

FIG. 42 illustrates an exemplary top view mounting arrangement for the IR emitter 960 and the two IR detectors or photo detectors 962, 964. When the emitter and detectors are mounted on a sensor Printed Circuit Board (PCB) of the sensor module 958, the PCB fits within the collar 912 of the automatic dispensing apparatus 914. In addition to the emitter and detectors, other electronic components (not shown) may reside on the PCB. As one of skill in the art will readily recognize, one or more cables preferably couple the PCB to the control module 926.

FIGS. 43A-43C illustrate a preferred front-to-back arrangement for the two IR detectors or diodes 962, 964. Object photo diode 962 is mounted at the front of the sensor printed circuit board and the communication photo diode 964 is mounted behind and preferably offset slightly from photo diode 962. The diodes are preferably positioned some standoff distance from one another, and secured in the positions as shown, with transparent silicone sealant fill 967 as depicted in FIG. 43C. The object photo diode 962 preferably includes an IR transmissive aperture 973 that provides for IR signal coupling between an IR source, such as portable communication device 970, and communication photo diode 964. Generally speaking, the above mentioned arrangement allows IR signals to pass through aperture 973 to communication photo diode 964, thus providing better IR reception of data signals than the back-to-back arrangement. Although other sensors may be employed in accordance with the present invention, the preferred object photo diode 962 may be a diode identified by part number BPV23F and the communication photo detector 964 may be a diode identified by part number BPV22F, both of which are manufactured by Vishay Intertechnology, Inc. The photo diodes 962, 964 are preferably mounted on the sensor printed circuit board with conventional electronic components. In addition, and as indicated in FIG. 32c, the arrangement positioned behind a single aperture has the effect of minimizing interference from undesired light sources, such as sunlight or room lighting.

Because the automatic dispensing apparatus 914 in the described embodiment is battery powered, it may be desirable to utilize a battery savings methodology. Such a battery saving methodology is embodied when the control logic 1003 configures the signal processor 1006 to operate in an on mode, a wait mode, and a stop mode. When the automatic dispensing apparatus 914 is installed and functioning, the signal processor is in the on mode approximately 2.8% of the time, the stop mode nearly 97% of the time, and the wait mode for around 0.2% of the time. A low frequency clock frequency of 32.768 KHz is preferably applied to the signal processor during the stop mode allowing the signal processor to operate on about 50 microamps. When a timer, functioning in the stop mode, reaches a given value, the signal processor transitions to the on mode. During the on mode the clock frequency for the signal processor is approximately 4 MHz, requiring an operational current of about 4 milliamps for the signal processor. The wait mode requires around 1 milliamp of current, and is used for special purposes, such as providing power for operation of the control logic for the latching solenoid drivers during a transition between the on mode and the stop mode. Where the detection signal is an emitter pulse that is preferably sent 4 times per second with a pulse width of around 59 microseconds, the power requirement for the emitter 960 of the automatic dispensing apparatus 914 is significantly reduced. Conventional dispensing devices send pulses around 8 times per second with a pulse width of over 200 microseconds. In addition, modifications to the latching solenoid valve circuits have provided an additional reduction in energy requirements.

The battery saving methodology described above allows an embodiment of the remotely managed automatic dispensing apparatus to operate on four (4) AA batteries, where each battery is capable of supplying around 2500 mAhours. Conventional dispensing devices typically require four (4) C batteries, where each battery is capable of supplying around 7100 mAhours. The reduction, of nearly 65%, in power requirements and the associated benefits of reduced cost and size represents a significant improvement over conventional dispensing devices.

In the preferred embodiment, the present invention normally operates in the detection mode, to provide the function of dispensing water. A method or procedure is provided in accordance with the present invention to transfer from the detection mode to the communication or data mode. Since the PDA communication protocol is preferably based on the IRDA specifications, it is preferable to send a known sequence to the sensor module 958 from the portable communication device 970 for at least 300 milliseconds since the operational mode for the control module 926 typically occurs for a brief amount of time every 250 milliseconds. When the control module detects the known sequence a detection mode to communication mode transition is initiated as described more detail above.

Further details relating to these and other aspects of the present invention are disclosed in greater detail in U.S. patent application Ser. No. 10/045,331, filed Oct. 23, 2001, entitled, “System and Method for Filtering Reflected Infrared Signals”; U.S. patent application Ser. No. 10/035,750, filed Oct. 23, 2001, entitled, “Data Communications System and Method for Communication Between Infrared Devices”; U.S. patent application Ser. No. 10/045,302, filed Oct. 23, 2001, entitled, “Method of Automatic Standardized Calibration for an Infrared Sensing Device”; U.S. patent application Ser. No. 10/037,343, filed Oct. 23, 2001, entitled, “Apparatus and Method for Wireless Data Transmission”; U.S. patent application Ser. No. 10/035,749, filed Oct. 23, 2001, entitled, “Method of Automatic Dynamic Calibration for an Infrared Sensing Device”; U.S. patent application Ser. No. 10/035,959, filed Oct. 23, 2001, entitled, “Apparatus and Method for Wireless Data Reception”; U.S. patent application Ser. No. 10/035,370, filed Oct. 23, 2001, entitled, “System and Method for Wireless Data Exchange Between an Appliance and a Handheld Device”; each of which is commonly owned by Synapse, Inc., and each of which is hereby incorporated herein by reference.

While the invention has been described in detail, it is to be expressly understood that it will be apparent to persons skilled in the relevant art that the invention may be modified without departing from the spirit of the invention. Various changes of form, design or arrangement may be made to the invention without departing from the spirit and scope of the invention. For example, the invention as described is not dependent upon specific hardware configurations, nor is it pivotal to employ a specific programming language to implement the invention as described. Therefore, the above mentioned description is to be considered exemplary, rather than limiting, and the true scope of the invention is that defined in the following claim.

What is claimed:

1. An apparatus for mixing fluids, the apparatus comprising:
a housing defining a channel having a first end, a second end remote from the first end, an area of convergence positioned between the first and second ends, and an orifice communicating with the area of convergence, the channel configured to receive a first fluid between the first end and the area of convergence and a second fluid between the second end and the area of convergence, the channel constructed and arranged to guide the first fluid and the second fluid toward the area of convergence to cause the fluids to be rotationally mixed as the fluids enter the orifice.

2. The apparatus of claim 1 wherein the length of the channel between the first end and the area of convergence defines a first pathway and wherein the length of the channel between the second end and the area of convergence defines a second pathway, wherein the first pathway is offset from the second pathway.

3. The apparatus of claim 2 wherein the first pathway is parallel to the second pathway.

4. The apparatus of claim 2 wherein the first pathway is nonparallel to the second pathway.

5. The apparatus of claim 2 wherein the first pathway defines a first flow path and the second pathway defines a second flow path and wherein the orifice opens to a passageway defining a flow path that is normal to the first and second flow path.

6. A method of mixing fluids, said method comprising the steps of:
dispensing a first fluid into a first end of a channel formed in a housing;
dispensing a second fluid into a second end of the channel remote from the first end; and
guiding the fluids toward one another within the channel to cause the fluids to meet at an area of convergence formed between the ends of the channel such that the fluids are rotationally mixed as they exit the channel via an orifice in fluid communication with the area of convergence.

7. The method of claim 6 wherein the guiding step comprises the step of directing the first fluid through a first pathway defined between the first end of the channel and the area of convergence, and directing the second fluid through a second pathway defined between the second end of the channel and the area of convergence, wherein the second pathway is offset from the first pathway.

8. The method of claim 7 wherein the first pathway and the second pathway are parallel and wherein the method further comprises the step of discharging the rotationally mixed fluids through the orifice along a third passageway that is oriented normal to the first and second pathways.

9. A method of electronically controlling fluid dispensation comprising the steps of:
receiving an electronic signal including an instruction for controlling the flow rate at which at least one fluid is dispensed from a device;
processing the electronic signal to create a control signal indicative of the flow rate;
delivering the control signal to a motor coupled to a valve; and moving the valve with the motor in response to the control signal to dispense the at least one fluid from the device at the flow rate included in the instruction.

10. The method of claim 9 further comprising the step of mixing a second fluid with the at least one fluid to achieve a desired temperature.

11. The method of claim 9 wherein the valve comprises a first valve and a second valve, wherein the motor comprises a first motor and a second motor, and wherein the at least one fluid comprises a first fluid stream having a first temperature and a second fluid stream having a second temperature, said method further comprising the step of rotationally mixing the first fluid stream dispensed from the first valve with the second fluid stream dispensed from the second valve to achieve a desired flow rate and temperature.

12. The method of claim 11 wherein the step of rotationally mixing the first fluid stream with the second fluid stream comprises the step of guiding the fluid streams toward one another within a channel defined within a housing such that the fluid streams converge at an area of convergence located between the ends of the channel.

13. The method of claim 10 wherein the moving step comprises the step of applying a DC voltage to the motor for a period of time sufficient to open the valve an amount sufficient to achieve the flow rate and temperature.

14. An apparatus for electronically controlling fluid dispensation, the apparatus comprising:
a user interface configured to deliver an electronic signal in response to a user selected temperature and flow rate;
a controller communicating with the user interface to receive the electronic signal, the controller including control logic configured to process the electronic signal to create a control signal indicative of the user selected temperature and flow rate; and
a valve assembly including a motor and a valve coupled to the motor, the motor configured to drive the valve in response to the control signal to open the valve a sufficient distance to achieve the selected flow rate and temperature.

15. The apparatus of claim 14 wherein the motor comprises a DC motor.

16. The apparatus of claim 15 wherein the DC motor is powered by a battery.

17. The apparatus of claim 14 wherein the user interface comprises a voice recognition system.

18. The apparatus of claim 14 wherein the user interface comprises a keypad.

19. The apparatus of claim 14 wherein the valve assembly comprises a first motor coupled to a first valve and a second motor coupled to a second valve, and wherein the first motor is configured to open the first valve by an amount specified by a first control signal to allow a first fluid having a first temperature to pass through the first valve at a particular first flow rate, and wherein the second motor is configured to open the second valve by an amount specified by a second control signal to allow a second fluid having a second temperature to pass through the second valve at a particular second flow rate.

20. The apparatus of claim 19 wherein the valve assembly further comprises a mixing chamber downstream of the first and second valves, the mixing chamber comprising a channel having a first end, a second end and an area of convergence therebetween, the mixing chamber constructed and arranged to cause the first fluid and the second fluid to meet at the area of convergence and be rotationally mixed as the fluids exit the area of convergence.
